(19) United States
(12) Patent Application Publication
(10) Pub. No.: US 2003/0110840 A1
(43) Pub. Date: Jun. 19, 2003

(54) Systems and methods for detecting a particle

(76) Inventors: Edgar A. Arriaga, Minneapolis, MN (US); Ciaran F. Duffy, Milestown Stamullen (IE); Dmitry Andreyev, Minneapolis, MN (US)

Correspondence Address: MUETING, RAASCH & GEBHARDT, P.A., P.O. BOX 581415, MINNEAPOLIS, MN, 55458, US

(21) Appl. No.: 10/202,450

(22) Filed: Jul. 24, 2002

Related U.S. Application Data
(60) Provisional application No. 60/307,404, filed on Jul. 24, 2001.

(51) Int. Cl. G01N 30/00

(52) U.S. Cl. 73/61.72; 73/865.5

(57) ABSTRACT

Systems and methods for detecting particles are provided. In one embodiment, capillary electrophoresis is used to separate particles that may be detected by methods including, for example, laser induced fluorescence. The systems and methods are useful for separating and evaluating individual particles including, for example, subcellular particles.

This application claims the benefit of the U.S. Provisional Application Serial No. 60/307,404, filed Jul. 24, 2001, which is incorporated herein by reference in its entirety.

### GOVERNMENT FUNDING

The present invention was made with partial government support under Grant Nos. R01-AG20866-01 and R03-AG18099-01 awarded by the National Institutes of Health (National Institute on Aging) and Grant No. R01-GM61969-01A1 awarded by the National Institutes of Health (National Institute of General Medical Studies).

### BACKGROUND

There are many analytical procedures to characterize nanometer- and micrometer-sized particles. Among these procedures are electron microscopy imaging, flow cytometry, centrifugation, field-flow fractionation, chromatography, and electrophoresis. Each of these techniques offers a unique technique for characterizing particles. Each is typically restricted to one or two basic properties of the particles. Furthermore, many of these techniques detect and report an average behavior for a sample or peak that represents a plurality of particles having a distribution of properties. Characterization based on averaged properties prevents a defined characterization based on unique properties of individual particles. For example, liposomes have been analyzed by electrophoresis, but only average electrophoretic mobilities could be calculated and reported.

In many analytical procedures, the number of particles required for detection is limited by the sensitivity of the instrument. Therefore, a successful analysis relies on a simultaneous detection of a large number of particles or on tagged particles with multiple extraneous labels. From an analytical perspective, the demands imposed by the appearance of complex liposomal preparations used in many industries, the characterization of subcellular fractions in fundamental research and biomedicine, and the need to characterize the multitude of nanomaterials are challenges that are of interest to many areas of the scientific community.

For example, the understanding of diseases that are linked to mitochondrial mutations has been dominated by procedures based on tissue extracts. The results of these procedures provide a value for the degree of mutations present in mitochondria. This value may be used, for example, to determine associations between the degree of mutations and the severity of the disease. Unfortunately, the outcome of this comparison is often far from ideal, because the effect of mitochondrial mutations cannot generally be well understood unless they are analyzed one at one time. Moreover, there is an ongoing need in the art for techniques capable of analyzing individual particles such as mitochondria.

Electrokinetic separation techniques are well known and include, for example, capillary electrophoresis, capillary isoelectric focusing, isotacophoresis, and gel electrophoresis. Such techniques have traditionally been used to separate and isolate chemical compounds.

U.S. Pat. No. 5,723,031 (Dürr et al.) discloses a method for the analytical separation of viruses, and recites that “[s]imply by calculation, for given viruses the detection limit using fluorescence detection is below that of a particle” (column 7, lines 36-38). Although Dürr et al. calculate the theoretical sensitivity of their method, they give no indication that their separation conditions were sufficient to actually separate individual viruses and/or that their apparatus was sufficiently sensitive to actually detect individual viruses.

Thus, there remains a need for analytical techniques that are capable of separating and evaluating individual particles.

### SUMMARY OF THE INVENTION

In one aspect, the present invention provides a method of detecting a particle. The method includes providing a sample including a plurality of particles; applying an electric field to separate a particle, preferably by electrophoresis; generating a signal characteristic of the separated particle; sampling the signal at a sampling rate effective to detect the separated particle; and providing output based on the sampled signal that is characteristic of the detected separated particle. Preferably the sample has a defined sample volume. Preferably, the signal is generated based on received light from fluorescence, and preferably laser induced fluorescence, by the separated particle; received light from light scattering by the separated particle; and/or received light from circular dichroic interactions with the separated particle. Preferably the particles include subcellular entities.

In another aspect, the present invention provides a method of detecting a particle, wherein the method includes: providing a sample including a plurality of particles; applying an electric field to separate a particle; generating a signal characteristic of the separated particle; sampling the signal at a rate of at least about 40 cycles per second to detect the separated particle; and providing output based on the sampled signal that is characteristic of the detected separated particle.

In another aspect, the present invention provides a method of detecting a particle including: providing a defined sample volume including a plurality of particles; directing the particles through a separation device; allowing the particles to interact with an inner surface of the separation device to separate a particle; generating a signal characteristic of the separated particle; sampling the signal at a sampling rate effective to detect the separated particle; and providing output based on the sampled signal that is characteristic of the detected separated particle.

In another aspect, the present invention provides a method of detecting a particle including: providing a defined sample volume including a plurality of particles; separating a particle; generating a signal characteristic of the separated particle; sampling the signal at a rate of at least about 40 cycles per second to detect the separated particle; and providing output based on the sampled signal that is characteristic of the detected separated particle.

In another aspect, the present invention provides a method of detecting a particle comprising: providing a defined sample volume comprising a particle; applying an electric field to displace the particle based on an electrophoretic property of the particle; and providing output characteristic of the displaced particle to detect the displaced particle. Preferably, the method further includes measuring the time to displace the particle. Optionally, the method further includes calculating the electrophoretic mobility of the displaced particle based on the measured time.

In another aspect, the present invention provides a method of detecting a plurality of particles including: providing a sample comprising a plurality of particles; directing the particles through a separation device to provide a plurality of separated particles; generating a signal characteristic of the separated particles; sampling the signal at a sampling rate effective to detect at least about 50% of the separated particles; and providing output based on the sampled signal that is characteristic of the separated detected particles. Preferably, the sample has a defined sample volume.

In another aspect, the present invention provides a system for detecting a particle. The system includes: a separation device operable to receive a defined sample volume including a plurality of particles; an electric field application device operable to apply an electric field across at least a portion of the sample volume to separate a particle; a signal generating device operable to generate a signal characteristic of the separated particle; and an output device operable to sample the signal at a rate effective to detect the separated particle and to provide output based on the sampled signal that is characteristic of the detected separated particle.

In another aspect, the present invention provides a system for detecting a particle, the system including: a separation device operable to receive a sample including a plurality of particles; an electric field application device operable to apply an electric field across at least a portion of the sample to separate a particle; a signal generating device operable to generate a signal characteristic of the separated particle; and an output device operable to sample the signal at a rate of at least about 40 cycles per second to detect the separated particle and to provide output based on the sampled signal that is characteristic of the detected separated particle.

In another aspect, the present invention provides a system for detecting a particle, the system including: a separation device including a defined sample volume including a plurality of particles, wherein the separation device has an inner surface that interacts with the particles; a device operable to direct the particles through the separation device to separate a particle; a signal generating device operable to generate a signal characteristic of the separated particle; and an output device operable to sample the signal at a rate of at least about 40 cycles per second to detect the separated particle and to provide output based on the sampled signal that is characteristic of the detected separated particle.

In another aspect, the present invention provides a system for detecting a separated particle provided in a separation device, wherein the separation device is operable to receive a defined sample volume including a plurality of particles. The system includes: a signal generating device operable to generate a signal characteristic of the separated particle; and an output device operable to sample the signal at a rate of at least about 40 cycles per second to detect the separated particle and to provide output based on the sampled signal that is characteristic of the detected separated particle.

In another aspect, the present invention provides a method of detecting a particle using a system for detecting a separated particle provided in a separation device, wherein the separation device is operable to receive a defined sample volume including a plurality of particles. The method includes: generating a signal characteristic of the separated particle; sampling the signal at a rate of at least about 40 cycles per second to detect the separated particle; and providing output based on the sampled signal that is characteristic of the detected separated particle.

The present invention provides methods and systems that separate and/or detect individual particles (e.g., organelles and liposomes). Preferably, characteristic properties of individual particles (e.g., electrophoretic mobility) can be calculated based on the detection of the individual particles, which is a significant improvement over the current state of the art. Significantly, particles in the nanometer to micrometer range can be detected. Such particles include, for example, subcellular entities such as mitochondria, nuclei, and lysosomes. Furthermore, the methods of the present invention are generally reliable and efficient. They require as little as nanoliter volumes of material and can detect particles in the aqueous phase.

In some embodiments of the present invention, methods are provided for separating and/or detecting intact particles (i.e., non-destructive methods). Non-destructive methods may be advantageous in that intact particles can, for example, be recovered for further analysis or other purposes. Furthermore, bioparticles and organelles can be studied in a separation medium without disrupting their biological stability or function. However, in some embodiments of the present invention, it may be desirable to disrupt a particle (e.g., rupture or digest) to characterize or analyze the contents of the particle.

The separation used in the methods of the present invention is preferably an electrophoretic separation. In addition to electrophoretic mobility, the various characteristics that may optionally be measured include, for example, scattering and fluorescence. These characteristics can be measured substantially simultaneously if desired. Other properties that can be determined based on direct scattering and/or fluorescence measurements include, for example, protein content, entrapped volume, membrane potential, DNA content, which are intrinsic to subcellular entities such as organelles or nanoparticles. For example, a single particle (e.g., an organelle) may be separated and identified, and the drug content of the particle (e.g., using a fluorescent drug) may be determined from measurements of the fluorescence of the single particle. Thus, the methods of the present invention provide an emerging alternative for the characterization of individual nanometer and micrometer size particles.

The methods of the present invention can also be used to differentiate between the particles of interest and contaminating particles. Thus, they can be used to monitor the quality of a given preparation. The particles can be micron (i.e., micrometer) or nanometer size particles (as occur in colloids, for example). The particles can be organelles or liposomes. They can be subcellular entities, such as mitochondria, nuclei, or lysosomes.

Definitions

As used herein, “particle” refers to a small, finite mass of material that is substantially insoluble in the medium in which it is contained. Particles useful in the present invention may be organic (e.g., biological particles) or inorganic. Useful particles include, for example, cellular particles, subcellular particles, micrometer sized particle, submicrometer sized particles, nanometer sized particles, microspheres, liposomes, and vesicles.

As used herein, “cellular” or “cells” refer to the smallest structural units of an organism that are capable of independent functioning, including one or more nuclei, cytoplasm, and various organelles, all surrounded by a semipermeable cell membrane. Cells typically have an average diameter of at most about 3 millimeters, and more typically at most about 1 millimeter. Cells typically have an average diameter of at least about 5 microns, more typically at least about 10 microns, and most typically at least about 20 microns.

As used herein, “subcellular” refers to components situated or occurring within a cell (e.g., subcellular organelles).

As used herein, “organelle” refers to a structurally discrete component of a cell. Organelles include, for example, nuclei (i.e., the major organelle of eukaryotic cells, in which the chromosomes are separated from the cytoplasm by the nuclear envelope), mitochondria (i.e., spherical or elongated organelles in the cytoplasm of nearly all eukaryotic cells, containing genetic material and many enzymes important for cell metabolism), lysosomes (i.e., membrane-bound organelles in the cytoplasm of most cells containing various hydrolytic enzymes), and peroxisomes (i.e., organelles containing enzymes, such as catalase and oxidase, that catalyze the production and breakdown of hydrogen peroxide).

As used herein, “micrometer sized particles” or “microparticles” refer to particles having an average size of at most about 10 microns. Micrometer sized particles preferably have an average size greater than about 1 micron. As used herein, for spherical particles, the average size is taken as the average diameter, and for non-spherical particles, the average size of a group of particles is taken as the average of the longest dimension of each particle in the group.

As used herein, “submicrometer sized particles” refer to particles having an average size of at most about 1 micron. Preferably, submicrometer sized particles have an average size greater than about 0.1 micron.

As used herein, “nanometer sized particles” refer to particles having an average size of at most about 100 nanometers (i.e., at most about 0.1 microns). Preferably, nanometer sized particles have an average size greater than about 1 nanometer.

As used herein, “microspheres” refer to submicrometer and/or micrometer sized particles that are preferably substantially spherical in shape.

As used herein, “vesicle” refers to a small bladder-like cavity, typically enclosed by a membrane. Typically, a vesicle is filled with an aqueous medium, membrane folds, and/or smaller vesicles.

As used herein, “liposome” refers to an artificial vesicle that has one or more continuous phospholipid bilayer membranes enclosing an aqueous interior. Liposomes are capable of encapsulating, for example, drugs, chemicals, and/or water soluble molecules.

As used herein, “separating a particle” or “separation” means that an individual particle is being or has been sufficiently spatially separated from a plurality of non-aggregated particles to enable detection of the individual, separated particle. The plurality of non-aggregated particles may include particles that are like and/or not like the particle being separated. A surface of a separated particle is preferably spatially separated from the surfaces of other particles by at least about 25 microns, and more preferably by at least about 50 microns. Alternatively, the surface of a separated particle is preferably spatially separated from the surface of other particles by at least about 100 times the diameter of the separated particle. The individual particle may be a non-aggregated particle or an aggregation of particles. As used herein, “aggregated” or “aggregation” refers to two or more particles that are held together by adsorption or electrostatic interactions during the separation process. Aggregated particles are not spatially separated (e.g., they have zero distance between the surfaces of adjacent particles).

As used herein, “displacing a particle” or “displaced particle” means that an individual particle is being or has been sufficiently moved or displaced by the electric field to enable measurement or calculation of a characteristic electrophoretic property of the particle (e.g., electrophoretic mobility).

As used herein, a “defined sample volume” refers to a sample that includes one or more particles, preferably in a fluidic medium (e.g., a fluidic sample). The volume of the defined sample is less than the volume of the separation device. Preferably the defined sample volume is at most about 1% by volume, more preferably at most about 0.5% by volume, and most preferably at most about 0. 1% by volume of the separation device. The volume of the separation device is the maximum volume of fluid that a separation device can hold at a particular time. As used herein, a “fluidic” sample includes suspensions, emulsions, sols, gels, solutions, and/or colloids, but not solids or gases.

As used herein, a “separation device” is a device in which particles may be separated. Separation devices include, for example, channels, gel structures, porous fibers, membranous tubes, beds of particles, nanostructures, and combinations therof.

As used herein, “detecting a particle” means that the output based on the sampled signal indicates the presence of a particle.

As used herein, “electrophoresis” refers to the migration of a charged particle suspended in an electrolyte experiencing an electric field. As used herein, an “electophoretic separation” refers to separating a particle using electrophoresis.

As used herein, “capillary electrophoresis” refers to electrophoresis using a capillary as the separation device.

As used herein, “electrophoretic mobility” means the ratio of the speed of the particle (centimeters per second, cm/s) divided by the electric field applied (volts per centimeter, V/cm), and is typically expressed in units of centimeters squared per volt per second) (e.g., cm²/V·s or cm²·V⁻¹·s⁻¹)

As used herein, “cuvette” refers to a transparent or translucent container for holding liquid samples. Preferably, the cuvette is a box-shaped container with precisely-measured dimensions.

As used herein, “sheath fluid” refers to a fluid that forms a sheath or covering by flowing, for example, between the outside of a capillary and the inside of a cuvette.

### BRIEF DESCRIPTION OF THE FIGURES

FIG. 1a is a schematic representation of a system of the present invention for detecting a particle. FIG. 1b is a schematic representation of a system of the present invention including a laser induced fluorescence (LIF) detector system for detecting a particle.

FIG. 2 depicts a continuous electromigration of 6-μm diameter fluorescein-labeled latex beads and their detection by post-column laser-induced fluorescence (x-axis is time in seconds, y-axis is fluorescence intensity in volts). The inset is a plot of the fluorescence intensity (x-axis) versus number of events (y-axis). Detected events include: single beads (79% of events), 2.25 to 5 V signals; bead fragments and bubbles (4% of events), 2.25 V<signal; and bead aggregates (17% of events), signal >5 V. For single-bead detection, the detector response shows a relative standard deviation of 10% (n=123). A bead suspension, 850 beads·μl⁻¹, in 2.5 mM sodium tetraborate, 10 mM SDS, pH 9.3 (BS buffer) was continuously electrokinetically injected at −200 V/cm. The fused-silica, 150 μm O.D., 50 μm I.D., capillary was coated with polyacryloylaminopropanol. Excitation: 488-nm argon-ion line. Fluorescence detection range: 522 to 552 nm. Scattering at 488-nm was blocked with a rejection band filter.

FIG. 3 depicts electropherograms of a liposome suspension. In Part A (x-axis is migration time in seconds, y-axis is fluorescence intensity in volts), the top electropherogram (offset +0.15 V) corresponds to a five-fold dilution of the original liposome suspension. The bottom trace corresponds to a 100-fold dilution of liposomes not containing fluorescein. In Part B (x-axis is migration time in seconds, y-axis is fluorescence intensity in volts), the migration window from 710 to 720 seconds in the electropherogram corresponding to the 5-fold dilution (top trace, Part A) was expanded. Electrokinetic injection: −50 V·cm⁻¹ for 5 seconds. Separation: −200 V·cm⁻¹ in 250 mM sucrose, 10 mM HEPES, pH 7.5 in a 50-μm I.D. poly-AAP coated capillary. Fluorescence detection: 20 mW, 488-nm excitation, 535±17 nm band-pass, 1000 V PMT bias. Data acquisition: 50 cycles per second (Hz).

FIG. 4 depicts histogram distributions (y-axis, number of events) of liposome entrapped volume (x-axis, femtoliters, fL, Part A) and electrophoretic mobility (x-axis, cm²·V⁻¹·s⁻¹, Part B). Data correspond to the five-fold dilution of fluorescein-containing liposomes shown in FIG. 3A. Only events with signals larger that five times the standard deviation of the background were included in the distribution.

FIG. 5 depicts a density plot of reduced electrophoretic mobility (y-axis) versus apparent κR (x-axis) for individual liposomes. Each liposome is represented by a set of dimensionless coordinates (μ_{R}, κR). Data correspond to the five-fold dilution of fluorescein-containing liposomes shown in FIG. 3A. The Debye parameter K was calculated from the buffer ionic strength (Schnabel et al., Langmuir, 15:1893-1895 (1999)). The radius calculation is based on Equation 3. The reduced electrophoretic mobility μ_{R} was calculated using Equation 4.

FIG. 6 illustrates the detection of individual mitochondria by CE-LIF during continuous electrokinetic introduction. Part A shows the 600-second data collection window (x-axis is seconds, y-axis is fluorescent intensity in volts). Part B shows a 10-second window (x-axis is seconds, y-axis is fluorescent intensity in V) from part A indicated by the arrow. Mitochondria were a sampled from the 6% Pc/17% Mz fraction. This fraction was prepared from 0.32 million MAK cells that were separated in a discontinuous gradient after homogenization, labeled with a label available under the trade designation MitoTracker Green, and diluted two-fold in Buffer B prior to analysis. CE-LIF analysis was performed by continuous electrokinetic introduction at −200 V/cm in 250 mM sucrose, 10 mM Hepes, pH 7.4. Data collection started 1000 seconds after the onset of the electric field. Only peaks (asterisk) with a signal higher than five times the standard deviation of the corrected background were considered for mitochondria counting and further analysis.

FIG. 7 illustrates distributions of mitochondrial protein content in various interfaces. Peak height of detected events (y-axis) in a 600-second window (see Figure) are used as a protein index (x-axis, arbitrary units, A.U.). Data from the interfaces 17% Mz/35% Mz, 6% Pc/17% Mz, and Top/6% Pc are plotted as distributions A, B, and C respectively. The false positives (blank) for each interface (gray tone bars) are shifted to the right for the sake of clarity. The distributions in C have a low number of events in comparison to A and B (see Table 3).

FIG. 8 illustrates differences between the two interfaces that contain most of the mitochondria. The distributions of the interfaces 17% Mz/35% Mz and 6% Pc/17% Mz (FIG. 7) were normalized with respect to the total number of detected events in each corresponding distribution. The normalized distributions were subtracted (y-axis). At a given protein index (x-axis, A.U.), positive values indicate that a larger percentage of mitochondria are found in the 17% Mz/35% than in the 6% Pc/17% Mz interface. Negative values indicate the opposite.

FIG. 9 illustrates the output of capillary electrophoresis (x-axis is migration time in seconds, y-axis is fluorescence) of mitochondria prepared from NS1 cells. Forty-seven spikes are present in the upper trace in Part A resulting from the analysis of mitochondria isolated from cells treated with NAO. In Part B three spikes are better appreciated in the expansion of a 4 second migration time window, equivalent to the width of the arrow. The lower trace in Part A is a control containing 10⁻⁵ M NAO alone. The middle trace in Part A is a control containing mitochondria from cells that were not labeled with NAO. Samples were introduced electrokinetically for 5 seconds at −100 Vcm⁻¹. Separations were performed at −200 V⁻¹ in a 27.4 cm 50 μm inside diameter poly-AAP coated capillary in a 10 mM HEPES, 250 mM sucrose. Excitation: 488 nm argon line. Detection: 522-552 nm.

FIG. 10 depicts a plot of events sorted in order of increasing intensity (x-axis, %). All those peak signals higher than 0.0114 V (y-axis is fluorescence), a threshold equal to 3σ in the range (0 to 300 seconds) are included. The percentage scale of the x-axis facilitates comparison of regions with different numbers of events. Circles correspond to the mitochondrial electropherogram, upper trace, FIG. 9A; the dotted line corresponds to unlabeled mitochondria, middle trace, FIG. 9A; the solid line corresponds to NAO control, lower trace, FIG. 9A. The data above were all collected in the migration window 300-1170 s. The data marked with ‘+’ correspond to the mitochondrial electropherogram, upper trace, FIG. 9A in the migration window 0-300 seconds.

FIG. 11 illustrates an electrophoretic mobility distribution (y-axis is number of events). The migration time for detected events with signals higher than 0.02 V were used to calculate the electrophoretic mobility of the event (x-axis, cm²V⁻¹s⁻¹). Bins are 0.225×10⁴ cm²V⁻¹s⁻¹ wide. The mitochondrial isolate was analyzed in triplicate. The height of the thick bar represents the average while the thin line represents one standard deviation. Other conditions are as described for FIG. 9.

FIG. 12 illustrates a plot (y-axis is number of events) of the electrophoretic mobility (x-axis, cm²V⁻¹s⁻¹) for mitochondria isolated from NS1 and CHO cells. The upper distribution, vertically offset for clarity, corresponds to CHO cells; the lower distribution corresponds to NS1 cells. Mitochondrial isolation is described in the Example 3. CE-LIF experiments were as described for FIG. 9 for NS1 cells and in Example 3 for CHO cells. Data analysis was done in a manner similar to that outlined for FIGS. 10 and 11.

FIG. 13 is a comparison between high-density and low-density mitochondrial distributions (x-axis is electrophoretic mobility, cm²V⁻¹s⁻¹; y-axis is number of events). High-density (1.1079-1.1907 g/ml) and low-density (1.0406-1.1079 g/ml) mitochondria were collected from the Mz 17%/Mz 35% interface (black bars) and the Pc 6%/Mz 17% interface (light bars), respectively. Other conditions were as outlined for FIG. 9 and data analysis was done in a manner similar to that outlined for FIGS. 10 and 11.

FIG. 14 is an illustration of the structures of 10-N-nonyl acridine orange (NAO) and cardiolipin. Cardiolipin forms a 1:1 complex with NAO, (complex 1) with absorbance and emission maxima of 495 and 525 nm, respectively. The 2:1 complex (complex 2) has absorbance and emission maxima at and 450 and 640 nm, respectively (e.g., Petit et al., Eur. J. Biochem., 220:871-879 (1994).

FIG. 15 depicts a fluorescence spectra of mitochondria stained with NAO (x-axis is emission wavelength in namometers, y-axis is fluroescence in A.U.). NAO concentration (micromolar) varies as indicated for the labeled curves. Between 0.05 μM and 0.01 μM NAO concentration, spectra exhibited negligible fluorescence and were omitted. An estimate of mitochondria density in the samples is 1.4×10¹⁰/mL. Excitation was at 488±3 nm. Vertical lines indicate the region of the spectra that was integrated.

FIG. 16 is a NAO green fluorescence saturation plot. Spectra in FIG. 15 were integrated from 517 to 552 nm and the resultant fluorescence peak areas (nanometers times fluorescence intensity, y-axis) are plotted against concentration NAO (micromolar, x-axis).

FIG. 17 is an illustration of an electropherogram (x-axis is migration time in seconds, y-axis is fluorescence intensity in volts) of mitochondria saturated with NAO. Mitochondria were stained with 5 μM NAO. For mitochondrial analysis, the suspension was electrokinetically injected for 10 seconds at −200 V/cm and separated at −200 V/cm. Inset is an enlarged view of a mitochondrial event.

FIG. 18 is a histogram of cardiolipin content (x-axis in attomoles of cardiolipin, amol) for number of events (y-axis) in FIG. 17. Cardiolipin content was calculated for peaks with heights larger than three standard deviations (3%). Two hundred eighty events are shown, 81 were subtracted based on the rate of occurrence of noise events outside of the migration time window (0.09 noise events/second), 46 events with high cardiolipin content were excluded to facilitate display of the events with lower cardiolipin content.

FIG. 19 is an illustration of the individual detection of microspheres (x-axis is migration time in seconds, y-axis is fluorescence intensity in volts). 6.0-μm diameter microspheres were diluted in either borate-SDS buffer (Part A) or borate buffer (Part B). The top trace in Parts A and B corresponds to an electrokinetic injection (5 seconds at −100 V/cm) of several microspheres in a suspension. Similarly the bottom trace corresponds to the selective siphoning (1-second, −11.2 kPa) of one microsphere held on a slide by micropositioning the capillary injection on top of the microsphere. Separations were carried out at −400 V/cm in a 50-μm inside diameter, 36.3-cm long poly-AAP coated capillary. Other experimental details are given in Example 5.

FIG. 20 is a plot of migration time variation (y-axis in seconds) in borate and borate-SDS buffers (x-axis is analysis number). For borate buffer (data above 150 seconds, y-axis) twelve consecutive electrokinetic injections were done as for FIG. 19. For each consecutive analysis (x-axis) the migration times for the detected microspheres are represented by one horizontal dash (y-axis). The trace joins the median migration time for each analysis. After the twelve electrokinetic injections, six one-microsphere injections were performed. The same strategy was followed for the borate-SDS buffer (data herein, 150 seconds, y-axis).

FIG. 21 is a two dimensional representation. For each detected event, its coordinates represent the measured fluorescence intensity (y-axis, fluorescence intensity in volts) and calculated electrophoretic mobility (x-axis, cm²V⁻¹s⁻¹). For 1.0, 0.5, and 0.2-μm diameter sizes, 4, 3, and 3 electropherograms were used to obtain the data (Table 5 and Table 6). Open circles, smaller black circles, and dots represent 1.0, 0.5, and 0.2-μm diameter microspheres, respectively. Larger dots in the 0.2-μm diameter microsphere region are an artifact of the limited resolution of the print out; events were resolved in the original electropherograms. Separations were carried out at −200 V/cm in a 50-μm inside diameter, 34.1-cm long, poly-AAP coated capillary. The separation buffer was 10 mM borate-SDS.

FIG. 22 is a plot of electrophoretic mobility (x-axis, cm²V⁻¹s⁻¹) as a function of κR (y-axis). Each dash mark represents one point from the data in FIG. 21. κ=0.47 nm⁻¹ was calculated according to the expression 3.288 √I, where I=0.020 M for the borate-SDS buffer (Radko et al., Electrophoresis, 21:3583-3592 (2000)). The particle radius is determined by its diameter, which is indicated on the top of the graph. One line joins the average mobility and the other line joins the median mobility for each particle size.

FIG. 23 depicts a confocal image of a nuclear preparation. The preparation was stained with 1.0 μM of a stain available under the trade designation SYTO-11 from Molecular Probes (Eugene, Oreg.) for 1 hour. The magnification used was 600×; the bar on the bottom left denotes 10 μm. The circles indicate disrupted nuclei.

FIG. 24 illustrates electropherograms of a nuclear preparation (x-axis is migration time in seconds, y-axis is signal intensity in volts). The preparation was stained with hexidium iodide as described herein. A bare fused-silica capillary (37.1 cm) was used. Electrokinetic injection: 400 V/cm, 5 seconds; separation: 400 V/cm. Part A shows the raw data in the window from 150-550 seconds. Part B is the electropherogram of the broad peaks obtained after 9-point median filtering. The culture medium (peaks 1,3) and dye peaks (peak 2) are indicated. Part C is the electropherogram of narrow events. For clarity Part A and B are offset by 10 V and 13 V, respectively.

FIG. 25 depicts electrophoretic mobility and fluorescence intensity distributions (y-axis is percentage of events). Histograms representing average distributions of electrophoretic mobility (panel A, x-axis, x10⁻⁴ cm²V⁻¹s⁻¹) and fluorescent intensity (panel B, x-axis, volts) of nuclei for three consecutive injections of the same nuclear preparation are shown. Bin sizes for mobility and fluorescence intensity are 6×10⁻⁶ cm²/V·s and 0.003V, respectively. Errors in the bin allocation is expected to be 4% from the reproducibility of electrophoretic mobility of broad peaks in FIG. 24B and 30% from the reproducibility in detector response. Each distribution replicate was normalized by its number of events. CE-LIF conditions are the same as for FIG. 24. About 15% of the events with mobilities more negative than −5.0×10⁻⁴ cm²/V·s are not shown.

FIG. 26 compares the mobility distributions (x-axis is mobility in units ×10⁻⁴ cm²V⁻¹s⁻¹; y-axis is signal intensity in volts) of MitoTracker Green-stained versus hexidium iodide-stained nuclear preparations. Individual events are represented by squares (hexidium iodide) or triangles (MitoTracker Green). Identical aliquots of the nuclear preparation were stained with 0.5 μM hexidium iodide, or with 10 μM MitoTracker Green for 30 minutes at room temperature prior to analysis. CE-LIF conditions are the same as for FIG. 24, except the capillary length was 40.2 cm.

FIG. 27 illustrates a plot of the migration time in seconds (x-axis) versus the fluorescence intensity in volts (y-axis) without background correction for a capillary electrophoresis experiment attempting to separate nuclei using a gel-containing column (e.g., agarose).

FIG. 28 is a schematic representation of a portion of an embodiment of a detection system of the present invention including modified commercially available instrumentation for improved data acquisition.

FIG. 29 illustrates a plot of the migration time in seconds (x-axis) versus relative fluorescence units (y-axis) for a capillary electrophoresis experiment using a modified commercially available system to separate polystyrene microspheres.

### DETAILED DESCRIPTION OF PREFERRED EMBODIMENTS

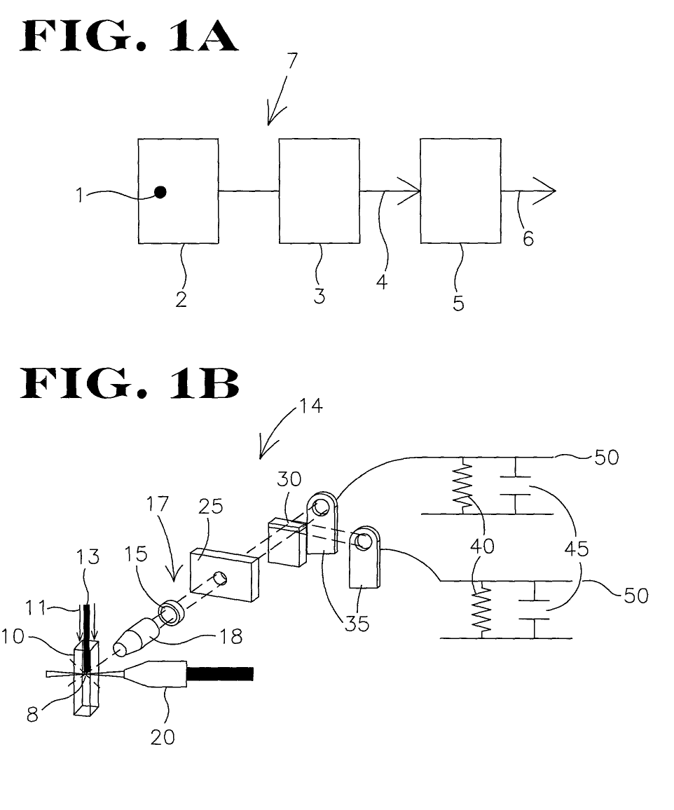

The present invention provides systems and methods for detecting separated particles. Referring to FIG. 1a, in system 7, particle 1 is preferably provided in separation device 2. Particle 1 is preferably separated or displaced by separation device 2, and provided for detection by detection system 3. Detection system 3 is preferably a signal generating device operable to generate signal 4 characteristic of the separated particle. Signal 4 is provided to output device 5, which is preferably operable to sample signal 4 at a rate effective to detect the separated particle, and to provide output 6 based on the sampled signal that is characteristic of the separated particle.

Organic particles (e.g., biological particles including, for example, subcellular particles and platelet derived microparticles) and/or inorganic particles may preferably be separated and detected. Synthetic (e.g., polystyrene spheres) and/or naturally occurring particles (e.g., sucellular particles) may preferably be separated and detected. Examples of particles that may be separated and detected preferably include, for example, cellular particles, subcellular particles (e.g., organdies), micrometer sized particle, submicrometer sized particles, nanometer sized particles, microspheres, microbes, nanotubes, liposomes, and vesicles. Preferably, the systems and methods of the present invention may detect separated organelles including, for example, nuclei, mitochondria, lysosomes, and peroxisomes.

Preferably, the systems and methods of the present invention can detect separated micrometer sized particles, more preferably submicrometer sized particles, and most preferably nanometer sized particles. Preferably, the systems and methods of the present invention can detect cellular particles, and more preferably subcellular particles.

For embodiments of the present invention in which laser induced fluorescence is used to detect a particle, it is preferable that the particle has fluorescent properties. Preferably, the particle is stained to enhance fluorescence (e.g., the stain includes a fluorescent dye). Preferred stains include, for example, fluorescein; a stain available under the trade designation MitoTracker Green; 10-nonyl acridine orange (NAO); and combinations thereof. The particle may be stained prior to being introduced into the separation device and/or while inside the separation device.

Particles may be provided from a wide variety of sources. For example, particles may be provided from a whole cell suspension. As another example, particles may be provided from tissue and/or cell preparations and purifications (e.g., cross-sections of tissues such as histological plates of muscle tissue), which may result, for example, in whole cell or subcellular homogenates. As a further example, particles may be provided as molecularly engineered nanoparticle suspensions or artificially made liposomes. Particles (e.g., organelles, microparticles) may also be provided from the disruption of one or more cells, which may optionally occur inside the separation device.

Typically, samples that include particles are provided in a fluid (i.e., fluidic samples). The fluid may be, for example, an organic liquid or an aqueous liquid, and is preferably an aqueous fluid. As used herein, a “fluidic” sample includes suspensions, emulsions, sols, gels, solutions, and/or colloids, but not solids or gases.

When an electric field is applied to separate or displace a particle, the fluid typically includes an electrolyte. Useful electrolytes include, for example, aqueous solutions of salts or buffers. Useful electrolytes include, for example, phosphate salts, 4-(2-hydroxyethyl)-1-piperazineethanesulfonic acid (HEPES), N-[tris(hydroxymethyl)methyl]glycine (Tricine), borate salts, potassium chloride, sodium chloride, sodium dodecyl sulfate (SDS), and combinations thereof. When the fluid includes electrolytes, the fluid preferably includes at least about 1 mM electrolyte, more preferably at least about 5 mM electrolyte, and most preferably at least about 8 mM electrolyte. When the fluid includes electrolytes, the fluid preferably includes at most about 50 mM electrolyte, more preferably at most about 20 mM electrolyte, and most preferably at most about 15 mM electrolyte.

The fluid may include additives such as buffers, simple sugars (e.g., sucrose, mannitol), protein standards, polymers (e.g., agarose, ampholytes), cyclodextrins, and surfactants (e.g., digitonin). For example, in the cases of organelles, electrophoretic separation involves the use of an isotonic buffer as a separation medium. This buffer helps to reduce or eliminate osmotic pressure differences between the interior and exterior of the organelle, thus preventing swelling or shrinking of the organelle.

The fluid may also include additives that minimize or prevent aggregation. Useful additives for this purpose include, for example, mannitol. However, in the case of particles enclosed by a membrane, fluids and additives are preferably selected that do not disrupt the membrane during the analysis process. For example, sodium dodecyl sulfate (SDS) is preferably avoided when analyzing mitochondria.

When the fluid includes a simple sugar, the fluid preferably includes at least about 10 mM simple sugar, more preferably at least about 100 mM simple sugar, and most preferably at least about 200 mM simple sugar. When the fluid includes simple sugars, the fluid preferably includes at most 350 mM simple sugar, more preferably at most about 300 mM simple sugar, and most preferably at most about 275 mM simple sugar.

For some embodiments (e.g., for separating biological particles), it is preferred that the fluid be buffered to a suitable pH. In these embodiments, the fluid is preferably buffered to a pH of at least about 3, more preferably at least about 6, and most preferably at least about 7. In these embodiments, the fluid is preferably buffered to a pH of at most about 9, more preferably at most about 8.5, and most preferably at most about 8.

For some embodiments (e.g., for separating biological particles), it is preferred that the osmolarity of the fluid (i.e., the total moles of species per liter) is preferably at least about 10 mM, more preferably at least about 200 mM, and most preferably at least about 250 mM. In these embodiments, the osmolarity of the fluid is preferably at most about 500 mM, more preferably at most about 400 mM, and most preferably at most about 300 mM. In these embodiments, the fluid preferably has low conductivity (e.g., less than about 2×10⁻³ ohm·cm⁻¹, and more preferably less than about 5×10⁻⁴ ohm·cm⁻¹). In these embodiments, the fluid preferably includes, for example, simple sugars (e.g., sucrose, mannitol) and zwitterionic species (e.g., HEPES and/or 3-[(3-cholamidopropyl)dimethylammonio]-1-propanesulfonate hydrate (CHAPS)).

Samples used in the present invention include one or more particles, preferably a plurality of particles (i.e., two or more particles). The desired concentration of particles in the sample will depend on both the particular separation method and the particular detection method chosen. Generally, it is desirable to use a high enough concentration to enhance sensitivity, but a low enough concentration to enhance separation. Operable concentration ranges for each system can easily be determined without undue experimentation. For some embodiments of the present invention using capillary electrophoresis as the separation technique and laser induced fluorescence as the detection technique, the concentration of particles in the sample is preferably at least about 1 particle per nanoliter, more preferably at least about 50 particles per nanoliter, and most preferably at least about 500 particles per nanoliter. For the same embodiment, the concentration of particles in the sample is preferably at most about 2000 particles per nanoliter, more preferably at most about 1000 particles per nanoliter, and most preferably at most about 600 particles per nanoliter.

Separation Devices

In preferred methods and systems of the present invention, a separation (e.g., electrophoretic separation, affinity chromatographic separation) may be carried out in a separation device as illustrated, for example, by 2 in FIG. 1a. A separation device is a device in which particles may be separated. Suitable separation devices include, for example, channels, gel structures, porous fibers, membranous tubes, beds of particles, nanostructures, and combinations thereof. Preferably, the separation device includes a channel. A channel may be a single channel (e.g., a capillary or a column), a channel within a microfabricated device, or a plurality of channels (e.g., a bundle of capillaries or a multichannel device).

For electrophoretic separations, a capillary is a preferred separation device. Typical capillaries include fused silica, polycarbonate, polyurethane, and combinations thereof. Preferred capillaries have an inside diameter of at least about 2 micrometers, more preferably at least about 10 micrometers, and most preferably at least about 40 micrometers. Preferred capillaries have an inside diameter of at most about 100 micrometers, more preferably at most about 75 micrometers, and most preferably at most about 60 micrometers. Preferred capillaries have a length of at least about 10 cm, and more preferably at least about 30 cm. Preferred capillaries have a length of at most about 100 cm, and more preferably at most about 40 cm.

For some embodiments, it is preferred that the inside surface of the capillary be coated with a material to increase or decrease the interaction of the particle with the surface as described, for example, in Gelfi et al., Electrophoresis, 19:1677-1682 (1998). Useful materials for coating the inside surface of the capillary include, for example, polyacrylamide, poly(acryloylaminopropanol), poly(ethylene glycol), polyethylene oxide, and combinations thereof.

The selection of the coating material will depend on the nature of the particles being separated. For some embodiments of the present invention, a preferred coating material results from polymerizing a monomer inside a capillary (e.g., poly(acryloylaminopropanol, poly-AAP, available, for example, from Applied Biosystems, Foster City, Calif.). For other embodiments, dynamic capillary coatings may be employed by providing the coating material in the fluid. Exemplary dynamic coatings include, for example, glycine (e.g., at about 250 MM in the fluid), BSA (e.g., at about 20 mM in the fluid), and poly(vinyl alcohol) (PVA, e.g., at about 0.01% by weight in the fluid).

For embodiments of the present invention employing capillary electrophoretic separation devices, preferred separation devices are described, for example, in Duffy et al., Anal. Chem., 73:1855-1861 (2001); Strack et al., Analytical Biochemistry, 294:141-147 (2001); and Duffy et al., Anal. Chem., 74:171-176 (2002).

In some embodiments of the present invention, the separation device may receive a defined sample volume, which includes a plurality of particles, preferably in a fluidic medium (e.g., a fluidic sample). The volume of the defined sample is less than the volume of the separation device. Preferably the defined sample volume is at most about 1% by volume, more preferably at most about 0.5% by volume, and most preferably at most about 0.1% by volume, based on the volume of the separation device. The volume of the separation device is the maximum volume of fluid that a separation device can hold at a particular time.

Samples may be introduced into the separation device by a wide variety of suitable techniques known in the art. For example, when the separation device is a capillary, the capillary preferably includes an application end (e.g., an inlet). Illustrative techniques include, for example, hydrodynamic injections, electrokinetic injections, and combinations thereof. Hydrodynamic injections may be made by subjecting the application end of the separation device to a higher differential pressure than the detection end of the separation device during the injection stage. For example, a sample (e.g., liquid, slurry, tissue) may be placed in contact with the application end, which is then subjected to a higher differential pressure than the detection end. Useful techniques for creating a pressure differential include, for example, changing the relative heights of the ends, pumping (e.g., using a syringe pump), and/or applying a vacuum. Electrokinetic injections may be made by placing a sample (e.g., liquid, slurry, tissue) in contact with the application end, and then applying an electric field for a short period of time (e.g., about 1 second to about 10 seconds). Hydrodynamic injections and/or electrokinetic injections may also be used in combination with a valving mechanism that allows access to a sample in a different reservoir or channel.

Separation Techniques

Particles detected as described in the present application may be separated or displaced by a wide variety of techniques known in the art. For example, particles may be separated or displaced techniques involving the application of an electric field (e.g., electrophoresis, isoelectric focusing), techniques not involving the application of an electric field (e.g., affinity chromatography), or combinations thereof.

In some embodiments of the present invention, particles are separated or displaced by application of an electric field. Generally, charged particles in a separation device may be induced to move towards a detector by the application of an electric field. Two possible mechanisms are described herein. In the first instance, charged particles move towards the detector solely due to their electrophoretic mobility. In this case, the negative particles require a negative potential and positive particles require a positive potential at the starting end. In the second instance, the direction of movement is further affected by electroosmotic flow, a property dependent on the ionization of the walls of the channel or capillary where the separation is performed. In addition, the mobility may be affected by additives in the separation buffer. Examples of these additives include, for example, components that will maintain isotonicity (e.g., sucrose and mannitol), surfactants (e.g., digitonin), and polymers (e.g., agarose or ampholytes).

Techniques for separating or displacing particles by application of an electric field include, for example, electrophoresis (e.g., Radko et al., J. Chromatogr., B722:1-10 (1999)) and isoelectric focusing (see, for example, PCT International Publication Number WO 02/00100 (Armstrong); Armstrong et al., Anal. Chem., 71:5465-5469 (1999)). A preferred technique is electrophoresis, and a particularly preferred technique is capillary electrophoresis. See, for example, Landers et al., Handbook of Capillary Electrophoresis, CRC Press (Boca Raton, Fla., 1997)) for a description of capillary electrophoresis.

Briefly, in capillary electrophoresis, the applied electric field (volts per centimeter, V/cm), either positive or negative, can be chosen to effect the separation as desired. Preferably the electric field is at least about 10 V/cm, more preferably at least about 100 V/cm, and most preferably at least about 200 V/cm. Preferably the electric field is at most about 600 V/cm, more preferably at most about 400 V/cm, and most preferably at most about 300 V/cm.

For uncoated capillaries, electroosmotic flow occurs in the capillary. For coated capillaries, there is generally no substantial bulk flow.

In addition to buffer conditions described herein, the fluid viscosity and the temperature of the separation device have an effect on separation, and they may be varied, with guidance provided in the present specification, to arrive at the desired degree of separation. The viscosity of the fluid is preferably low, and more preferably the viscosity of the fluid is substantially the same as the viscosity of water.

Preferably, the temperature of the separation device is at least about 4° C., and more preferably at least about 20° C. Preferably, the temperature of the separation device is at most about 37° C., and more preferably at most about 30° C.

For embodiments of the present invention employing capillary electrophoresis, useful operational parameters are described, for example, in Duffy et al., Anal. Chem., 73:1855-1861 (2001); Strack et al., Analytical Biochemistry, 294:141-147 (2001); and Duffy et al., Anal. Chem., 74:171-176 (2002).

In electrophoretic separations as disclosed in the present invention, the morphology (e.g., deformability), size, and zeta potential (which depends on, among other things, the nature of the surface and the charge) of each particle are responsible for each particle having slight variations in electrophoretic behavior. Thus, even when two particles appear to be identical under examination by other analytical methods, each individual particle typically exhibits unique electrophoretic behavior.

Techniques for separating particles that do not depend on application of an electric field include, for example, interaction of particles with a surface (e.g., affinity chromatography). Such techniques may be used either alone or in conjunction with a separation technique involving the application of an electric field. For example, an uncoated interior surface of a capillary column may tend to interact with particles to effect a separation. Alternatively, the inner surface of the capillary column may be coated with a material known to interact with the particles being separated.

Detection of Particles

A particles may be detected by a detector system as illustrated, for example, by 3 in FIG. 1a. Particles may be detected while the particle is in the separation device or after the particle has been displaced outside the separation device. For example, when using a capillary as a separation device, the particle may be detected either on column or post column.

Detectors useful in the present invention employ a signal generating device to generate a signal characteristic of a separated particle (e.g., based on electrochemical characteristics of the particle, received light from the separated particle, etc.). Preferred signal generating devices generate a signal based on at least a received light characteristic of the separated particle. For example, the signal may be based on received light from fluorescence (e.g., laser induced fluorescence) by the separated particle, received light from light scattering (e.g., Rayleigh scattering, Raman scattering) by the separated particle, and/or received light from circular dichroic interactions with the separated particle.

Typically, the signal is generated as an analog signal that may be converted to a digital signal and sampled at a desired sampling rate. For some embodiments of the present invention, the sampling rate is preferably at least about 40 cycles per second, more preferably at least about 50 cycles per second, even more preferably at least about 75 cycles per second, and most preferably at least about 100 cycles per second. For some embodiments of the present invention, the sampling rate is at most about 1000 cycles per second, more preferably at most about 200 cycles per second, and most preferably at most about 150 cycles per second. For some embodiments of the present invention, sampling rates as low as even about 20 cycles per second may be utilized.

For some embodiments of the present invention that include separation of particles, selection of higher sampling rates may result in improved efficiency in detecting separated particles. For example, for some embodiments of the present invention, sampling rates of at least about 50 cycles per second, more preferably at least about 75 cycles per second, and most preferably at least about 100 cycles per second, preferably result in detecting at least about 50% of the separated particles, more preferably at least about 80% of the separated particles, even more preferably at least about 95% of the separated particles, and most preferably substantially all of the separated particles. Additionally, for some embodiments of the present invention, higher sampling rates (e.g., preferably at least about 50 cycles per second, more preferably at least about 75 cycles per second, and most preferably at least about 100 cycles per second) preferably result in improvements in characterization of the detected separated particles (e.g., higher resolution, characteristic spikes).

Systems described in the present application have a characteristic time constant. A time constant is the time that it takes an instrument to react to a stimulus. When the limiting factor in the reaction time is an electrical component, the time constant is defined as RC, wherein R represents a resistance value, and C represents a capacitance value. Preferably the time constant is shorter than the cycle used in the sampling rate. Time constants are easily adjusted, for example, by changing values of a resistor and a capacitor connected in parallel to ground. For some applications, it may be desirable to modify the time constant of commercially available systems (e.g., a capillary electrophoresis system available under the trade designation P/ACE MDQ from Beckman Coulter, Fullerton, Calif.). The time constant is selected so that the response is not artificially broadened further than the time for the particle to travel through the laser beam. Typically, the travel time is on the order of milliseconds. In addition to the geometry that provides high sensitivity detection, the fast time constant provides for detection of individual particles traveling in close proximity to each other. For example, when using a laser induced fluorescence detector, the sampling rate and time constant are preferably selected to be less than the time for the particle to travel across the laser beam (e.g., a focused laser beam).

Referring to FIG. 1b, a preferred post-column laser induced fluorescence detector system 14 is described. The detector system 14 is similar to that described by Wu et al., J. Chromatogr., 480:141-155 (1989). A particle 8 is detected in cuvette 10, preferably a quartz cuvette into which a sheath fluid 11 is flowing. Preferably the composition of the sheath fluid 11 is the same as the composition of the sample volume fluid provided in separation device 13. The detector system 14 includes an optical system 17 and one or more light detectors 35 sensitive to one or more wavelengths of light, and which generate a signal as a function of detected light. The optical system 17 may be any suitable light focusing system. For example, as shown in FIG. 1b, the optical system 17 includes an objective lens 18 to focus the light towards a rejection filter 15 (e.g., a 505ALP filter, Omega Scientific) to remove scattering, thereby making fluorescent signals clearly distinguishable from background. This filter is useful in conjunction with the argon-ion laser 20. Other features common to other optical systems include: (i) a spatial filter 25 (e.g., a pinhole) located at the image plane inside the detector that facilitates imaging of the detection volume and further eliminates scattering from the surrounding regions to the detection volume; (ii) a dichroic beam splitter 30 that selects and passes one or more different wavelengths out to one or more suitable light detectors 35. For example, the dichroic beam splitter 30 may select fluorescence and eliminate Raman and Raleigh scattering. The detector described in this invention can also be used without the rejection filter, facilitating scattering detection that then can be detected with one of the two photo-detector channels 35. The channel outputs are measured through a set of resistors 40 (e.g., about one megaohm) and capacitors 45 (e.g, about 0.1 to about 10 nanofarad) connected in parallel, with the signals 50 output to a computer.

In addition to the post-column detection, the geometry of the detector described in this invention can also be used to detect particles traveling through a window in a microfabricated channel or through a window in a capillary. Furthermore, the overall geometry of the detector can be modified in various ways to achieve similar results.

For embodiments of the present invention employing laser induced fluorescence detectors, preferred detectors are described, for example, in Lee et al., Anal. Chem., 70:546-548 (1998); Duffy et al., Anal. Chem., 73:1855-1861 (2001); Strack et al., Analytical Biochemistry, 294:141-147 (2001); and Duffy et al., Anal. Chem., 74:171-176 (2002).

The digital data that is gathered may be analyzed and manipulated for output by techniques known in the art. In some embodiments of the present invention, it may be useful to only process data having values larger than a set threshold. For example, it may be useful to only process data having values larger than a multiple of the standard deviation of the background.

Systems and methods of the present invention may output processed data as, for example, the peak of a fluorescent spike, a scattering spike, or scattering and fluorescent spike in addition to the migration time of the particle. The migration time may be directly used to calculate mobility (e.g., electrophoretic mobility). The data can be output, for example, as plotted distributions or multiple dimensional plots. The data can be output in any convenient visible or audible form to enable one of skill in the art to detect the particle or one or more characteristics of the particle.

For embodiments of the present invention employing laser induced fluorescence detectors, preferred methods and devices for signal sampling, data analysis, and data output are described, for example, in Duffy et al., Anal. Chem., 73:1855-1861 (2001); Strack et al., Analytical Biochemistry, 294:141-147 (2001); and Duffy et al., Anal. Chem., 74:171-176 (2002).

Advantageously, systems and methods of the present invention are preferably nondestructive. That is, they do not destroy the sample. For example, after scattering or fluorescence detection, the sample can be further collected for analysis or processing. As an example, a sample can be directly deposited in a collection device (e.g., a commercial vial, a microfabricated device, or a plate) for further analysis (e.g., mass spectrometry (MS), polymerase chain reaction (PCR), and electron microscopy).

The present invention is illustrated by the following examples. It is to be understood that the particular examples, materials, amounts, and procedures are to be interpreted broadly in accordance with the scope and spirit of the invention as set forth herein.

### EXAMPLES

### Example 1

### Determination of Properties of Individual Liposommes

Reagents. HEPES, (N-[2-hydroxyethyl]piperazine-N-[ethanesulphonic acid]), phosphatidyl choline (PC), phosphatidyl ethanolamine (PEA), phosphatidyl serine (PS), and cholesterol were purchased from Sigma (St. Louis, Mo.). Capillary electrophoresis buffers contained 250 mM sucrose, 10 mM HEPES, pH 7.5 (sucrose-HEPES buffer) and 2.5 mM sodium tetraborate, 10 mM sodium dodecyl sulfate, pH 9.3 (BS buffer). All buffers were made with de-ionized water and filtered (0.2 micrometer) prior to use. A stock solution of 10⁻³ M fluorescein (Molecular Probes; Eugene, Oreg.) was prepared in ethanol. Dilutions were prepared immediately prior to use.

Liposome preparation. Phospholipid stock solutions, 1.23×10⁻²M PS, 1.3×10⁻² M PEA, 1.29×10⁻² M PC, and 2.5×10⁻²M cholesterol were prepared in chloroform. The phospholipids PC, PS, PEA and cholesterol were combined in a molar ratio of 47.3:2.3:42.9:7.5, respectively in two separate 5-ml round bottom flasks. Each flask contained a total volume of 790 microliters. The chloroform was evaporated under a stream of argon at room temperature. When all solvent was evaporated, 1 ml of 10⁻⁶M fluorescein in 2.5 mM sodium tetraborate, pH 9.3, for fluorescein-containing liposomes, and 1 ml of 2.5 mM sodium tetraborate, pH 9.3, for blank liposomes was added to each respective flask. The suspension was vortexed until all lipid components were in suspension and then placed at 4° C. for 2 hours to swell. The liposomes were then washed by spinning at 13,800×g for 5 minutes, followed by removal of the supernatant and addition of an equal volume of de-ionized water. This wash step was repeated four times. Due to the susceptibility of liposomes to photobleaching, they were stored in the dark at 4° C. prior to capillary electrophoresis analysis. This procedure resulted in the production of liposomes of undefined lamellarity. Liposome preparations were monitored by direct observation using an inverted fluorescence microscope (Eclipse 300, Nikon). Liposomes that contained 10⁻⁶ M fluorescein in 2.5 mM sodium tetraborate were visualized with a FITC cube and a 60×, N.A. 1.3, oil immersion objective. Liposome fluorescence intensity decreases rapidly as fluorescein photobleaches. Liposomes were not detectable after 30 seconds of illumination with the excitation source.

Capillary Electrophoresis and post-column laser induced-fluorescence. An electrophoresis system with a post-column laser induced fluorescence detector that uses a sheath flow cuvette as described, for example, in Lee et al., Anal. Chem., 70:546-548 (1998), was modified for detection of micrometer and nanometer size particles. The 488-nm line from an Argon-ion (Melles Griot, Irvine, Calif.) was used for excitation of fluorescein-containing liposomes or fluorescently-labeled beads migrating out from the capillary. Fluorescein emission was spectrally selected with an interference filter transmitting in the range 522-552 nanometers (nm) (535DF35, Omega Optical, Brattleboro, Vt.). An additional rejection band filter (488-53D, OD4, Omega Optical) was placed in front of the interference filter to further eliminate scattering at 488-nm caused by interactions of the liposome membrane or bubbles with the laser beam. The output of the photomultiplier tube (R1477 Hamamatsu, Japan) was passed through a low-pass analog filter (RC=0.01−s), which is compatible with the detection of single events.

For capillary electrophoresis a fused-silica, 150 μm O.D., 50 μm I.D., coated capillary was prepared. The capillary was coated with poly-acryloylaminopropanol (poly-AAP) to eliminate electroosmotic flow and to decrease the adsorption of liposomes to the capillary walls. The detector was aligned by continuous electrokinetic injection of 10⁻⁹ M fluorescein in BS buffer at −200 volts per centimeter (V·cm⁻¹) into the capillary.

Detector alignment was further confirmed by continuously electrokinetically injecting fluorescein-labeled, 6-μm diameter, latex beads (Molecular Probes) suspended in BS buffer. The reproducibility of the detector was determined by measuring the variation in fluorescence intensity in single event detection. Others have used similar approaches to characterize detector performance as described, for example, in Schrum et al., Anal. Chem., 71:4173-4177 (1999).

Unless otherwise indicated, liposome dilutions in de-ionized water were injected electrokinetically at −50V·cm⁻¹ for 5 seconds. Separations were performed in the sucrose-HEPES buffer at −200 V·cm⁻¹. Data acquisition was at 50 cycles per second (Hz).

Data analysis. Data were collected as binary files and further analyzed using Igor Pro software (Wavemetrics, Lake Oswego, OR). Migration time and Peak height for each detected event were determined and tabulated using the Igor Procedure PickPeaks. A copy of this procedure is listed in Supplementary Material for Duffy et al., Anal. Chem., 73:1855-1861 (2001). From the data tabulated by PickPeaks, the electrophoretic mobility, entrapped volume, and apparent radius were calculated for each detected liposome.

Results and Discussion

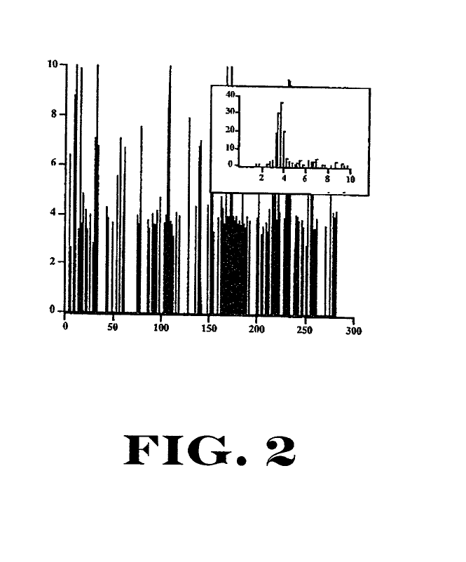

Detector characterization. Fluorescently-labeled latex beads were detected by the post-column laser-induced fluorescence detector when −200 V·cm⁻¹ was applied continuously to a poly-AAP coated capillary with its injection end immersed in a bead suspension containing 850 beads per microliter (beads·μl⁻¹) (FIG. 2). Since the core bead material was not electrically charged, it was not expected that beads would electromigrate in the presence of an electric field. However, these beads have an electrophoretic mobility of −2.75×10⁻⁵ cm²·V⁻¹s⁻¹. This mobility likely results from negatively charged fluorescein that is embedded in the bead material.

An auxiliary microscope (100× magnification) confirmed that most of the detected events correspond to single beads. However, also present were bead aggregates containing two and three beads. In FIG. 2, 169 events were detected under continuous bead electromigration for 285 seconds. Similar results are shown for flow cytometry in a microchip as described, for example, in Schrum et al., Anal. Chem., 71:4173-4177 (1999). Signals within 2.25 and 5.0 volts (V) correspond to single beads as seen in the histogram in the insert of FIG. 2. They have a fluorescent signal of 3.77±0.39 V (n=123). Signals smaller than 2.25 V likely correspond to fragmented beads or residual scattering caused by air bubbles. Fortunately, these events accounted for only 4% of the total number of detected events. Bead aggregates were identified as doublet and triplets under the auxiliary microscope and resulted in signals greater than 5.0 V. These aggregates constituted 24% of the total number of detected events. A larger fraction of aggregates was formed when the electric field used for electromigration was increased beyond −200 V/cm. Aggregation may result from electric field-induced bead polarization which would favor electrostatic attraction between beads with opposite polarity as described, for example, in Zimmerman et al., Electromanipulation of Cells, CRC Press (Boca Raton, Fla., 1996).

Based on the events corresponding to single-bead detection, the florescent signal has a relative standard deviation of 10%. This variation is identical to the reported variation determined by flow cytometry by the manufacturer (Molecular Probes). Therefore, it is clear that the post-column laser-induced fluorescence detector has similar response variation to a flow cytometer while detecting 6-μm diameter beads. Main differences between these two techniques are that (i) in electrophoresis bead migration is caused by the electrical properties of the bead surface while in flow cytometry they move due to hydrodynamic pressure; (ii) a laser-induced fluorescence detector has about ten times higher sensitivity than a typical flow cytometer. See, for example, Lee et al., Anal. Chem., 70:546-548 (1998); and Pasquali et al., J. Chromatogr., B722:89-102 (1999).

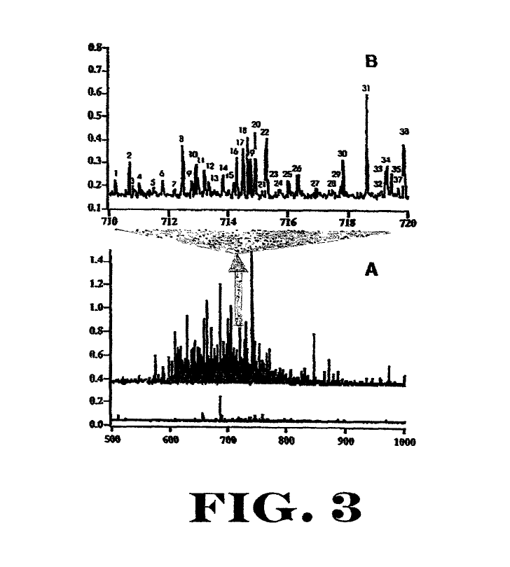

Detection of individual liposomes. As shown in FIG. 2 for the fluorescent beads, post-column laser induced fluorescence is an appropriate system for detection of single events. The use of this detector for the analysis of liposomes containing 10⁻⁶ M fluorescein is illustrated in FIG. 3. The upper trace of part A of this figure shows the electropherogram (offset on the y-axis for clarity) resulting from injecting electrokinetically a five-fold dilution of a liposome suspension that was prepared as described herein. The lower trace of part A shows a 100-fold dilution for liposomes not containing fluorescein (blank). Similar to the bead experiments, each electropherogram consists of spikes as illustrated by the expansion of the electropherogram of the 5-fold liposome dilution (FIG. 3B). This region shows 38 detected events that have a signal larger than five times the standard deviation of the background. Had these events corresponded to free-fluorescein in solution released from disrupted liposomes, (i) dilution would have impeded its detection, and (ii) they would have been wider (i.e., up to 1.1 seconds (s)) given the diffusion coefficient for this dye (3.3×10⁻⁶ cm²·s) (Chiem et al., Clin. Chem., 44:591-598 (1998). Therefore, these 80-millisecond (ms) wide events have to be to the result of individual liposomes from the original liposome preparation or to new liposomes formed by liposome fusion or fission during the electrokinetic injection or electromigration. See, for example, Zimmerman et al., Electromanipulation of Cells, CRC Press (Boca Raton, Fla., 1996); and Perkins, “Applications of Liposomes with High Captured Volume,” in Liposomes: Rational Design, A. S. Janoff, Ed., pp. 219-259 (Marcel Dekker, Inc., New York, N.Y., 1999). Regardless of their origin, every individually detected fluorescent event can be considered to be an individual liposome (FIG. 3B).

Similarly to FIG. 3B, Table 1 shows a total of 2004, 617, 55, and 38 liposomes for the 5, 20, 100, and a blank of the 100-fold dilution, respectively. A duplicate of the 100-fold dilution that showed 58 events, a variation in liposome number that is predicted by a Poisson Distribution (i.e., N±√N). As expected from injecting a sample in water into a capillary filled with a buffer with a higher ionic strength than sample, the number of liposomes injected was increased by stacking (e.g., Landers et al., Handbook of Capillary Electrophoresis, CRC Press (Boca Raton, Fla., 1997)). Despite this fact, calculating the apparent injected volume for the 100-fold dilutions gave an estimate that the original suspension contained 4×10⁹ liposomes·ml⁻¹. Estimating the number of liposomes in a suspension may be of importance in the formulation of drug treatments or other products that are based on liposome suspensions.

TABLE 1
Statistics for Liposome Properties

| | Liposome Suspension Dilution | | | |
|---|---|---|---|---|
| | | | | Blank^{c}, |
| Property^{a} | 5-fold | 20-fold | 100-fold^{b} | 100-fold |
| Total Number^{d} | 2004 | 617 | 55 | 38 |
| Migration Time, | | | | |
| (seconds) | | | | |
| Average | 731 | 726 | 704^{b} | 737 |
| Std. Dev. | 64 | 51 | 57 | 67 |
| Range | 548-1083 | 598-954 | 515-965 | 511-970 |
| μ^{e}, (cm² · V⁻¹ · s⁻¹) | | | | |
| Average ( × 10⁴) | 2.8 | 2.8 | 3.1^{b} | |
| Std. Dev. ( × 10⁴) | 0.3 | 0.2 | 0.3 | |
| Range ( × 10⁴) | 1.8-3.7 | 2.1-3.3 | 2.1-3.8 | |
| Volume^{f} (fl) | | | | |
| Average | 1.4 | 1.3 | 1.3^{b} | |
| Range | 0.3-10. | 0.3-13 | 0.4-6.4 | |
| Radius^{e}, (μm) | | | | |
| Average | 0.52 | 0.55 | 0.57^{b} | |
| Std. Dev. | 0.20 | 0.18 | 0.16 | |
| Range | 0.37-1.40 | 0.39-1.32 | 0.39-1.8 | |

^{a}Statistics include average, standard deviation (Std. Dev.), and the range of all points that were detected with the Procedure PickPeaks.
^{b}Average of two duplicates.
^{c}Liposomes in the blank preparation did not contain fluorescein.
^{d}Events with a signal larger than 5 times the standard deviation of the background.
^{e}Electrophoretic mobility, μ was calculated using Equation 4.
^{f}The entrapped volume was calculated using Equation 1. Std. Dev. was not calculated for this skewed distribution.
^{g}The apparent radius was calculated using Equation 3.

The data (Table 1) and the electropherogram (FIG. 3A, bottom trace) of liposomes not containing fluorescein indicate that the rejection band filter cannot completely eliminate scattering caused by liposomes that do not contain fluorescein. Therefore, scattering must be contributing to the total detected signal. Sorting the detected events in order of decreasing intensity for both the 100-fold dilution and its blank facilitates the comparison between the total signal (fluorescence plus scattering) and scattering signal. For example, signal comparison between the events at the maximum intensity of the fluorescein-containing and blank liposomes suggest that the fluorescent signal is 80% of the total signal. Considering the sorted events at 97, 94, 91, 84, and 77% of the maximum intensity, the ratio of fluorescent signal over total signal is 0.74±0.04 (average±standard deviation). Improved elimination of scattering might be accomplished by using a rejection band-pass filter with a higher optical density (i.e., O.D. 6).

Entrapped volume distributions. The peak height corrected for scattering for each individual liposome is a measure of its fluorescein content. Therefore, regardless of their lamellarity, the corrected fluorescence intensity S is related to the fluorescein volume V entrapped in each liposome by the equation:

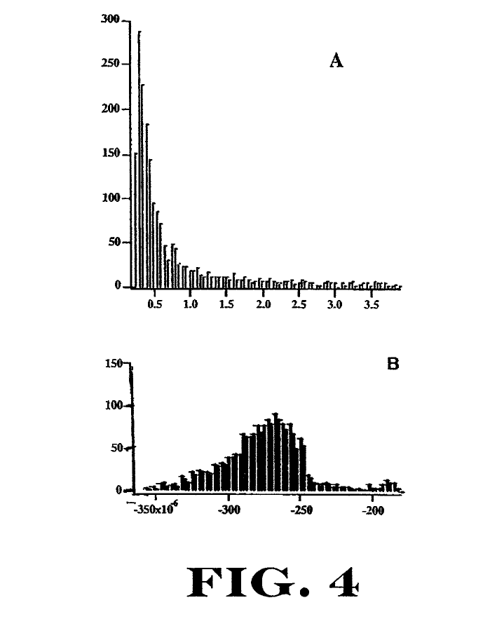

V=S/TC (1)

Where T is the detector sensitivity (i.e., 5.1×10¹⁹ V·mole⁻¹ for fluorescein in 2.5 mM sodium tetraborate, pH 9.3) and C is the concentration of fluorescein inside the liposome (i.e., 10⁻⁶ M). As seen in FIG. 3, signal intensity and migration time do not show a clear correlation, making it difficult to interpret the data when plotting entrapped liposome volume versus migration time. An alternate representation of these results is FIG. 4A that shows a histogram distribution of individual determinations of liposome volume. This representation provides a clear characterization of a liposome preparation.

The radius of spherical liposomes could be calculated directly from the entrapped volume (Equation 1) when they are unilamellar. However, when liposomes are multilamellar the entrapped volume is lower than the total liposome volume. Therefore the estimated radius of a unilamellar liposome is smaller than the actual radius of a multilamellar liposome. If this bias is insignificant, an apparent liposome radius R based on the entrapped volume is given by the equation:

$$R = \sqrt[3]{\frac{3 V}{4 π}} \qquad ( 2 )$$

Combining Equation 2 and Equation 1, the apparent radius of each liposome is determined as

R=3\sqrt{3.5×10⁻¹⁸S} (3)

The numerical factor accounts for the change in dimensions from liters to cubic meters. Table 1 shows the radius distribution for liposomes in the various liposome dilutions. It can be seen that liposome radii vary from 370 nm to 1.8 μm. These dimensions are in agreement with the size expected from the preparation procedure described herein. Since the size and the entrapped volume of a liposome are important in its effectiveness as a delivery agent or in other preparations, the use of distributions of single liposome measurements provides a powerful resource to monitor the quality of a liposomal preparation.

Electrophoretic Mobility of Individual Liposomes. A comparison with previous capillary electrophoresis analysis of liposomal preparations (e.g., Radko et al., J. Chromatogr., B722:1-10 (1999); Janzen et al., Biophys. J., 70:313-320 (1996); Roberts et al., Anal. Chem., 68:3434-3440 (1996); Tsukagoshi et al., J. Chromatogr., 813:402-407 (1998); Tsukagoshi et al., Anal. Sci., 12:869-874 (1996); and Radko et al., Anal. Chem., 72:5955-5960 (2000)), and the results reported here (FIG. 3 and the data in Table 1) indicate similar widths in liposome migration time zones. While previous reports determined only an average migration time, the present results include individual liposome determinations from where statistical parameters could be directly calculated.

Table 1 shows that using poly-AAP coated capillaries, reproducible migration time distributions were obtained for different dilutions of the liposomal preparation that could not be obtained with uncoated capillaries (data not shown). The hydrophilic coating is likely to reduce the electrostatic or hydrophobic interactions as described, for example, in Radko et al., J. Chromatogr., B722: 1-10 (1999). Therefore only coated capillaries were used to obtain the results reported here. From the data in Table 1 the overall average migration time was 717 seconds and the corresponding relative standard deviation varied from 7 to 9%.

For each individual liposome, the electrophoretic mobility μ can be calculated from the measured migration time t_{M} as:

μ=−0.2/t_{M} (4)

The constant in this equation takes into account the use of a 40.0-cm long capillary, at −200 V/cm. Using individual liposome measurements, the overall electrophoretic mobility is −2.9×10⁻⁴ cm²·V ⁻¹·s⁻¹ and the standard deviation for several dilutions of the liposomal preparations are close to 0.3×10⁻⁴ cm²·V⁻¹·s⁻¹. As described for the entrapped volume, a histogram distribution of electrophoretic mobilities of individual liposomes (FIG. 4B) provides a more comprehensive description than the average value of a liposomal preparation.

Although using uncoated capillaries would have been preferred for individual liposome analysis, use of these capillaries and any of the running buffers described herein resulted in a lengthy migration time window (up to 3 hours; data not shown). This migration time is longer than 33 minutes, the predicted time for the liposome with highest negative mobility in a coated capillary (−2.9×10⁻⁴ cm²·V⁻¹·s⁻¹; Table 1) opposing the electroosmotic flow (5×10⁻⁴ cm²·V⁻¹·s⁻¹). Therefore, the long migration times observed when using the uncoated capillary are likely the result from electrostatic and hydrophobic interactions between the capillary wall and the liposome membrane phospholipids as described, for example, in Radko et al., J. Chromatogr., B722:1-10 (1999).

Electrophoretic Mobility Distributions. As shown in FIG. 4B and Table 1, individual liposomes exhibit mobilities from −1.8×10⁻⁴ to −3.8×10⁴ cm²·V⁻¹·s⁻¹. These variations in mobility may be caused by the conditions used in the capillary electrophoretic separation or by the inherent diversity found in the liposomal preparation. Analysis-linked variations in the mobility of individual liposomes may be caused by the length of the injection plug, detector broadening, interactions with the capillary walls, interactions among liposomes, ionic strength, and longitudinal diffusion. In addition, mobility variations may result from inherent diversity in liposome size, membrane composition, and zeta (ζ) potential found in the liposomal preparations. The various potential contributors to mobility distributions are discussed below.

The length of the injected plug of liposome suspension is 0.7 mm long as estimated from the injection and separation parameters used in the electrokinetic injection of the liposome suspension. Considering an average electrophoretic velocity of 0.6 mm/second and not considering diffusion, the injected plug of liposome suspension will take 1 second to travel through the detector volume. Furthermore, the traveling time (i.e., 80 milliseconds) through the detector for each individual liposome (FIG. 3B) indicates that both the initial plug length and the detector are unlikely to contribute significantly to variation in migration time and thus to the observed dispersion in electrophoretic mobility.

Although reproducible migration time distributions were obtained by using a poly-AAP coated capillary, residual interactions between the capillary walls and liposomes cannot be directly ruled out. On the other hand, Radko et al., Anal. Chem., 72:5955-5960 (2000), report that the polyacrylamide coated capillaries facilitate a direct comparison between experimental measurement and theoretical predictions of average electrophoretic mobilities of liposomal preparations pointing to an absence of capillary wall liposome interactions. Given the similarity in width of the migration time zone between that work and the work reported here, we have assumed that coated capillaries show insignificant interactions between the modified capillary surface and the liposome surface and are not a major cause of the variations in the electrophoretic mobility of individual liposomes. At high liposome number/ml interactions among liposomes could also induce liposome modifications and thus changes in mobility as described, for example, in Jones et al., Colloid Interface Sci., 54:93-128 (1995). Table 1 shows that the migration time distribution did not change with dilution.

Ionic strength variations among running buffers contribute to variations to the zeta (ζ) potential in individual liposomes and thus to variations in electrophoretic mobility (Radko et al., Anal. Chem., 72:5955-5960 (2000)). However, this factor cannot contribute to the observed variation in electrophoretic mobility (FIG. 4B and Table 1) because the buffer composition does not change significantly during a given electrophoretic separation.

Longitudinal diffusion, the natural limiting factor to broadening in the capillary electrophoresis analysis of small analytes (i.e., 100-10,000 atomic mass units (a.m.u.)), cannot be an important factor due to the relatively large size of the liposomes being detected. Having considered that analysis-linked factors are not important contributors to the dispersion observed in individual electrophoretic mobility of liposomes, it is safe to attribute that the observed dispersion is linked to variations in properties of individual liposomes such as size, membrane composition, and zeta (ζ) potential. (Jones et al., Colloid Interface Sci., 54:93-128 (1995)). Models and experimental determinations confirm that the electrophoretic mobility of individual liposomes is predicted to be dependent on κR and the zeta (ζ) potential of the liposome, κ is the Debye parameter and R is the liposome radius (Schnabel et al., Langmuir, 15:1893-1895 (1999)). Furthermore, zeta (ζ) potential is dependent on the surface charge density, the ionic strength of the surrounding medium, and κR when κR≦10. Since κ⁻¹=4.3 nm, as calculated from the buffer ionic strength (κ(nm⁻¹)=3.288·√I, where I is the ionic strength in mM), and using the apparent liposome radius (Table 1), the product κR ranges from 86 to 420. Therefore, zeta (ζ) potential dependence on κR is not significant and variation in zeta (κ) could result only from variation in surface charge density, (i.e., variation in membrane phospholipid composition).

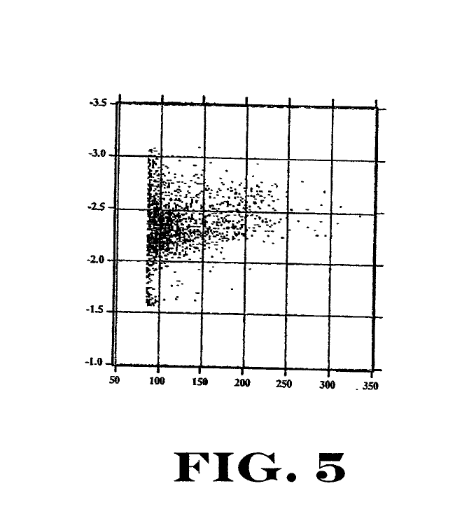

Unlike proteins that have electrophoretic mobilities predicted from the balance of electrical and frictional forces and that fall within the Hückel limit (i.e., κR<<1), predictions of liposome electrophoretic mobilities need to take into account the distortion of the ionic atmosphere surrounding the liposome resulting from the presence of an electric field (relaxation effect) (e.g., Wiersema et al., J. Colloid Interface Sci., 22:78-99 (1966); Jones et al., Colloid Interface Sci., 54:93-128 (1995)), the deformation of the liposome during migration (e.g., Kawakami, Langmuir, 15:1893-1895 (1999)), and electroosmotic drag on the surface of the liposome (e.g., Wiersema et al., J. Colloid Interface Sci., 22:78-99 (1966)). Since the relaxation effect has been found to be highly relevant, this effect will be taken into consideration in the discussion that follows. Depending on the range of zeta (ζ) and κR values, the variations in electrophoretic mobility may result from variations in zeta (ζ), κR, or both. For example, under the experimental conditions used by Radko et al. variations in electrophoretic mobility are linked to variations in κR, thus allowing them to estimate variations in liposome size. In this work, in order to determine the cause of variations in the electrophoretic mobility of liposomes, a plot of reduced electrophoretic mobility μ_{R} versus κR for each individual liposome (FIG. 5) facilitates a comparison with theoretical predictions previously reported (Radko et al., Anal. Chem., 72:5955-5960 (2000); Wiersema et al., J. Colloid Interface Sci., 22:78-99 (1966)). In this plot, the properties of each individual liposome is represented by the coordinates (μ_{R}, κR), R is the apparent radius calculated in equation 4 and μ_{R} is calculated as

μ_{R}=μ/(2εkT/3ηe) (5)

where μ is the calculated electrophoretic mobility (Equation 4), ε is the dielectric permittivity, η is the viscosity of the medium, k is the Boltzmann constant, T is the absolute temperature, and e is the electron charge. A comparison of FIG. 5 with FIG. 1 in Radko et al., Anal. Chem., 72:5955-5960 (2000), and FIG. 2 in Wiersema et al., J. Colloid Interface Sci., 22:78-99 (1966), show that the range for the coordinates (μ_{R}, κR) in FIG. 5 fall in regions of FIG. 1 (Radko et al., Anal. Chem., 72:5955-5960 (2000)) and FIG. 2 (Wiersema et al., J. Colloid Interface Sci., 22:78-99 (1966)) where mobility and zeta (ζ) potential are basically independent of κR. Therefore, in this work the variation in electrophoretic mobility of individual liposomes indicates variations in surface charge density that imply variations in membrane composition. Although measurements of the heterogeneity in liposome membrane composition has been previously done, there are reports that liposome material can precipitate out, resulting in liposomes with a heterogeneous membrane composition (e.g., Roberts et al., Anal. Chem., 68:3434-3440 (1996)).

Electric-field induced liposome fusion or fission may also result in redistribution of lipids among liposomes and cause variations in electrophoretic mobility and entrapped volume (e.g., Zimmerman et al., Electromanipulation of Cells, CRC Press (Boca Raton, Fla., 1996); Perkins, “Applications of Liposomes with High Captured Volume,” in Liposomes: Rational Design, A. S. Janoff, Ed., pp. 219-259 (Marcel Dekker, Inc., New York, N.Y., 1999)). Similar plots to FIG. 5 for other liposome dilutions (i.e., 20-fold, and 100-fold) suggest the 5-fold dilution (FIG. 5) has an additional cluster at (90, −1.6) that could be intra-liposome interactions. However, this cluster contains a low fraction of the total number of events being detected.

Conclusions

The analysis of individual liposomes by capillary electrophoresis with post-column laser-induced fluorescence detection provides a two-dimensional description of a liposome preparation (i.e., entrapped volume and membrane composition) that could not be determined previously with the average values of independent measurements (e.g., Roberts et al., Anal. Chem., 68:3434-3440 (1996)). These results suggests that a homogeneous mixture of phospholipids does not necessary generate liposomes of homogeneous composition. A combination of theoretical predictions, distributions of coordinates (μ_{R}, κR) determined from individual liposome measurements, and an adequate selection of separation buffer conditions, could also be used to estimate size variations as a function of electrophoretic mobility, and lead to the characterization of lamellarity in liposomes because size and entrapped volume could be determined simultaneously. The reported analysis and its variants support a rugged method to monitor quality of liposome preparations where stability, bio-compatibility, and ability to deliver drugs depends on the liposome size and phospholipid composition. Other phenomena such as liposome-liposome interaction, liposome rigidity, composition-dependent stability, and leakage could be studied with the described analyses.

### Example 2

### Capillary Electrophoretic Analysis of Mitochondria

Abbreviations. The following abbreviations are used in the present application: poly-acryloylaminopropanol (AAP); capillary electrophoresis (CE); dichloroindophenol (DCIP); dimethyl sulfoxide (DMSO); (N-[2-hydroxyethyl]piperazine-N-[ethanesulphonic-y-acid] (HEPES); laser-induced fluorescence (LIF); metrizamide (Mz); percoll (Pc); and phosphate buffered saline (PBS).

Materials and Methods

Materials. Bovine serum albumin, dichloroindophenol (DCIP), D-mannitol, (N-[2-hydroxyethyl]piperazine-N-[ethanesulphonic acid]) (HEPES), a Lowry Assay kit, metrizamide (Mz), percoll (Pc), phosphate buffered saline solution (PBS), sodium deoxycholate, disodium succinate, and tryptan blue were purchased from Sigma. Dimethyl sulfoxide (DMSO), magnesium chloride, sucrose, and trichloroacetic acid were purchased from Fisher. Fluorescein, 6-μm fluorescent beads, and a stain available under the trade designation MitoTracker Green were acquired from Molecular Probes. Chinese Hamster Ovary cells (CHO cells, used for bulk analysis) and MAK mouse hybridoma cells (used for capillary electrophoresis-laser induced fluorescence (CE-LIF) analysis) were a kind gift from Dr. Wei-Shou Hou (Department of Chemical Engineering, University of Minnesota, Minneapolis).

Viability tests. Cell density (cells/ml) and viability were routinely monitored using a hemocytometer (Fisher) and staining with tryptan blue. For most experiments cell counts ranged from 0.1 to 5 million cells/ml.

Isolation of Mitochondria. All cell suspensions were kept on ice during and after homogenization. The cells were washed three times with PBS, 0.30 M D-mannitol, and 5.0 mM magnesium chloride, pH 7.03 (Buffer A) and resuspended in the same buffer prior to disruption with a Potter-Elvehjelm homogenizer. Periodic microscope observations were made to ensure the disruption of cells. Following homogenization, the whole cells and nuclei were pelleted by centrifugation at 1300×g for five minutes (Eppendorf 5415-C), and the post nuclear supernatant was saved for density gradient centrifugation.

Percoll/Metrizamide Gradient. A discontinuous density gradient was prepared as described by Madden et al., Anal. Biochem., 163:350-357 (1987). The resulting densities for the different solutions were: 1.1304 g/mL metrizamide (35% Mz), 1.1029 g/mL metrizamide (17% Mz), and 1.0331 g/mL percoll (6% Pc). Differences in densities allow for these solutions to be seeded on top of each other inside a centrifuge tube. The post nuclear supernatant (2.4 ml), containing mitochondria and other organelles, was seeded on top of this gradient. The layers and interfaces from bottom to top are: 35% Mz layer, the 35% and 17% Mz interface (35%/17% Mz), the 17% Mz layer, the 17% Mz and 6% Pc interface (6% Pc/17% Mz), the 6% Pc layer, the supernatant and 6% Pc interface (Top/6% Pc), and the supernatant. This tube was then centrifuged for fifteen minutes at 48,000×g at 4° C. (J2-20, Beckman). These conditions are sufficient to allow for organelles within the post nuclear supernatant to move downwards until their density matches the density of the gradient medium. To ensure that all mitochondria were collected, 500 microliters (μl) were collected from each interface using a flat tipped needle. Each interface solution could then be subjected to characterization using the assays described below.

Lowry Assay. This assay was performed on each of the gradient interfaces according to instructions in the assay kit. This colorimetric assay monitors the absorbance at 750 nanometers (nm) resulting from the formation of a protein complex. Bovine serum albumin was used as the protein standard. Controls that did not contain protein were treated in an identical manner to the standards. Initial experiments showed that metrizamide interferes with the Lowry assay. The assay procedure therefore was modified to prevent interference from metrizamide and to be capable of analyzing the same fractions that were analyzed by the succinate dehydrogenase assay described below (e.g., Bregman in Laboratory Investigations in Cell and Molecular Biology, pp. 131-136 and 302-303 (Wiley, New York, N.Y. (1990)). To measure the protein concentration of a solution, the proteins were precipitated using 100 μl of a 1.5-mg/ml sodium deoxycholate solution and 100 μl of trichloroacetic acid solution (72% w/v). After protein precipitation the solutions were centrifuged at 8160×g for 8 minutes (Eppendorf 5415-C). The supernatant containing the interfering agents were then pipetted off the pelleted proteins. Upon resuspension of the proteins in water, the Lowry assay was carried out as described in the instructions.

Succinate Dehydrogenase Assay. This assay was performed on each of the percoll/metrizamide gradient interfaces. Each assay reaction contained the following solutions: 650 μL of Buffer A, 125 μL of 0.04 M sodium azide, 125 μL of 0.50 mM DCIP, 125 μL of 0.2 M succinate, and 400 μL of a gradient interface. The gradient interface was added last to initiate the reaction. These solutions were allowed to incubate at room temperature and the discoloration caused by reduction of DCIP was monitored over a 40-minute period at 600 nm in a UV-Vis spectrophotometer. Three controls were used. The first one was used to zero the spectrophotometer contained no DCIP solution. A second one replaced the mitochondrial fraction with BSA protein. The third control contained extra buffer to replace the volume of the mitochondrial fraction. The gradient fractions containing mitochondria will react with the DCIP present in solution and decrease the solution's color intensity.

Capillary Electrophoresis With Laser-Induced Fluorescence Detection. A 190 μL aliquot of each interface was mixed with 10 μL of a stain available under the trade designation MitoTracker Green (20 μM solution in DMSO) to give a final dye concentration of 1.0 μM. The stained interfaces were incubated at 37° C. for fifteen minutes. After incubation the fractions were placed on ice to prevent mitochondrial degradation. Before injection the contents of each interface were further diluted by adding 200 μL of running buffer that contained 250 mM sucrose, 10 mM HEPES, pH 7.4 (Buffer B). A control for each interface was prepared by seeding a gradient with Buffer A, following the centrifugation protocol, and collecting the corresponding interface as described above.

Analysis of each gradient interface was made using an in-house built CE-LIF instrument. This instrument and its operation has been described previously (e.g., Duffy et al., Anal. Chem., 73: 1855-1861 (2001)). Organelles were introduced continuously by applying −200 V/cm across a 30.3-cm long, 50-μm internal diameter capillary, modified with poly-acryloylaminopropanol (AAP). This capillary surface modification reduces organelle-capillary interactions as described, for example, in Gelfi et al., Electrophoresis, 19:1677-1682 (1998). The continuous electrokinetic injection of mitochondria suspended in Buffer B proceeded for 25 minutes. Detection of each individual mitochondrion was identified as an individual 80-millisecond wide spike as shown previously for detection of latex beads and liposomes (Duffy et al., Anal. Chem., 73:1855-1861 (2001)). Detection of these events result from excitation of the fluorophore available under the trade designation MitoTracker Green (absorption range, 465-495 nm) with the 488-nm argon-ion laser line (20 mW). An interference filter (515-555 nm, Omega Optical) that overlaps the fluorophore emission range (495-530 nm) was placed in front of the R1471 (Hamamatsu) photomultiplier tube to selectively detect fluorescence. The photomultiplier tube analog output was digitized using a NiDaq I/O board (National Instruments). The sampling rate was 50 cycles per second. Data analysis was done using routines written in IgoPro (Wavemetrics) as described, for example, in Duffy et al., Anal. Chem., 73:1855-1861 (2001). After the analysis of each interface, the capillary was flushed with Buffer B. This operation ensured that residual components of the interface were eluted and would not contaminate the subsequent injections.

Results

Bulk Analysis Assays. Using a modified Lowry Assay, the concentration of protein in the various interfaces, the supernatant, and the 35% Mz layer was determined (Table 2). The assay modification consisted of precipitating the protein with sodium deoxycholate, eliminating the density gradient components (i.e., percoll and metrizamide), and resuspending the protein in water prior to treatment with the Lowry assay reagents.

TABLE 2
Classical Mitochondrial Assays performed on density fractions.

| | | | Relative | |
|---|---|---|---|---|
| | Density | Total Protein | Succinate | Activity/ |
| | Range | Concentration^{b} | Dehydrogenase | protein |
| Interface^{a} | (g/ml) | (μg/ml) | Activity^{c} (A.U./s) | Ratio^{d} |
| Top | <1.03 | 125 ± 18 | 0 | 0 |
| Top/ | <1.03 | 158 ± 38 | 0.11 ± 0.02 | 0.72 |
| 6% Pc | | | | |
| 6% Pc/ | 1.03-1.10 | 64 ± 2 | 0.222 ± 0.006 | 3.4 |
| 17% Mz | | | | |
| 17% Mz/ | 1.10-1.13 | 22.0 ± 5 | 0.252 ± 0.006 | 11.2 |
| 35% Mz | | | | |
| 35% Mz | 1.13 | 7.9 ± 0.8 | 0.126 ± 0.006 | 15.8 |

^{a}Interfaces were defined by layers of 35% Mz in 0.25 M glucose, (ρ = 1.13 mg/ml), 17% Mz (ρ= 1.10 mg/ml), and 6% percoll (ρ = 1.03 mg/ml) that were deposited in the centrifugation tube in order of decreasing density.
^{b}Protein Concentration was determined using the Lowry Assay using BSA as standard and measuring absorbance at 750 nm. Calibration curve: S = 0.031 C + 0.1142; R² = 0.98; where S is the absorbance reading, C is the concentration in μg/ml. Reported values are average and standard deviation of three measurements.
^{c}Reduction of dichloroindophenol (DCIP) is catalyzed by this enzyme. The reduced species is colorless causing a decrease in the absorption of DCIP at 600 nm. Reported values are given as the slope of this change in absorbance units (A.U.)/s. The error represents the standard deviation from the slope as determined from linear regression.
^{d}Activity/protein ratio is calculated directly from the values described in b and c above.

For this calorimetric assay the absorbance (A) at 750 nm of bovine serum albumin standards showed a linear relationship between zero and 300 μg/ml. The linear regression equation is A=0.031C+0.1142; R²=0.98; where C is given in μg/ml. Using this equation, the total protein concentration was shown to vary from 158 μg/ml in the Top/6% Pc interface to 8 μg/ml in the 35% Mz layer. The supernatant that remained on top also contained 125 μg/ml of total protein, possibly originating from the cytoplasm (Madden et al., Anal. Biochem., 163:350-357 (1987)). The lower concentrations of protein found in the more dense interfaces and the 35% Mz layer may be indicative of the presence more pure organelle fractions, but more specific assays are required to verify purity.

In order to determine the presence of mitochondria in the different fractions, we used an assay based on the activity of succinate dehydrogenase (e.g., Bregman in Laboratory Investigations in Cell and Molecular Biology, pp. 131-136 and 302-303 (Wiley, New York, N.Y. (1990)). Bound to the inner mitochondrial membrane, this enzyme aids in the production of ATP by catalyzing the oxidation of succinate to fumarate using oxygen as the electron acceptor. In the succinate dehydrogenase assay DCIP replaces the required oxygen. As DCIP accepts an electron pair the solution changes from a blue color to a clear solution. This change was measured spectrophotometrically at 600 nm. Changes in absorbance with time (slope of a linear curve) represent the relative enzymatic activity. Controls showed a slight color change over time. To obtain a corrected enzymatic activity, the slope of the control was subtracted from the corresponding fractions collected from the gradient.

The results for the various interfaces, the top layer, and the 35% Mz layer are shown in Table 2. As expected from the literature, mitochondrial activity is higher in the 6% Pc/17% Mz and 17%/35% Mz interfaces (e.g., Madden et al., Anal. Biochem., 163:350-357 (1987)). In our findings, the enzymatic activity was lower in the 6% Pc/17% Mz interface than in the 17%/35% Mz interface, 0.222 A.U./s versus 0.252 A.U./s. Variations in activity depend strongly on the cell culture, the homogenization procedure, and the potential denaturation of the enzymatic marker during handling. As expected, there was some activity in the Top/6% Pc interface (0.11 A.U./s), in the 35% metrizamide layer (0.126 A.U./s) and none in the supernatant.

The succinate dehydrogenase assay provides more convincing evidence than the Lowry assay about the presence of mitochondria in a given fraction. However, alone it cannot provide an indication of purity. If multiple enzymatic assays that check for the presence of other organdies are not available, taking the ratio of enzymatic activity to protein concentration, gives a good indication of purity. Table 2 shows that this ratio increases from the top to the bottom layer and that the 35% Mz layer contains the most pure mitochondria. In summary, these two assays combined suggest the presence and purity of mitochondria in a given fraction and validate the use of discontinuous gradient centrifugation to isolate mitochondria from cultured cells.

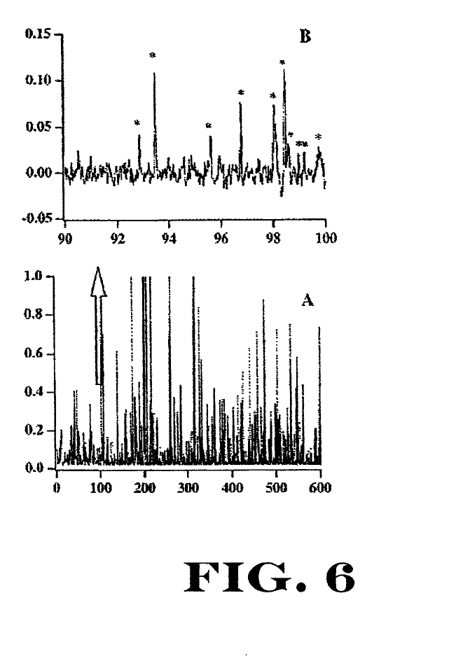

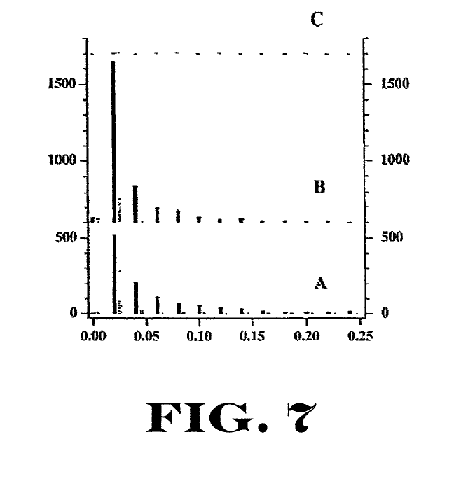

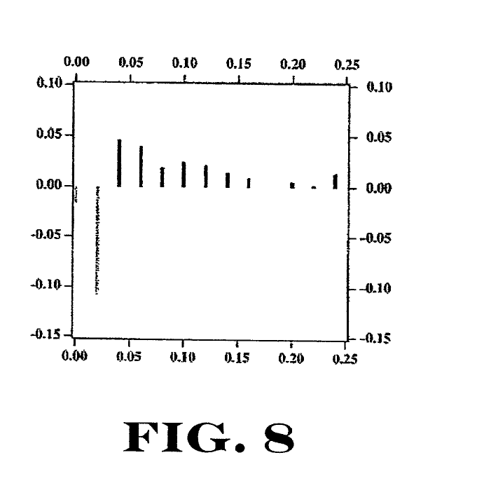

Capillary Electrophoresis with Laser-Induced Fluorescence Detection. The continuous introduction of mitochondria by using −200 V/cm allows for their individual detection while they migrate out from an AAP-coated capillary. Based on the average electrophoretic mobility for mitochondria, −1.5×10⁻⁴ cm²/V·s, a value that was previously measured (Duffy et al., Anal. Chem., 74:171-176 (2002)), the predicted migration time for a mitochondria is 873 seconds. Therefore, electromigration was allowed to proceed for at least 1000 seconds prior to data collection to ensure that detected mitochondria were representative of the sample. FIG. 6A shows the 600-second time window during which data were collected from a mitochondrial sample taken from the 6% Pc/17% Mz interface, labeled with a stain available under the trade designation MitoTracker Green, and diluted in an equal volume of Buffer B. In order to appreciate the detection of individual mitochondrion, FIG. 6B shows an expansion of a 10-second time window. Each peak marked with an asterisk represents a single mitochondrion with a fluorescent signal greater than five times the standard deviation of the background (i.e., 5×0.0039). Smaller mitochondria (or mitochondrial fragments) that may contain fewer molecules labeled with a stain available under the trade designation MitoTracker Green may be excluded using this threshold. However, this threshold was preferred because lower thresholds (i.e., three times the standard deviation of the background), introduced a significant number of false positives as determined from the corresponding blank. Using this detection and peak assignment scheme, data collected in a 600-second time window were used to calculate values reported in Table 3 and FIGS. 7 and 8.

TABLE 3
Mitochondrial Properties determined by CE-LIF

| | Detected | | | |
|---|---|---|---|---|
| | number | Detected | Millions | Total |
| | of mito- | number of | of mito- | Mitochondrial |
| | chondria^{b} | events in blank^{c} | chon- | Protein^{e} |
| Interface^{a} | (counts) | (counts) | dria/ml^{d} | (relative units) |
| Top | 5 | 6 | — | — |
| Top/6% Pc | 14 | 6 | 0.023 | 0.00 |
| 6% Pc/17% | 1697 | 219 | 4.0 | 2.25 |
| Mz | | | | |
| 17% Mz/35% | 1223 | 155 | 3.0 | 3.6 |
| Mz | | | | |
| 35% Mz | 613 | 397 | 0.61 | — |

^{a}Interfaces have been defined in Table 2.
^{b}Only events with signals larger than 5 × standard deviation of the background were included. Samples from the various interfaces were stained with a stain available under the trade designation MitoTracker Green prior to capillary electrophoresis analysis as described in Materials and Methods.
^{c}Same as described in b except for the fact that buffer A was used instead of supernatant.
^{d}This value is estimated from the number of mitochondria inside the 0.51 - μl capillary volume at a given time. This number was calculated as (b − c) × (873/600)/0.51 × 2; where b and c are the counts mentioned in b and c, 873 is the estimated traveling time in the capillary (Duffy et al., Anal. Chem., 74:171-176 (2002)), 600 is the time window used for data acquisition, and 2 is the dilution factor prior to the analysis.
^{e}The reported value is the sum of all the peak heights for all detected events (see b) minus the sum of the peak heights for all detected events in the blank (see c).
^{f}This value was not determined because the blank seems to be the major contributor to the number of detected events (i.e., 63%).

It is clear that the 6% Pc/17% Mz and the 17% Mz/35% Mz fractions have relatively high numbers of events when compared to the other fractions in Table 3. These results are in agreement with the determination of mitochondrial activity using the succinate dehydrogenase assay (see Table 2) and literature reports that have used the same discontinuous density gradient for preparation of mitochondrial fractions (e.g., Madden et al., Anal. Biochem., 163:350-357 (1987)).

Comparison of the number of detected events in interfaces containing mitochondria with their corresponding blank (Table 3) suggests that some events may not be directly related to mitochondrial presence (false positives). It can be seen that the blanks for both the 17%/35% Mz and the 6% Pc/17% Mz interfaces contain 13% of the total number of events of the corresponding interface. The percentage of false positives is particularly high in the blanks of the Top/6% Pc interface, and in the 35% Mz layer, while in the supernatant all detected events seem to be false positives. The presence of false positives is addressed again herein.

The number of detected events in the 600-second time window could also be used to predict the number of mitochondria in the original interface. Considering that the capillary volume is 0.51 μl, the average traveling time for a mitochondrion through the capillary is 873 seconds (Duffy et al., Anal. Chem., 74:171-176 (2002)) and by subtracting the number of false positives in the corresponding blank, gives an estimate of the original mitochondria number per milliliter in the original fraction (Table 3). Furthermore, based on this number for the various interfaces and layers, an estimate of the total mitochondria number in the preparation is 15.7 million mitochondria. As a first approximation, using the initial cell count (0.30 million), and ignoring fragmentation or handling related losses, the average mitochondria number per cell is 52.

The selective accumulation of the stain available under the trade designation MitoTracker Green in mitochondria and its covalent attachment to cysteine residues, makes this labeling scheme very specific towards mitochondrial protein in the inner membrane (e.g., Keij et al., Cytometry, 39:203-210 (2000)). Thus, the peak height for each detected mitochondrion is an index of individual protein abundance. Assuming that a similar fraction of cysteine residues have been labeled in all mitochondria, the peak height could be considered a protein index.

The relative amount of mitochondrial protein can also be determined by adding the protein index of each mitochondrion in an interface, subtracting the corresponding false positives, and comparing the totals among interfaces (Table 3). The selectivity of the stain available under the trade designation MitoTracker Green guarantees that the estimate of the relative abundance of mitochondrial protein is more reliable than a succinate dehydrogenase assay, biased by the activity status of this enzyme, or by the low specificity of the Lowry assay (Table 2).

Data collected by CE-LIF can be further represented by plotting the protein index of individual mitochondria in a histogram distribution. These data are shown for selected density gradient fractions in FIG. 7. From bottom to top, these distributions correspond to the 17%/35% Mz interface (A), the 6% Pc/17% Mz interface (B), and the Top/6% Pc interface (C). Each distribution shows the number of detected events sorted into 0.02 A.U. intervals of protein index per mitochondrion. In addition, a distribution of the blank for each interface (false positives) is shown shifted to the right of the corresponding mitochondrial distribution. The distributions for the Top/6% Pc interface and its blank are difficult to appreciate in this figure due to the low number of events detected in these interfaces (FIG. 7C). On the other hand, the distributions of peak heights in the 17%/35% Mz and the 6% Pc/17% Mz interfaces, are very clear because they contain a large fraction of the total mitochondria.

Also, a comparison between the distributions of protein index per mitochondrion of the two mitochondria-rich fractions points to differences between these fractions. This comparison is based on normalizing each distribution with respect to the total number of events and then finding the difference between each corresponding fluorescence interval. The fraction with a density range 1.03-1.10 g/ml (negative values in FIG. 8) has predominantly mitochondria with low amounts of protein (0.0 to 0.4 A.U.), while the fraction with density range 1.10-1.13 g/ml (positive values) has mitochondria with higher amounts of protein (>0.4 A. U.).

Discussion

Prior to evaluating CE-LIF as a method to analyze mitochondrial fractions, we decided to corroborate that discontinuous gradient centrifugation can be used to prepare fractions containing mitochondria of different densities. As expected from previous reports (e.g., Madden et al., Anal. Biochem., 163:350-357 (1987)), 39% of the succinate dehydrogenase activity was localized in fractions denser than 1.03 g/ml, in the 6% Pc/17% Mz, 17% Mz/35% Mz, and 35% Mz. Also the purity of the ratio of activity to protein in Table 2 suggests that more pure mitochondrial fractions are found in denser fractions. The 35% Mz layer was not expected to contain mitochondrial activity (Madden et al., Anal. Biochem., 163:350-357 (1987)). However, in the present work we adjusted the density of this layer to 1.13 instead of 1.19 g/ml, making it possible for mitochondria with densities higher than 1.13 g/ml to accumulate in this layer.

As described in results, CE-LIF is capable of detecting individual mitochondria labeled with a stain available under the trade designation MitoTracker Green. Counting those events during continuous introduction of these organelles into the capillary led to determining the mitochondria copy number per ml (Table 3) and that, on average, there are 52 mitochondria per cell. This conservative estimate is not taking into account fragmentation or losses during handling. Future work will focus on improving sample preparation methods to make CE-LIF determinations more quantitative.

The number of events detected in the blanks (false positives) were taken into account by making a correction to exclude their percentage contribution to the number of mitochondria in the sample. This correction should not be necessary in the future when the cause of false positives is identified and eliminated. Probably causes of false positives are bubbles, labeling of other particles with a stain available under the trade designation MitoTracker Green, and carry-over. Bubbles are an unlikely source of false positives because the CE-LIF instrument is equipped with a band rejection filter with an optical density capable of decreasing scattering one million fold. Another source of false positives may be the labeling of other particles with a stain available under the trade designation MitoTracker Green other than mitochondrial membranes. However, we have no evidence that the blanks contain reactive groups towards this fluorescent probe. The most likely source of false positives is carry-over. At the end of a run, the capillary is flushed by pressure using a syringe. Despite the use of an AAP-coated capillary, which is expected to reduce adsorption of organelles to the capillary, we have found that a few organelles adhere and elute in subsequent runs. We are presently evaluating better ways of controlling carry-over by testing new capillary coatings and using more effective flushing procedures.

Despite the potential bias caused by false positives, the fractions richest in mitochondria showed the least fraction of false positives (Table 3 and FIG. 7). Thus, various results based on CE-LIF measurements of protein index per mitochondrion are not seriously affected. In addition the CE-LIF method is consistent with the bulk analysis assays (Table 2) in showing that most mitochondrial protein is localized in the 6% Pc/17% Mz, the 17% Mz/35% Mz interfaces, and in the 35% Mz layer.

Distributions of protein index per mitochondrion provide further details about the mitochondrial fractions. The difference in distributions between the 6% Pc/17% Mz and the 17% Mz/35% Mz interfaces suggest that more dense mitochondria have a higher protein content per mitochondrion (Table 2, FIG. 8). In addition, the distributions of protein index per mitochondrion may be used as an indication of the mitochondrial fragmentation. The harsh mechanical disruption method presently used in the preparation of the mitochondrial homogenate may lead to significant fragmentation and increase the abundance of low-protein content events as observed in FIG. 7. These events are particularly more abundant in the less dense interface (density range 1.03-1.10 g/ml; FIG. 7B). In the future, use of more gentle disruption methods (i.e., nitrogen cavitation) may help test this hypothesis.

Conclusions

The analysis of individual mitochondria by CE-LIF is capable of providing a novel description of the status of a mitochondrial preparation. Using this method we determined the number of mitochondria in a fraction and the distributions of protein index per mitochondrion, we estimated the average number of mitochondria per cell, and determined the relative abundance of mitochondrial protein in a fraction. These results are in agreement with bulk assays that are commonly used to characterize mitochondrial presence. The small sample consumption (less than one microliter per analysis) is significantly less than the volume required in a conventional assay.

### Example 3

### Determination of Electrophoretic Mobility Distributions Through the Analysis of Individual Mitochondrial Events

Reagents. Sucrose, dimethyl sulfoxide (DMSO) and sodium tetraborate were purchased from Fisher Scientific (Pittsburgh, Pa.). N-[2-hydroxyethyl]piperazine-N-[ethanesulphonic acid] (HEPES), D-mannitol, ethylenediaminetetraacetic acid (EDTA), metrizamide (Mz) and percoll (Pc) were purchased from Sigma (St. Louis, Mo.). CE buffers contained 10 mM borate, 10 mM sodium dodecyl sulfate (BS buffer), pH 9.3 or 250 mM sucrose, 10 mM HEPES (sucrose-HEPES buffer), pH 7.5 for separation of CHO derived mitochondria and pH 7.39 for separation of NS1 derived mitochondria. The mitochondrial isolation buffer (M buffer) consisted of 210 mM D-mannitol, 70 mM sucrose, 5 mM HEPES and 5 mM EDTA, adjusted to pH 7.35 with potassium hydroxide (Aldrich, Milwaukee, Wis.). All buffers were made with milli-Q deionized water and filtered (0.2 μm) prior to use. Stock solutions of 10³ M fluorescein and 10⁻³ M 10-nonyl acridine orange (NAO) (Molecular Probes, Eugene, Oreg.) were made in ethanol and DMSO respectively. Dilutions of these solutions were prepared immediately prior to use. A 100 mg/ml digitonin (Aldrich) stock solution was prepared in DMSO, and diluted to 10 mg/ml in M buffer before using.

Mitochondria preparation. The mitochondria used in this study were isolated from CHO and NS1 cells grown at 37° C. and 5% CO₂. The CHO cells (a kind donation from Dr. Wei-Shou Hu, Department of Chemical Engineering, University of Minnesota) were cultured in 90% alpha modified minimum essential medium (Eagle), 10% fetal bovine serum. The NS1 cells (a kind donation from Dr. Sally Palm, Department of Laboratory Medicine and Pathology, University of Minnesota) were cultured in 90% Dulbecco's Modified Eagle's Medium, 10% calf serum (all cell culture reagents were from Sigma). Cells were maintained by addition of new media every 2-3 days. Biosafety level I was observed in all preparations.

A differential centrifugation protocol loosely based on procedures from Howell et al., Plasmid, 16:77-80 (1986) and Bogenhagen et al., J. Biol. Chem., 249:7991-7995 (1974) was followed to extract mitochondria from the NS1 cells. Briefly, NS1 cells in the log phase were washed three times with cold M buffer and counted using a Fuchs-Rosenthal hemacytometer (Hausser Scientific, Horsham, Pa.). Cells were diluted in M buffer to 8.6×10⁶ cells/ml. To two 1.5 ml siliconized microcentrifuge tubes, 1 ml aliquots of the cell suspension and 2.5 μl of 10 mg/ml digitonin solution were added. Following a 5 minute incubation on ice, the tubes were placed in an ice cooled cell disruption bomb (Parr Instrument Co., Moline, Ill.) which was charged with N₂ to 650 pounds per square inch (psi) for 20 minutes. As estimated by light microscopy, 90% of the cells were disrupted. The mitochondria in one of the 1 ml aliquots of homogenate were labeled with 10 μM NAO for 5 minutes. Whole cells, nuclei and large cell debris were removed from the stained and unstained samples by centrifugation at 1,400×g for 5 minutes in an Eppendorf 5415D centrifuge, the supernatants were removed and centrifuged again, for a total of three repetitions. The final supernatants were then centrifuged at 14,000×g for 20 minutes, and the pellets were resuspended in 0.5 ml sucrose-HEPES buffer and kept on ice until analyzed.

A discontinuous gradient described by Madden et al., Anal. Biochem., 163:350-357 (1987), was used to isolate mitochondria from the CHO cells. The mitochondria were labeled with 10 μM NAO for 5 minutes at room temperature while the cells were still intact. The mitochondria were isolated after NAO labeling was confirmed by fluorescence microscopy. Briefly, 2 ml of cell suspension [1×10⁶cells/ml] was homogenized on ice using a Potter-Elvehjem tissue homogenizer. Homogenization was followed visually by light microscopy to ensure the use of a minimum number strokes for disruption of 75% of the initial number of cells. The homogenate was centrifuged at 1300×g for 5 min to remove nuclear and membranous material. The pellet was resuspended in ice-cold 250 mM sucrose and spun again; both supernatant fractions were combined to give a total post-nuclear supernatant (PNS).

A hybrid Pc/Mz discontinuous gradient was prepared using 250 mM sucrose in Labcor 16 ml ultracentrifugation tubes as described, for example, in Madden et al., Anal. Biochem., 163:350-357 (1987). A volume of 2 ml of 35% Mz (ρ=1.1907 g/ml) was overlaid with 2 ml of 17% Mz (ρ=1.1079 g/ml) which in turn was overlaid with 5 ml of 6% Pc (ρ=1.0406 g/ml). The PNS, total volume 1.7 ml, was gently overlaid. Centrifugation was carried out at 4° C. in a Beckman Centrifuge (Model J2-21) at 50,000×g for 15 minutes with the brake setting at zero. According to Madden there are two interfaces that are enriched in mitochondria. The most dense mitochondria (1.1079-1.1907 g/ml) are in the interface that is formed between the 17% and 35% Mz layers (Mz 17%/Mz 35%). The less dense mitochondria (1.0406-1.1079 g/ml) are in the interface that is formed between the 6% Pc and 17% Mz layers (Pc 6%/Mz 17%). The former interface is expected to contain mitochondria with minimum contamination from other organelles while the latter interface, although containing a higher number of mitochondria, is not as pure. Following centrifugation, mitochondrial fractions from these interfaces were carefully removed using a blunt ended needle and kept on ice until analyzed.

Capillary Electrophoresis. The design and set-up of the electrophoresis system with post-column laser-induced fluorescence detection used for this study was described previously (e.g., Duffy et al., Anal. Chem., 73:1855-1861 (2001)). The 488-nm line from an Argon-ion laser (Melles Griot, Irvine, Calif.) was used for excitation. Fluorescence emission was monitored spectrally with an interference filter transmitting in the range 522-552 nm (Omega Optical, Brattleboro, Vt.). In order to reduce scattering at 488 nm caused by interactions between the laser beam and mitochondria or air bubbles, an additional rejection band filter (488-53D, OD4, Omega Optical) was placed in front of the interference filter.

Separations were carried out using both poly-acryloylaminopropanol (poly-AAP) coated (e.g., Gelfi et al., Electrophoresis, 19:1677-1682 (1998)) and bare fused silica capillaries, 50 μm inside diameter (i.d.), 150 μm outside diameter (o.d.). The poly-AAP coating reduces the interactions between proteins associated with the outer mitochondrial membrane and the capillary wall. The detector alignment was optimized by continuously introducing a 10⁻⁹ M solution of fluorescein in BS or sucrose-HEPES buffer by electrokinetic pumping at −200Vcm⁻¹. Detector optimization was completed by observing the reproducibility of the fluorescence produced by individual 6 μm fluorescently-labeled latex beads (Molecular Probes, Eugene, Oreg.). For mitochondrial analysis, the suspension was electrokinetically injected for 5 seconds at −50 V/cm and separated at −200 V/cm for CHO derived mitochondria and injected for 5 seconds at −100 V/cm and separated at −200 V/cm for NS1 derived mitochondria. Sucrose-HEPES buffers were used in all separations.

Data analysis. The output from the photomultiplier tube was electronically filtered (RC=0.01 second) and then digitized using a PCI-MIO-16E-50 I/O board driven by Labview software (National Instruments, Austin, Tex.). The sampling rate was 50 cycles per second. The data were stored as binary files that were then analyzed using Igor Pro software (Wavemetrics, Lake Oswego, Oreg.). Tabulation of peak intensities and migration times for individual events was done using PickPeaks, an in-house written Igor Procedure that has been previously described (e.g., Duffy et al., Anal. Chem., 73:1855-1861 (2001)). The program selects those events with signal intensities higher than three times the standard deviation of the background and the events are sorted in order of increasing intensity. A comparison among the sorted events from the mitochondrial electropherogram and the corresponding controls allows for selection of a new threshold that clearly identifies events corresponding to a migration time window in the mitochondrial electropherogram. The events in the migration time window are used to calculate individual electrophoretic mobilities.

Results and Discussion

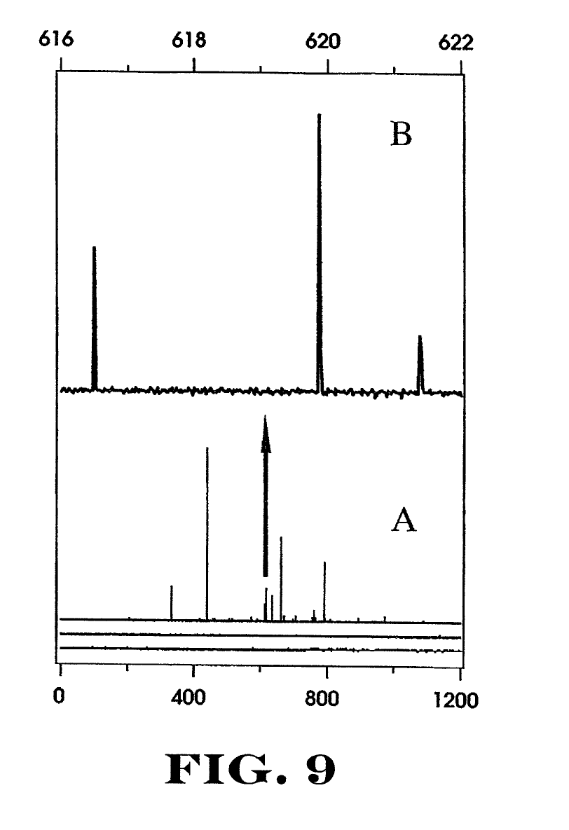

Mitochondria analysis. An electropherogram resulting from the electrokinetic injection of a mitochondrial isolate from NS1 cells consists of spikes as shown in the upper trace of FIG. 9A. Instead of the typical migration zones observed in electropherograms of small ions or molecules, 47 spikes are detected (FIG. 9A). As suggested in FIG. 9B, an expansion of a 4 second migration time window from the upper trace of FIG. 9A, all the spikes have practically the same width, 200 milliseconds (ms). As expected, the peak width is the same whether the spike was detected early or late in the separation and depends on the traveling time through the tightly focused laser beam that defines the detection volume in the post-column laser-induced fluorescence detector. The characteristic peak width is one of the criteria for identification of a spike and exclusion of potential broad migration zones caused by free dye in the sample.

Identification of these spikes as individual mitochondrial species relies on the specificity of NAO which forms a complex (K_{D}=5×10⁻⁷ M) with cardiolipin, a phospholipid specifically found in the mitochondrial inner membrane (e.g., Petit et al., Eur. J. Biochem., 209:267-273 (1992)), and the use of a mitochondrial isolation procedure. As expected, the analysis of a control containing only NAO and no mitochondria, lower trace in FIG. 9A, results in a spike-free electropherogram. Similarly, the electropherogram of unlabeled mitochondria, middle trace in FIG. 9A, does not have spikes, indicating that scattering is not causing false spikes and that mitochondrial components do not have significant autofluorescence when excited with the 488-nm line of an argon-ion laser.

Although each detected event is likely caused by an individual mitochondrion, mitochondrial fragments or aggregates resulting from the disruption process may also be detected. In order to minimize the presence of fragments, we adopted nitrogen cavitation for cell disruption because it is known that this procedure produces intact organelles, minimizing the chance of detecting fragments (e.g., Hunter et al., Biochim. Biophys. Acta, 47:580-586 (1961); Adachi et al., J. Biol. Chem., 273:19892-19894 (1998)). No systematic studies of mitochondrial aggregation in isolation buffers have been reported, however, buffers relying primarily on mannitol for osmotic support are favored because, relative to sucrose, they exhibit decreased binding to glycogen (e.g., Graham in Subcellular Fractionatoin A Practical Approach, J. M. Graham & D. Rickwood, Eds., pp. 1-29 (IRL Press, New York, N.Y., 1997)). The isolation buffer mimics the pH and osmolarity of the original cellular environment, minimizing the chances of agglomeration by retaining the electrostatic repulsions among mitochondria, which are negatively charged at biological pH.

The signal intensity of each mitochondrial species is also highly variable as seen in the upper trace of FIG. 9A and in FIG. 9B. Although, the 2:1 stoichiometry in the NAO cardiolipin complex suggests that peak intensity is a measurement of cardiolipin content, there are several factors that make the fluorescence intensity a qualitative parameter: (i) for the CHO cells, the NAO concentration in the cytoplasm is expected to be different from the extracellular NAO concentration used for whole cell labeling and may also be variable within the cell; (ii) determination of an appropriate concentration of NAO is not straightforward. In excess, NAO may stain other phospholipids found in the mitochondrial membranes, K_{D}=1.4×10⁻⁵ M for phosphatidylserine and phosphatidylinositol (e.g., Petit et al., Eur. J. Biochem., 209:267-273 (1992)), in deficit it will not saturate the cardiolipin binding sites, thus prohibiting accurate determination of the total cardiolipin content; and (iii) variations in detector response as determined with fluorescently labeled latex beads may be as large as RSD=35% (data not shown). Therefore, the fluorescence intensity is only a qualitative estimate of the amount of cardiolipin in a given mitochondrial species.

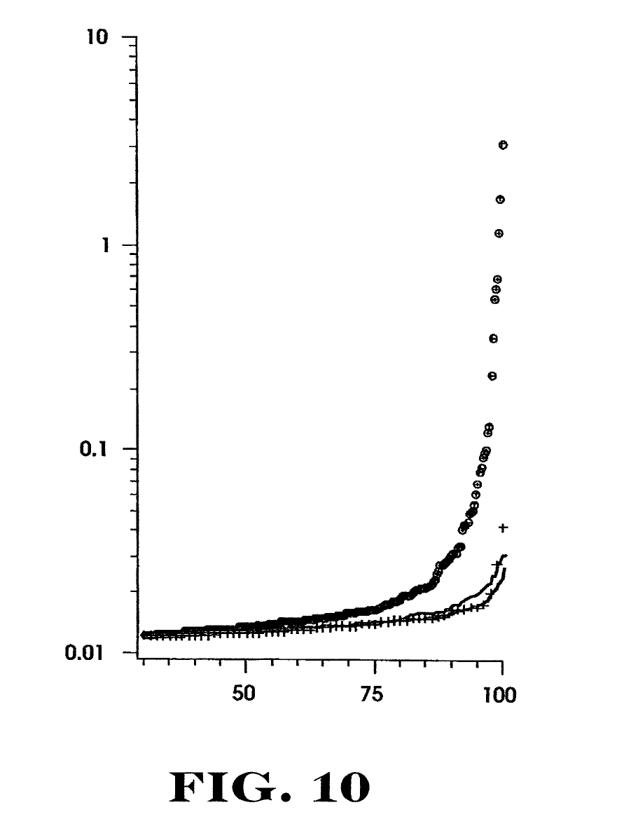

Despite its qualitative nature, signal intensity is a useful criterion to distinguish detected mitochondrial species from events caused by random background noise. FIG. 10 shows the sorted intensities of the spikes present in the electropherograms of FIG. 9A. Each electropherogram has a background standard deviation (σ) close to 0.0038 V (RSD 3.9%) in the range 0-300 seconds, a region where mitochondrial species are not detected. Only events with intensities larger than 3σ are included in FIG. 10. High-intensity events are abundant only in the NAO labeled mitochondrial electropherogram. The controls for unlabeled mitochondria (middle trace, FIG. 9A) and NAO alone (lower trace, FIG. 9A) collected over the range, 0-1170 seconds resemble the events in the 0-300 second range of the NAO labeled mitochondrial electropherogram. Alternatively, in all the data sets, 60% of the sorted events have values lower than 0.013 V. These events are considered false positives and are expected from the statistical sampling if noise is described by a normal distribution. In this case, 0.3% of events will lie outside of 3σa. For example, considering the window 0-300 seconds (15 000 points), there should be 45 false positives, a number of the same magnitude as the actual number of false positives detected in the window. However, there are events between the 60 and 90% intensity range that could not be easily assigned to mitochondria or random events. Only those events with fluorescence higher than 0.037 V are unique to the NAO labeled mitochondrial electropherogram. Also, FIG. 10 suggests that most of the events in the controls and the pre-migration window (0-300 seconds) never reach 0.02 V, confirmed by a histogram distribution and appreciated as a plateau in FIG. 10. Therefore, when drawing conclusions related to the analysis of mitochondrial species, we considered only those events with intensities higher than 0.02 V.

Analysis of NS1 mitochondria by CE-LIF as described in FIG. 9 was done in triplicate. The number of detected events with signals larger than 0.02 V was 43±10, Table 4. The variation in the number of events was not caused by heterogeneity in the isolate because the sample was thoroughly mixed prior to injection. In addition, proper controls between consecutive electrophoretic separations confirmed that there was no carry over of mitochondria to the next separation. That the variation is slightly larger than expected from a Poisson distribution (√N=7) may be the result of electrokinetic bias or anomalies in the sampling due to simultaneous introduction of a large number of mitochondria.

TABLE 4
Electrophoretic Mobility Distributions of Mitochondria

| | NS1 Cells^{a} | | | | CHO Cells^{a} |
|---|---|---|---|---|---|
| | 1 | 2 | 3 | Ave. ± Std. Dev.^{b} | Ave. ± Std. Dev.^{b} |
| Range | −1.2 to −4.0 | −1.2 to −4.3 | −1.2 to −4.1 | −1.2 to −4.3^{c} | −0.8 to −4.2^{c} |
| 25th Percentile | −1.8 | −1.7 | −1.4 | −1.7 ± 0.2 | −1.2 ± 0.2 |
| Median | −2.0 | −2.1 | −1.7 | −1.9 ± 0.2 | −1.4 ± 0.1 |
| 75th Percentile | −2.7 | −2.7 | −2.9 | −2.8 ± 0.1 | −1.7 ± 0.2 |
| Total events | 51 | 47 | 32 | 43 ± 10 | 157 ± 59 |

^{a}All values in gray are electrophoretic mobility values, multiplied by 10⁴ and given in units of cm²V⁻¹s⁻¹.
^{b}The average and the standard deviation of the value obtained from three replicates. Individual replicates are not shown for CHO cells.
^{c}The range for all the events combined.

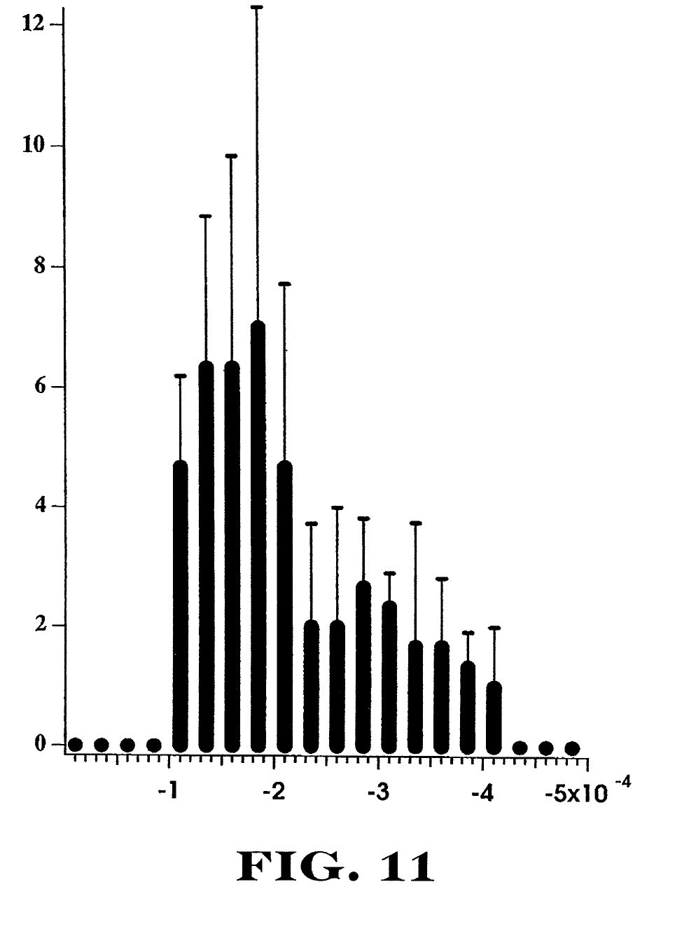

The combined results for three replicates of mitochondrial analysis from NS1 cells performed as in FIG. 9 are shown in FIG. 11. Mitochondrial species migrated within the range −1.2×10⁻⁴ to −4.3×10⁻⁴ cm²V⁻¹s⁻¹. The 25^{th} percentile of fast migrating species have mobilities within −2.8 and −4.3×10⁻⁴ cm²V⁻¹s⁻¹; the equivalent fraction of slow migrating species have mobilities within −1.8 and −1.7×10⁻⁴ cm²V⁻s⁻¹ (average values, Table 4). These distributions provide the first detailed description of the electrophoretic mobility of mitochondrial species. These distributions are based on individual measurements and are not compromised by slow detection or broad migration zones.

The observed dispersion in the electrophoretic mobility of mitochondria from NS1 cells is likely the combined result of their natural diversity, the effect of the disruption process used during isolation and to a lesser degree, interactions with the capillary walls during the separation. The latter problem has been minimized by using poly-AAP coated capillaries. This hydrophilic coating has been successfully used to reduce protein interactions with the capillary wall (e.g., Gelfi et al., Electrophoresis, 19:1677-1682 (1998)). We have also used this coating to decrease interactions between liposomes, used as mitochondrial models, and capillary walls (e.g., Duffy et al., Anal. Chem., 73:1855-1861 (2001)). Without this coating, mitochondria do not migrate within a defined migration window (data not shown).

Application of an electric field to the mitochondrial samples may result in organelle disruption or aggregation (e.g., Duffy et al., Anal. Chem., 73:1855-1861 (2001)). Fortunately, the electric field used in these studies, −200V/cm is below the critical fields described in the literature (i.e., 600 V/cm) (Zimmerman et al., Electromanipulation of Cells, (CRC Press, New York, N.Y., 1996)). As discussed above, disruption of cells by nitrogen cavitation decreases the possibility of organelle disruption, thus the variety of mobilities is likely caused by the disparity of mitochondrial surface properties. It is expected that mitochondrial properties will vary throughout the cell cycle, the localization within the cell, the age of the cell and even cellular performance.

Comparison among mitochondrial samples. In order to use the electrophoretic analysis described above to characterize the electrophoretic mobility of a mitochondrial sample, it is necessary to evaluate the reproducibility of the method. Table 4 contains the electrophoretic mobility data of the same sample analyzed in triplicate from FIG. 11. The analysis was performed on the same day to minimize possible error introduced by different sample preparation and instrument set up. A comparison of the 25th percentile, the median and the 75th percentile for each analysis indicate that their RSDs are 11, 11, and 4% respectively. These values establish the scope of the method in comparing distributions of electrophoretic mobilities of individual mitochondrial species.

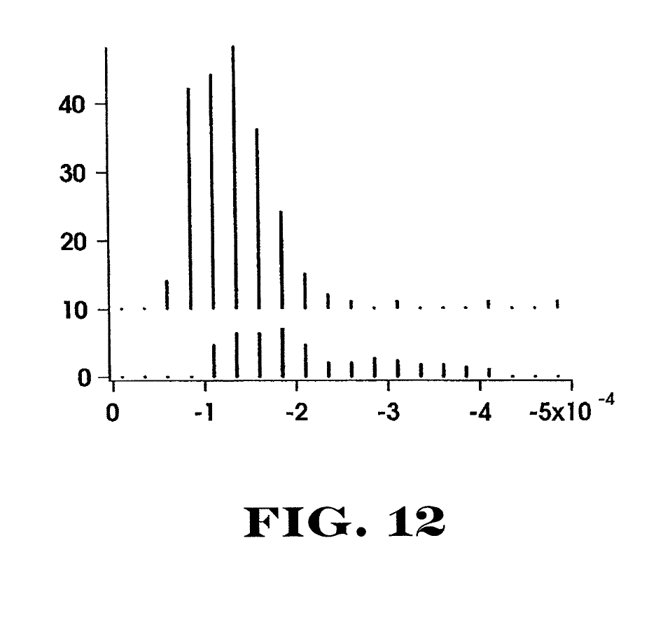

Variations in electrophoretic mobility distributions of mitochondria from different preparations are compared in FIG. 12 and Table 4. The mobility distribution of mitochondria from NS1 cells (lower) and CHO cells (upper) are visually different, have a different number of events (43 and 157, respectively), and have different electrophoretic characteristics as seen in Table 4. The most striking difference is above the 75th percentile where the preparations span the range −2.8 to −4.3×10⁻⁴ cm²V⁻¹s⁻¹ and −1.7 to −4.2×10⁴ cm²V⁻¹s⁻¹ respectively. Although the differences observed between the distributions of the two mitochondrial preparations may be affected by use of different isolation and purification procedures, these data clearly indicate that CE-LIF can provide a detailed description of the electrophoretic properties of mitochondrial species.

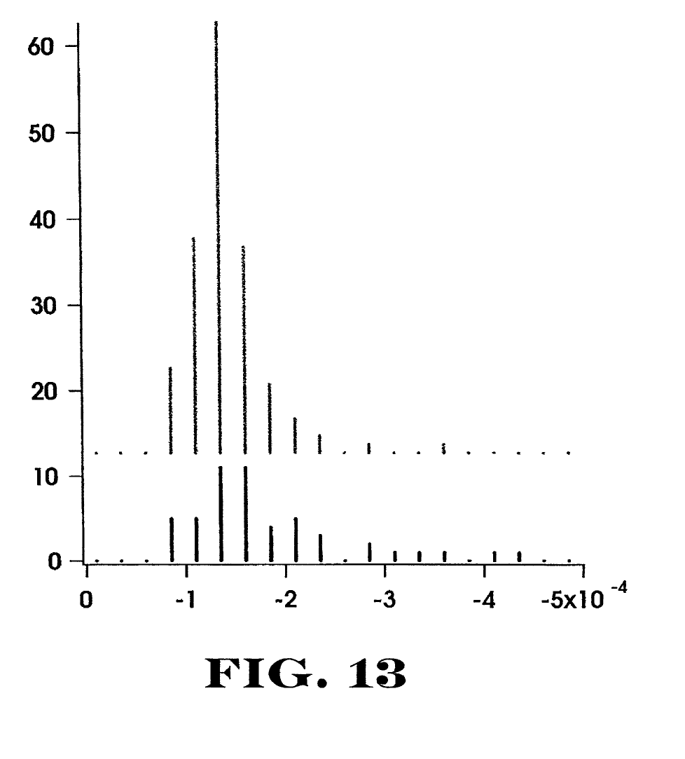

In a separate experiment, we also determined that the electrophoretic mobility distributions of mitochondria from CHO cells do not seem to differ between fractions containing mitochondria of different density (FIG. 13). After mechanical disruption of CHO cells, mitochondria were separated into two density ranges by discontinuous gradient centrifugation: 1.0406-1.1079 g/ml and 1.1079-1.1907 g/ml (e.g., Madden et al., Anal. Biochem., 163:350-357 (1987)). The light fraction contained 125 events while the heavy fraction contained 52 events. The relative abundance is consistent with measurements of enzymatic activity by Madden et al., Anal. Biochem., 163:350-357 (1987). A comparison based on a graphic display (not shown) indicates that the slight variations of the mobilities for the different percentiles are insignificant when considering the typical errors shown in Table 4. For example the electrophoretic mobility range is −0.95 to −3.6×10⁻⁴ cm²V⁻¹s⁻¹ and −0.90 to −5.4×10⁴ cm²V⁻¹s⁻¹ for the light and heavy fraction respectively. Similarly the heavy fraction has slightly higher mobility values at the 25^{th} percentile, the median, and the 75^{th} percentile. Namely −1.3 versus −1.5×10⁻⁴ cm²V⁻¹s⁻, −1.5 versus −1.7×10⁻⁴ cm²V⁻¹s⁻¹, and −1.7 versus 2.2×10⁻⁴ cm²V⁻¹s⁻¹, respectively. Therefore we can conclude that the density of a mitochondrion is not related to its electrophoretic mobility. This finding further suggests that electrophoretic mobility and density are orthogonal properties that could be combined for further purification or subfractionation of mitochondrial preparations.

Conclusions

The distribution of electrophoretic mobilities in a mitochondrial isolate suggests the presence of diversity within mitochondrial preparations, a likely effect of both the preparation procedure and natural diversity. In particular, it has been reported that mitochondria within the cell are a dynamic system, characterized by fission and fusion processes (e.g., Santel et al., J. Cell Sci., 114:867-874 (2001); Yoon et al., Curr. Biol., 11:R67-R70 (2001)). As a result it would be expected that their surface properties and thus electrophoretic mobility would be a reflection of that diversity. Considering that individual mitochondrial species can be detected when they migrate out less than 100 milliseconds apart, differences in mobility as low as 400 parts per million are feasible. Thus, electrophoretic distributions promise to be a powerful tool to characterize mitochondrial diversity and may provide methods for characterizing or monitoring isolation and preparation procedures. The results presented here suggest that individual mitochondria within a specific electrophoretic mobility range could isolated or further purified after using other isolation techniques such as density gradient centrifugation. The capillary electrophoresis strategy reported for individual mitochondria is likely to be a method easily applicable to other organelles, microsomes, or artificial nanoparticles.

### Example 4

### Determination of the Cardiolipin Content of Individual Mitochondria

In eukaryotes, the phospholipid diphosphatidylglycerol or cardiolipin is found exclusively in mitochondria, localized primarily in the inner mitochondrial membrane. Although its role has not been unequivocally elucidated it is an essential structural component of the mitochondrial membrane and is critical to the electron transport chain. Cardiolipin complexes with cytochrome c, and recently a decrease in cardiolipin content has been implicated in the liberation of cytochrome c, a proapoptotic step.

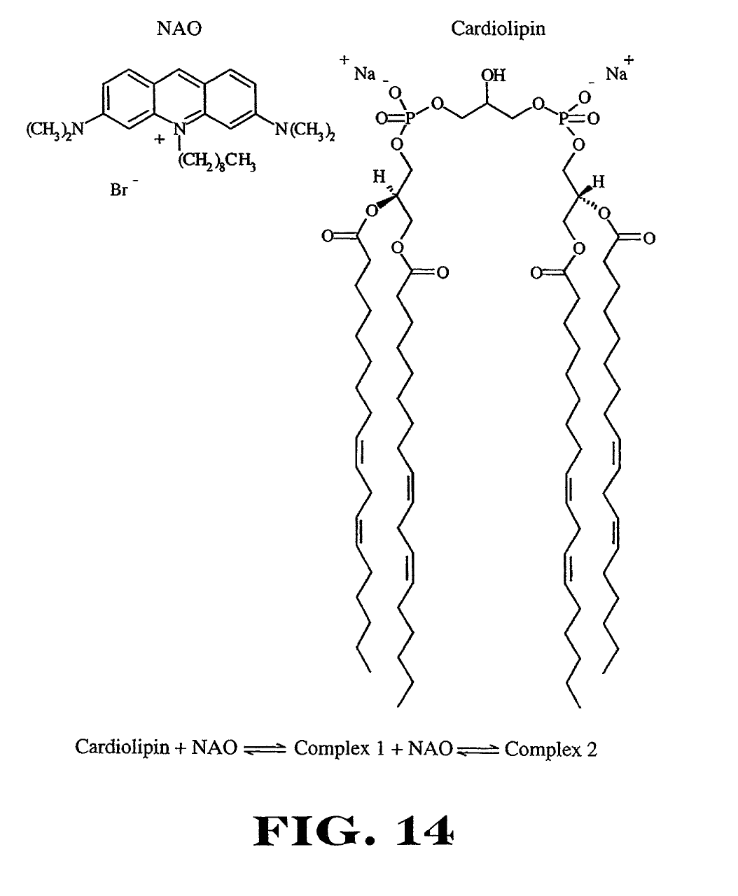

As seen in FIG. 14, cardiolipin has a dimeric structure with four acyl groups and two negative charges separated by the glycerol group (Schlame et al., Prog. Lipid Res., 39:257-288 (2000)). The fluorescent dye, 10-N-nonyl acridine orange (NAO) exhibits mitochondrial selectivity by binding to cardiolipin with Kₐ=6.6×10⁵ M⁻¹ (Petit et al., Eur. J. Biochem.209:267-273 (1992)). The affinity of NAO for cardiolipin has been attributed to electrostatic attraction of the quarternary ammonium of NAO for the phosphate groups of cardiolipin. Furthermore, 2 NAO molecules can bind a single cardiolipin, allowing the planar, nonpolar acridinium groups to interact, red-shifting the fluorescence emission wavelength (Petit et al., Eur. J. Biochem., 220:871-879 (1994)). Although the fluorescence intensity of NAO has been demonstrated to be affected by some membrane potential altering drugs, it is widely used as a mitochondrial mass probe. NAO has been used to estimate the cardiolipin content of mitochondria in bulk mitochondrial isolates (e.g., Petit et al., Eur. J. Biochem.209:267-273 (1992)) and in whole cells (e.g., Gallet et al., Eur. J. Biochem., 228:113-119 (1995)) however, there have not been any reports of use of NAO to estimate the cardiolipin contents of individual mitochondria.

Because many investigators have demonstrated that mitochondria from a single cell may exhibit a diversity of properties and cannot be thought of as identical, it is desirable to study the characteristics of individual mitochondria which can number in excess of one thousand per cell. Using membrane potential sensitive fluorescent dyes, membrane potential has been evaluated primarily by flow cytometry or fluorescence microscopy methods. Flow cytometry allows the fluorescence of mitochondria comprising a bulk mitochondrial sample to be rapidly and accurately evaluated, whereas microscopy permits spatial and temporal resolution of fluorescence measurements. The characteristic copy number of mitochondrial DNA has been investigated by PCR from single or very small assemblages of mitochondria collected using techniques such as flow cytometry or optical trapping. Other characteristics that are routinely evaluated in individual mitochondria with fluorescent probes, both in situ and in isolated organelles, are pH and calcium ion concentrations. Microscopy has also been used to determine enzymatic activity, NAD redox state, and morphology.

Capillary electrophoresis with laser-induced fluorescence (CE-LIF) is uniquely suited for the evaluation of properties that can be discerned with a fluorescence signal, either via native fluorescence when possible, or using a fluorescent probe. Rather than broad peaks comprised of multiple events, in our hands particles are detected as well-defined spikes, which have been determined to correspond to single events. The ability to resolve individual events is attributed to the sensitivity of the sheath flow cuvette and a high data acquisition rate (typically 50 to 100 Hz). CE-LIF enables the fluorescence emission of a particle or organelle to be directly determined, and does not require a deconvolution scheme as is necessary in microscopy, thus the potential for bias is reduced. In contrast to flow cytometry, the separation regime inherent in CE-LIF enables the electrophoretic mobility of a particle to be measured and could be incorporated into orthogonal separation techniques. We have reported the use of CE-LIF to characterize both liposomes and mitochondrial preparations and here we extend the technique to estimate the cardiolipin content of individual mitochondria.

Materials and Methods

Chemicals. Sucrose was purchased from Mallinkrodt (Paris, N.Y.). N(2-hydroxyethyl)piperazine-2′-(2-ethanesulphonic acid) (HEPES) was from EM Science (Gibbstown, N.J.). D-mannitol, ethylenediaminetetraacetic acid (EDTA), Dulbecco's Modified Eagle's Medium and bovine calf serum were from Sigma (St. Louis, Mo.). Potassium hydroxide and digitonin were purchased from Aldrich (Milwaukee, Wis.). Ethanol was from Aaper (Shelbyville, Ky.). Dimethyl sulfoxide (DMSO) was from Burdick and Jackson (Muskegon, Mich.). CE buffer (buffer S) contained 250 mM sucrose, 10 mM HEPES adjusted to pH 7.47 with potassium hydroxide. Mitochondrial isolation buffer (buffer M) consisted of 210 mM d-mannitol, 70 mM sucrose, 5 mM HEPES and 5 mM EDTA, adjusted to pH 7.38 with potassium hydroxide. All buffers were made with milli-Q deionized water and filtered (0.2 μm) prior to use. Stock solutions of 10⁻³ M fluorescein and 10⁻³ M 10-nonyl acridine orange (NAO) (Molecular Probes, Eugene, Oreg.) were made in ethanol and DMSO respectively. Dilutions of these solutions were prepared immediately prior to use. A 100 mg/ml digitonin stock solution was prepared in DMSO, and diluted to 10 mg/ml in buffer M before using.

Cell culture. The mitochondria used in this study were isolated from NS1 cells grown at 37° C. and 5% CO₂. The cells (a kind donation from Dr. Sally Palm, Department of Laboratory Medicine and Pathology, University of Minnesota) were cultured in 90% Dulbecco's Modified Eagle's Medium, 10% calf serum and were maintained by addition of new media every 2-3 days. Biosafety level I was observed in all preparations.

Spectrofluorometry of mitochondria. A differential centrifugation protocol based on procedures from Howell et al., Plasmid, 16:77-80 (1986) and Bogenhagen et al., J. Biol. Chem., 249:7991-7995 (1974) was followed to extract mitochondria from the NS1 cells. Briefly, NS1 cells in the log phase were washed three times with cold buffer M and counted using a Fuchs-Rosenthal hemacytometer (Hausser Scientific, Horsham, Pa.). Cells were diluted in buffer M to 8.6×10⁶ cells/ml. To the cell suspension 15 μg/ml digitonin was added. Following a 5 minute incubation on ice, the cells were placed in an ice cooled cell disruption bomb (Parr Instrument Co., Moline, Ill.) which was charged with N₂ to 650 pounds per square inch (psi) for 20 minutes. As estimated by light microscopy, 80% of the cells were disrupted. Whole cells, nuclei and large cell debris were removed by centrifugation at 1,400×g for 5 minutes in an Eppendorf 541 SD centrifuge (Eppendorf, Westbury, N.Y.) the supernatants were removed and centrifuged again, for a total of three times. The final supernatant was added to 12 siliconized tubes in 300 μl aliquots and the mitochondria were pelleted by centrifugation at 14,000×g for 20 minutes. NAO (final concentration 0-100 μM) and buffer M were added, and following incubation on ice for 15 minutes the mitochondria were pelleted and resuspended to 150 μl in buffer S. Assuming that there are 1000 mitochondria/cell and that all mitochondria from disrupted cells were recovered, the concentration of mitochondria in the samples was approximately 1.4×10¹⁰/mL. Samples were kept on ice until analyzed. Fluorescence emission spectra of the NAO stained mitochondria produced by excitation at 488±3 nm were collected using a Jasco FP-6200 spectrofluorometer (Jasco Inc., Easton, Md.) with a 50 μl quartz cuvette (Starna Cells, Atascadero, Calif.).

Preparation of mitochondria for CE. Mitochondria were prepared for capillary electrophoresis as for spectrofluorometry, however, prior to the low speed centrifugation step NAO was added to three 1 ml aliquots of disrupted cells in concentrations of 5, 1 and 0 μM. Following incubation, whole cells, nuclei and large cell debris were removed by centrifugation at 1,400×g for 5 minutes, the supernatants were removed and centrifuged again, for a total of three repetitions. The final supernatants were added to siliconized tubes and the mitochondria were pelleted by centrifugation at 14,000×g for 20 minutes, resuspended in 500 ml buffer S and kept on ice until analyzed.

CE-LIF instrumentation. The design and set-up of the electrophoresis system with post-column laser-induced fluorescence detection used for this study was described previously (e.g., Duffy et al., Anal. Chem., 73:1855-1861 (2001); Duffy et al., Anal. Chem., 74:171-176 (2002). The 488-nm line from an Argon-ion laser (Melles Griot, Irvine, Calif.) was used for excitation. Fluorescence emission was monitored spectrally with an interference filter transmitting in the range 517 to 552 nm (Omega Optical, Brattleboro, Vt.). In order to reduce scattering at 488 nm caused by interactions between the laser beam and mitochondria or air bubbles, an additional rejection band filter (488-53D, OD4, Omega Optical) was placed in front of the interference filter.

CE-LIF of mitochondria. Separations were carried out using a 30.6 cm polyacryloylaminopropanol (poly-AAP) coated (e.g., Gelfi et al., Electrophoresis, 19:1677-1682 (1998)) fused silica capillary, 50 μm inside diameter, 150 μm outside diameter. The poly-AAP coating reduces the interactions between proteins associated with the outer mitochondrial membrane and the capillary wall. The detector alignment was optimized by continuous electrokinetic introduction of a 10⁻⁹ M solution of fluorescein in buffer S at −200Vcm⁻¹. Detector optimization was completed by observing the reproducibility of the fluorescence produced by individual 1 μm fluorescently labeled latex beads (Polysciences Inc., Warrington, Pa.), and the relative standard deviation of the fluorescence peak heights was 24%.

Data analysis. The output from the photomultiplier tube was electronically filtered (RC=0.01 second) and then digitized using a PCI-MIO-16E-50 I/O board driven by LabVIEW software (National Instruments, Austin, Tex.). The sampling rate was 50 cycles per second. The data were stored as binary files that were then analyzed using Igor Pro software (Wavemetrics, Lake Oswego, Oreg.). Tabulation of peak intensities and migration times for individual events was done using PickPeaks, an in-house written Igor Procedure that has been previously described (e.g., Duffy et al., Anal. Chem., 73:1855-1861 (2001)). The program selects those events with signal intensities higher than three times the standard deviation of the background.

Results and Discussion

Because its relative intensity is 14 times greater (e.g., Petit et al., Eur. J. Biochem., 220:871-879 (1994)), the green fluorescence emitted by complex 1 (FIG. 14) was selected for analysis rather than the red fluorescence generated by complex 2. One molecule of NAO can bind to phospholipids with single negative charges, specifically, phosphatidylserine and phosphatidylinositol, resulting in green fluorescence as per complex 1, albeit with lower affinity (Kₐ=7×10⁴ M⁻¹) (e.g., Petit et al., Eur. J. Biochem.209:267-273 (1992)). However, these phospholipids are much less abundant than cardiolipin (e.g., Voelker in Biochemistry of Lipids and Membranes, pp. 475-502 (The Benjamin/Cummings Publishing Co., Inc., Menlo Park, Calif., 1985); Pepe et al., Am. J. Physiol. Heart Circ. Physiol., 276:H149-H158 (1999); Lesnefsky et al., Am. J. Physiol. Heart Circ. Physiol., 280:H2770-H2778 (2001)), and should not significantly skew the values related herein.

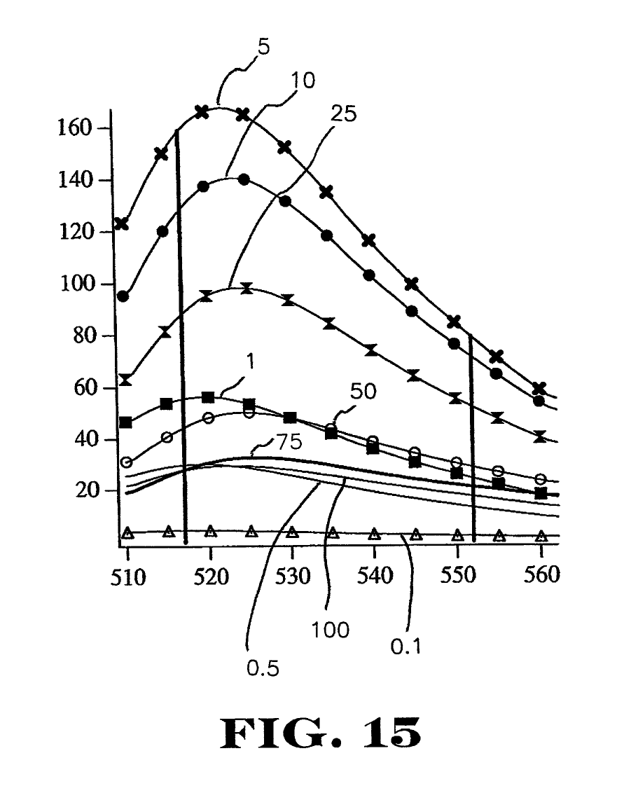

To establish a CE-LIF method for cardiolipin determination in mitochondria, prior spectrofluorometric measurements were needed to select appropriate NAO concentrations. Two concentrations are necessary: a saturating concentration at which, ideally, all of the cardiolipin molecules are in complex 1, and a lower concentration, termed subsaturating, at which a fraction of the available cardiolipin molecules present are in complex 1, with the remainder not being bound by the dye. In order to select appropriate subsaturating and saturating NAO concentrations, mitochondrial isolate was stained with concentrations of NAO ranging from 0 to 100 μM. The fluorescence spectra of the isolates are shown in FIG. 15. Notably, there was no red-shift evident in the concentrations we assayed, indicating that there was not a significant concentration of complex 2.

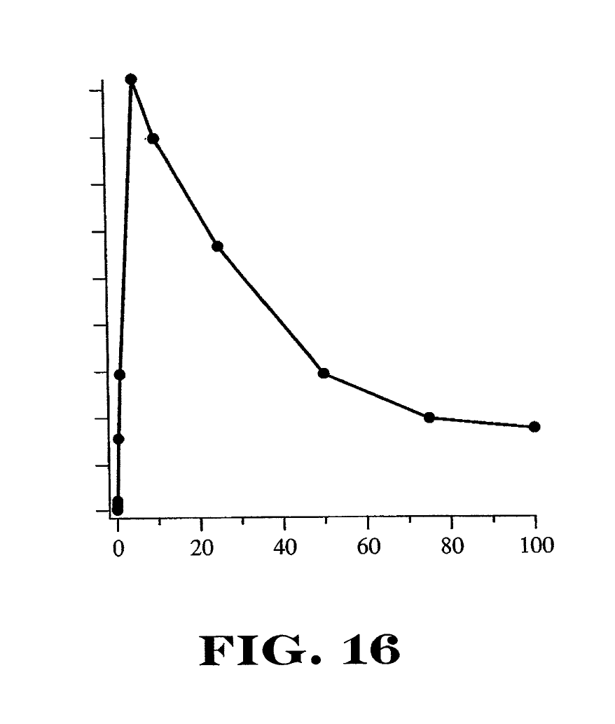

A saturation curve of fluorescence peak area with respect to NAO concentration is shown in FIG. 16. The spectra were integrated from 517 to 552 nm, the range detected by the interference filter used in CE-LIF analysis. A maximum at 5 μM is in close agreement with findings by Petit et al., Eur. J. Biochem., 220:871-879 (1994) for murine L1210 cells. At concentrations greater than 5 μM the resultant fluorescence peak area decreases steadily. This is attributed to increased formation of complex 2 (e.g., Petit et al., Eur. J. Biochem., 220:871-879 (1994); Gallet et al., Eur. J. Biochem., 228:113-119 (1995)). Based on these findings, concentrations of 1 μM and 5 μM were selected as subsaturating and saturating concentrations of NAO (complex 1), respectively, for CE-LIF investigations.

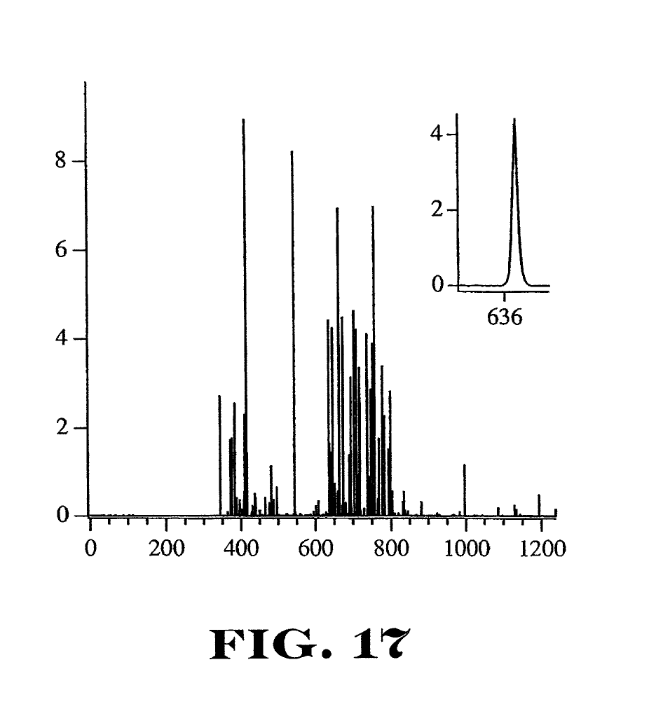

Following staining with subsaturating and saturating concentrations of NAO, mitochondrial preparations were analyzed by CE-LIF in a poly-AAP coated capillary. A typical electropherogram is shown in FIG. 17, rather than broad zones, mitochondrial events appear as spikes of similar width, approximately 90 milliseconds, in a defined migration time window. It is essential to emphasize that although we are able to detect individual events, an event could be comprised of mitochondrial fragments or aggregated mitochondria traveling together through the sheath-flow cuvette, an isolation buffer containing d-mannitol was chosen to minimize this aggregation. Controls consisting of 5 μM NAO in buffer S and unstained mitochondria only contained small noise spikes spread throughout the electropherogram.

In a typical electropherogram of the mitochondrial preparation stained with 1 μM NAO, the subsaturating NAO concentration (not shown) 421 mitochondrial events were detected, and the summation of the peak heights was 118.99 V. For comparison, the electropherogram shown in FIG. 17 in which the mitochondria preparation was stained with the saturating NAO concentration contains 407 peaks with a total height of 147.09 V. Because the relative standard deviation of the number of events detected from replicate injections is typically less than 14%, the different numbers of events that were detected in these CE-LIF runs were statistically the same. Dosage with a subsaturating concentration of NAO would result in essentially all of the dye being bound to cardiolipin because the dye is the limiting reagent. The known amount of dye used in subsaturating conditions can be correlated to the combined peak height of all the events detected by CE-LIF, and a sensitivity factor can be calculated. To measure the cardiolipin content of the mitochondrial events the sample is treated with the saturating NAO concentration and for each peak the sensitivity factor facilitates the calculation.

From the electropherogram of mitochondria stained with the 1 μM subsaturating concentration of NAO shown in FIG. 17, a sampled volume (Volᵢₙⱼ) was calculated based on the median migration time of the mitochondrial events. Using equation 6 where volᵢ and vol_{f}, are the volumes of the sample prior to and following differential centrifugation and [NAO]ₛₛ is the subsaturating NAO concentration, the amount of NAO injected can be calculated.

$$Amount of NAO injected = ( \frac{{[ NAO ]}_{ss} \times {vol}_{i}}{{vol}_{f}} ) {vol}_{inj} \qquad ( 6 )$$

A sensitivity factor of 9.67×10¹⁴ V/mol relating the height of a mitochondrial spike to its cardiolipin content may then be calculated as the ratio of the sum of the mitochondrial peak heights divided by the amount of NAO injected (1.23×10⁻¹⁴ mol).

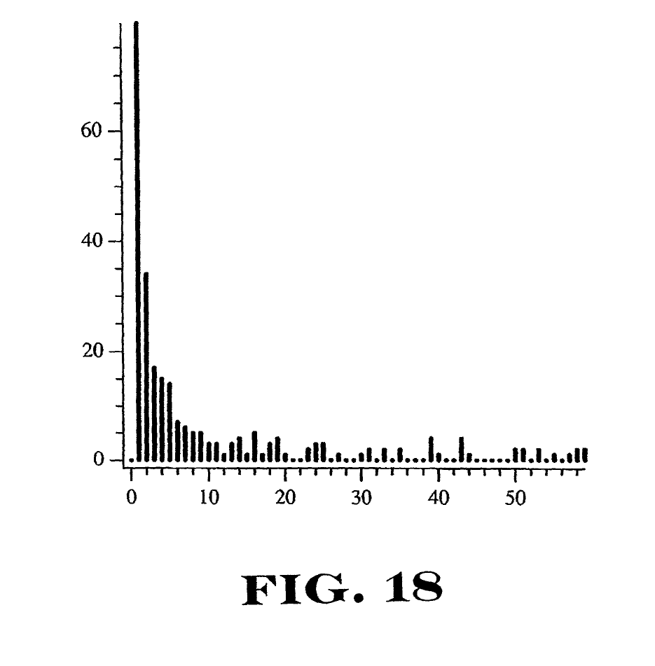

Using this sensitivity factor, the cardiolipin content of the mitochondrial events detected in the sample stained with the 5 μM saturating NAO concentration were calculated, and are appreciated as a histogram (FIG. 18). There is a wide distribution ranging from 1.2 to 920 amol, with a median of 4 amol. It is possible that some of the events in this bin may be due to mitochondria that were fragmented by the disruption or electrophoretic processes. In order to minimize the presence of fragments, we adopted nitrogen cavitation for cell disruption because it is known that this procedure can produce intact organelles (Adachi et al., J. Biol. Chem., 273:19892-19894 (1998); Hunter et al., Biochim. Biophys. Acta, 47:580-586 (1961). Likewise, some of the events comprising the high cardiolipin content tail of the histogram may be due to mitochondrial aggregation. However, a buffer relying primarily on mannitol for osmotic support was used for mitochondrial isolation because, relative to sucrose, it will diminish binding to glycogen (e.g., Graham et al. in Subcellular Fractionation: a Practical Approach, J. M. Graham & D. Rickwood, Eds. (IRL Press, New York, N.Y., 1997)). Likewise, if the mitochondria of NS1 cells are reticulated it is possible that upon disruption random mitochondrial bodies could form. Similarly, electrophoretic mobilities displayed a broad (4×) range which is likely a result of varied electrical charge density or size and possibly transient interactions of the organelles with the walls of the capillary. The wide spread of cardiolipin contents and electrophoretic mobilities may reflect true diversity within the sample.

Several approximations and assumptions were used to calculate the cardiolipin content of the mitochondrial events. Some error, at least 0.5% based on a report by Voelker in Biochemistry of Lipids and Memnbranes, pp. 475-502 (The Benjamin/Cummings Publishing Co., Inc., Menlo Park, Calif., 1985), was undoubtedly introduced by the sole use of the green NAO fluorescence rather than the red fluorescence. The red NAO fluorescence is more specific to cardiolipin, because green fluorescence would also be produced by 1:1 complexation of NAO and phosphatidylserine or phosphatidylinositol (e.g., Petit et al., Eur. J. Biochem.209:267-273 (1992)). Moreover, by neglecting the red fluorescence the small fraction of cardiolipin present in the form of complex 2 was not detected. Furthermore, in addition to the 24% relative standard deviation in detector response, the sampled volume used in equation 6 may be subject to a high degree of error. However, the estimate of cardiolipin content set forth in this report is in agreement with measurements made in bulk, 2.2±0.3 nmol/10⁶ cells for yeast cells grown in a high glucose medium, which, when assuming 1000 mitochondria/cell is 2.2 amol cardiolipin/mitochondria (e.g., Gallet et al., Eur. J. Biochem., 228:113-119 (1995)).

Concluding Remarks

Although there are some limitations associated with the uniformity of the CE-LIF detector response and with differentiating intact mitochondria from aggregates and fragments, this methodology has unique advantages over microscopy and flow cytometry, which currently dominate the field of single particle characterization, such as higher sensitivity, decreased potential for bias due to the lack of a deconvolution scheme and the ability to separate mitochondria based on their electrophoretic mobilities.

### Example 5

### Determination of Individual Microsphere Properties

Materials and Methods

Reagents, buffers, and microsphere suspensions. Sodium tetraborate and sodium dodecyl sulfate (SDS) was purchased from EM Sciences, Gibbstown, N.J. and J T Baker, Phillipsburg, N.J. Two buffer systems were used in these studies: A borate buffer containing 10 mM borate, pH 9.3 and a borate-SDS buffer containing 10 mM borate, 10 mM SDS, pH 9.3. The 1.0, 0.5, and 0.2-μm diameter Fluoresbrite microspheres (Polysciences, Warrington, Pa.) are sulfated particle suspensions containing 2.55, 2.60, and 2.70% in solid latex. The size relative standard deviations (RSD's) provided by the manufacturer for these microspheres are 2, 2, and 3%, respectively. They are embedded with YG, a proprietary dye with maximum excitation and emission at 458 and 540 nm, respectively. The 6-μm carboxylated microspheres, embedded with fluorescein, (Molecular Probes, Eugene, Oreg.) have an excitation and emission maximum at 505 and 515 nm, respectively. The manufacturer reports less than 10% RSD for their size distribution. The spectral properties of all microspheres were compatible with excitation by the 488-nm line from an argon-ion laser used for the CE-LIF analysis described later in this section.

Numbers of microspheres/ml for the Polysciences products were calculated according to the equation:

$$No . of microspheres \text{/} ml = \frac{6 W \times {10}^{12}}{P \times 3.14 \times {D}^{3}}$$

where W is grams of polymer per ml, D is the diameter in microns and P is the density of polymer in grams/ml. Microspheres were suspended in borate-SDS buffer to a final density of 4.6×10⁵, 3.6×10⁶, and 5.7×10⁷ microspheres/ml for the 1.0, 0.5, and 0.2-μm diameter microspheres, respectively. The original density of the 6.0-μm diameter microspheres was 1.7×10⁷ microspheres/ml (0.2% solids). When required these microspheres were diluted in borate buffer.

CE-LIF instrument. The instrument used for this study has been previously described (e.g., Duffy et al., Anal. Chem., 73:1855-1861 (2001)). Briefly, the injection end of the capillary is placed in close proximity to a platinum electrode connected to the high voltage cable of a CZE1000R power supply (Spellman, Hauppauge, N.Y.). The detection end of the capillary is inside a quartz cuvette and makes electrical contact to ground through a sheath flow identical to the running buffer. The 488-nm line of an Argon-ion laser (532-BS-A04, Melles Griot, Irvine, Calif.) excites the microspheres as they leave the capillary. Fluorescence emission is spectrally selected with an interference filter transmitting in the range 522-552 nm (Omega Optical, Brattleboro, Vt.). An additional rejection band filter (488-53D, OD4, Omega Optical) is placed in front of the interference filter to reduce Rayleigh scattering. A photomultiplier tube (R1477, Hamamatsu, Japan) detects fluorescence and its output is measured through a 1 megaohm (MΩ) resistor connected in parallel with a 10 nanofarad (nF) capacitor. The analog signal is digitized at 50 cycles per second (Hz) with an PCI-MIO-16XE-50 I/O card run with LabVIEW (National Instruments, Austin, Tex.).

Microsphere injection. For single microsphere injections, the capillary injection end is held tight in a Plexiglas capillary holder previously described (e.g., Krylov et al., Anal. Chem., 72:872-877 (2000)). By micromanipulation of this holder with x, y, z translation stages (SOMA Scientific, Irvine, Calif.) the capillary is vertically positioned in the center of the field of view of an inverted microscope (Nikon Eclipse TE-300, Nikon, Melville, N.Y.) under 10× magnification. Once centered, the capillary is lowered into a 5 μL drop of microsphere suspension. Using the x-y translation of the microscope stage the microsphere is brought directly under the image of the capillary lumen. Then, the capillary end is gently lowered over the microsphere and by applying negative pressure (11.2 kilopascals (kPa)) for 1 second, the microsphere is drawn into the capillary. The capillary is then removed from the Plexiglas holder and placed in a vial containing the separation buffer. The separation is carried out as described herein.

For sampling of nanoliter volumes of microsphere suspensions, the injection end of the capillary was introduced into an Eppendorf vial containing the suspension. An electrokinetic injection at 100 V cm⁻¹ for 5 seconds was used for 6-μm diameter microspheres, while 200 V cm⁻¹ for 10 seconds was used for other microsphere sizes. The capillary length used for each experiment is reported in the Brief Description of the Figures.

Electrophoretic Separations. Separations were carried out either using 10 mM borate-SDS or 10 mM borate buffer as indicated. For the 6-μm diameter microspheres the separation was carried out at −400V/cm while −200V/cm was used for all other microsphere sizes. In order to prevent carry over in consecutive separations, the capillary was pressure flushed between runs with a syringe filled with running buffer.

Microspheres do not migrate out when using bare fused silica capillaries. Therefore we derivatized 50 μm inside diameter (i.d.), 150 μm outside diameter (o.d.) capillaries (Polymicro, Phoenix, Ariz.), with poly-acryloylaminopropanol (poly-AAP) as previously described (e.g., Gelfi et al., Electrophoresis, 19:1677-1682 (1998)). This polymeric coating reduces the interactions between microspheres and the capillary wall. The efficiency of the coating was evaluated by testing for electroosmotic flow according to Huang et al., Anal. Chem., 60:375-377 (1988). Capillaries with EOF higher 2×10⁻⁵ cm²V⁻¹s⁻¹ were discarded.

Data Analysis. Files are analyzed using Igor Pro (Wavemetrics, Lake Oswego, Oreg.). Using this software, an in-house written procedure, PickPeaks, is used to determine the migration time (t_{M}) and peak intensity for each detected microsphere (e.g., Duffy et al., Anal. Chem., 73:1855-1861 (2001)). From the migration time, the electrophoretic mobility (μ) is calculated according to the equation:

μ=L/E·t_{M} (7)

where L is the total capillary length and E is the electric field.

Results and Discussion

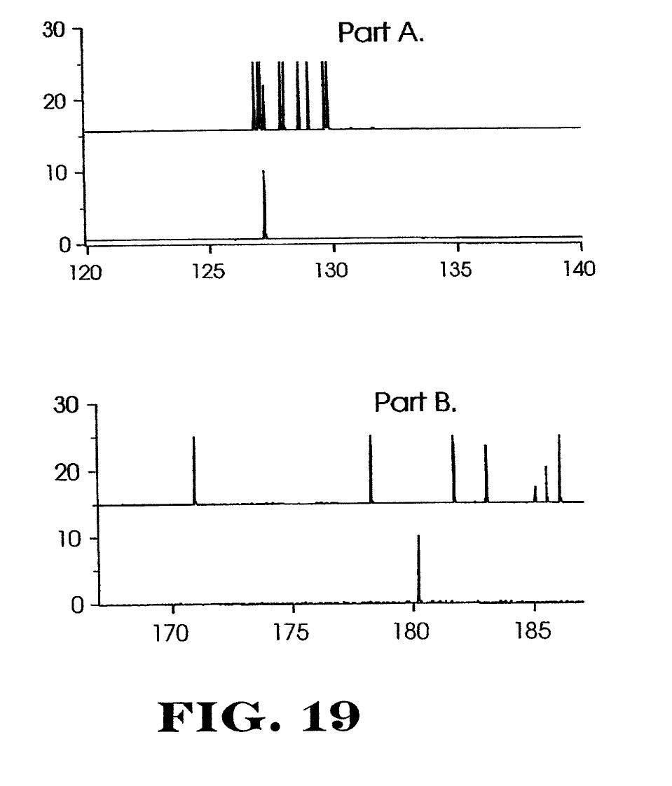

Electropherograms of individually detected microspheres. Multiple reports have clearly confirmed that polystyrene latex microspheres have an intrinsic electrophoretic mobility that makes them amenable to analysis by CE (e.g., Vanhoenacker et al., Electrophoresis, 22:2490-2494 (2001); Radko et al, Electrophoresis, 21:3583-3592 (2000)). This fact is confirmed in FIG. 19, that shows electropherograms of two buffer systems, borate-SDS and borate, resulting from sampling electrokinetically or by siphoning a few nanoliters of a microsphere suspension containing from one to ten microspheres. As opposed to the previously reported Gaussian-like profiles resulting from the detection of millions of microspheres (e.g., Vanhoenacker et al., Electrophoresis, 22:2490-2494 (2001); Radko et al, Electrophoresis, 21:3583-3592 (2000)), in this report each microsphere is detected individually. In the post-column LIF detector, which typically allows for the detection of less than 600 molecules (e.g., Duffy et al., Anal. Chem., 73:1855-1861 (2001)), an argon-ion laser focused about 50-μm away from the capillary tip excites each microsphere as it leaves the capillary and is washed away by a sheath flow. Detection of individual microspheres as small as 0.2-μm in diameter was possible because as described herein, the emitted fluorescence during the 80 -millisecond traveling time of the microsphere through the laser beam is collected with a high collection efficiency microscope objective (N.A. 0.6), spectrally and spatially filtered, and detected with a photomultiplier tube wired for fast response (e.g., Duffy et al., Anal. Chem., 73:1855-1861 (2001)).

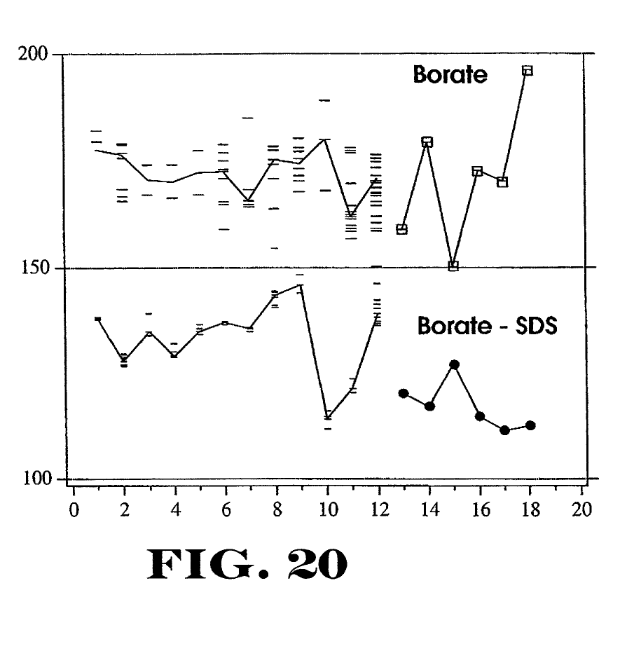

In FIGS. 19A and 19B, the top electropherograms are the result of electrokinetically sampling 7 to 24-nl volumes from 500 μl of a microsphere suspension contained in a vial. These electropherograms are characterized by several spikes associated with the detection of individual events. On the other hand, the bottom electropherograms resulted from successfully injecting a single microsphere. As expected, the electropherogram has only one spike with a migration time within the range defined by the multiple spikes in the top electropherograms (FIGS. 19 and 20). This observation confirms that in a CE experiment each detected microsphere will cause a spike with a characteristic migration time that then can be used to calculate an electrophoretic mobility value.

FIGS. 19A and 19B also show that the migration time ranges defined by the detection of individual events are different for borate-SDS (FIG. 19A) and borate running buffer (FIG. 19B). When SDS is present the detected microspheres have an overall faster migration time than when SDS is absent from the running buffer. This is not surprising since adsorption of SDS to microspheres, increases the abundance of negative charges on the microsphere surface and makes its electrophoretic mobility more negative (e.g., Hiatshwayo et al., Polym. Mater. Sci. Engineer., 75:55-56 (1996)). A surprising finding when comparing both buffer systems was the narrower migration time range for microspheres in borate-SDS than in borate buffer. Two possible explanations are: (i) When SDS interacts with the microsphere surface, it may be masking dissimilarities among microspheres making their electrophoretic mobility mainly determined by the adsorbed SDS; (ii) there may be some interaction between the microspheres and the capillary walls which lead to a wider migration time range; SDS may be preventing these interactions. Further work is required to elucidate the effect of SDS on the migration time range.

Detection of spikes caused by other than microspheres may affect the interpretation of the data. In particular, during data analysis the PickPeaks routine described herein is unable to distinguish false events. Therefore, it was necessary to determine the frequency of false positives and an effective strategy to eliminate them in the calculations described below. By setting up the detector to its highest gain (1000 V photomultiplier tube bias), the 6-μm diameter microspheres in FIG. 19 displayed maximum detector response, 10 V. On the other hand less intense events, such as the events at 185.5 and 185.6 seconds in the upper trace of FIG. 19B, had to be attributed to photobleached or fragmented microspheres sometimes observed under a bright field microscope. These events were also absent in blank electropherograms consisting of injections of the sample buffer. In addition, there was a second class of events characterized by peak heights lower than 0.1 V. These events appear over the entire electropherogram and in the blank electropherograms suggesting that they are the result of scattering caused by other particles such as bubbles in the running buffer. Thus, for a given microsphere size, we chose to arbitrarily ignore all those events which had signals smaller than 10% the average intensity of the all the detected microspheres. In random occasions spikes would appear outside the expected migration time range (not shown). These stray events seem to be the result of unwanted carry over likely related to microspheres sticking to the outside of the end of the capillary or the platinum high voltage electrode. These events were easily distinguished from events falling in the migration time range and were not included in the calculations of electrophoretic mobilities.

Sampling error was also investigated. For each buffer system the number of 6.0-μm diameter microspheres was counted in 12 consecutive electrokinetic injections. The number of detected events per sampling were 5.6±2.7 and 8.4±3.1 (average±standard deviation) for borate buffer-SDS and borate buffer systems, respectively. These variations in the numbers of microspheres are consistent with a Poisson distribution that would predict standard deviations of 2.3 and 2.9, respectively.

Table 5 shows a similar comparison for the other microsphere sizes. The observed number of events after sampling of 1-μm diameter microspheres is fairly consistent with the predicted value based on the initial density of the microsphere suspension. Also, the variation in the number of observed events is in good agreement with the predictions of a Poisson distribution. On the other hand, sampling of 0.5 and 0.2-μm diameter microspheres shows large discrepancy between the predicted and observed values. This discrepancy is under present investigation.

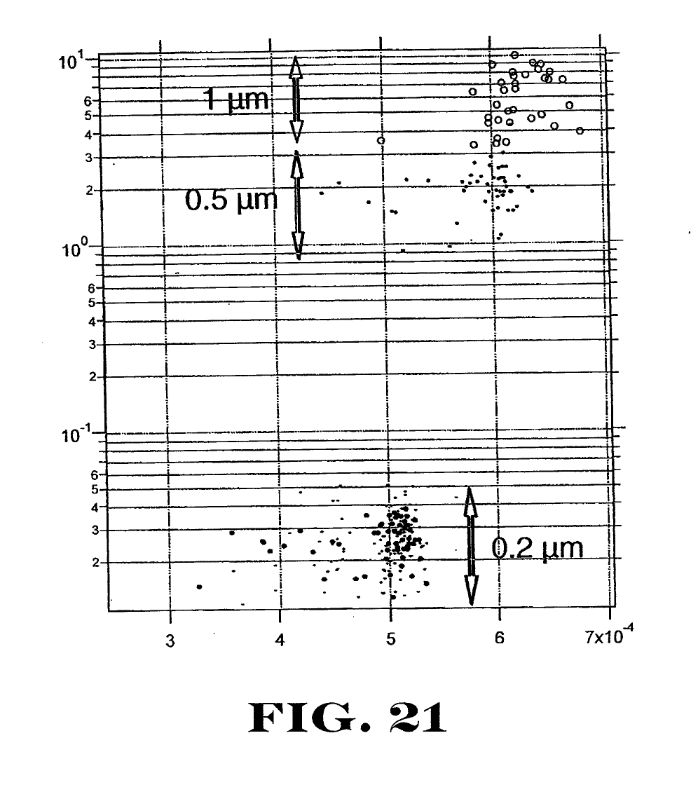

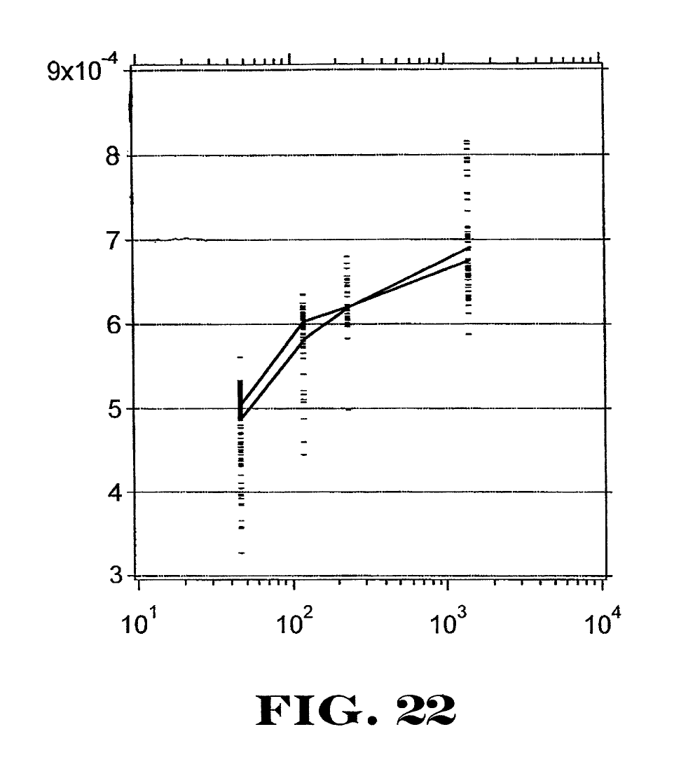

TABLE 5
Microsphere electrophoretic mobility. Data correspond to those
plotted in Figures 21 and 22.

| | | - Electrophoretic Mobility × 10⁴ | | |
|---|---|---|---|---|
| | Number of events^{a} | (cm² · V¹ · s⁻¹) | | |
| | Range, n | Within | Pooled^{d} | |
| Diameter | Average (Predicted) | analysis^{c} | Median | |
| (μm) | Std. Dev. (Predicted) | (RSD) | (Average) | Skewness^{e} |
| 6 | 2-10, 12 | 6.21-7.97 | 6.8 (6.9) | 0.72 |
| | 5.6 (−)^{b} | (0.2-3.2) | | |
| | 2.7 (2.3) | | | |
| 1 | 7-11, 4 | 6.17-6.28 | 6.2 (6.2) | −1.2 |
| | 8.5 (10) | (2.7-7.9) | | |
| | 2.4 (2.9) | | | |
| 0.5 | 9-30, 3 | 5.82-5.91 | 6.0 (5.9) | −1.7 |
| | 17 (72) | (2.8-8.3) | | |
| | 11 (4.1) | | | |
| 0.2 | 41-71, 3 | 4.87-4.98 | 5.0 (4.9) | −1.7 |
| | 56 (1200) | (5.8-9.5) | | |
| | 15 (7.5) | | | |

^{a}The ‘range’ indicates the minimum and maximum number of events detected in ‘n’ electropherograms. ‘Average (Predicted)’ is the determined and predicted value based on the original density of microspheres in suspension and the sampled volume. ‘Std. Dev. (Predicted)’ is the calculated standard deviation and the predicted variation according to a Poisson distribution.
^{b}Initial microsphere density was not known.
^{c}The listed values represent the minimum and maximum average in the set of electropherograms. Similarly, the relative standard deviation (RSD) for all detected events in a given electropherogram varied in the range given in brackets.
^{d}The detected events in all the electropherograms were pooled together and the overall median and average were calculated.
^{e}Skewness was calculated according to the statistical package in Igor Pro.

Migration time range reproducibility was studied in 12 consecutive electrokinetic injections for each buffer system (FIG. 20). In addition, 6 single-microsphere injections followed the electrokinetic injections and confirmed that the migration time for single injections showed a similar reproducibility trend. As discussed above, the median migration time is longer for microspheres in borate buffer (upper trace) than for microspheres in borate-SDS buffer. Furthermore the two buffer systems have non-overlapping migration time ranges in 24 electrokinetic injections. The median migration time was chosen in FIG. 20 to compare successive sampling. The average migration time was not chosen as it was noticed that its distribution tended to be asymmetric. Both buffer systems displayed large variations in median migration time while the width of the migration time range was typically consistent from run to run (FIG. 21). We do not have a convincing hypothesis to explain these variations at the present time, however one potential cause is the temperature variations in the non-thermostated capillary. Small local changes in temperature may result in buffer viscosity changes, which previously have been shown to affect separations (e.g., Voss et al., Anal. Chem., 73:1345-1349 (2001)).

Two dimensional representations. Sampling of collections of microspheres of different sizes produce electropherograms similar to those shown in the upper trace of FIG. 19A. Using Equation 7, the migration time of a detected event is used to calculate its electrophoretic mobility. In FIG. 21 each event is shown as a point characterized by coordinates of fluorescence intensity and electrophoretic mobility. Even when the data from several electropherograms have been combined, this figure shows well-defined coordinate regions for a given microsphere size. It is also observed that for the commercial microspheres used in these studies (Polysciences), the fluorescence intensity conveniently increases with microsphere size making it a convenient approach to indirectly identify the size of the microsphere that originated the detected event. Thus, even when there is an overlap in electrophoretic mobility, as shown in FIG. 20 for the 1-μm and 500-nm diameter microspheres, the ability to measure a second property facilitates identification of the microsphere size. Similar two dimensional representations could become a powerful resource to identify microspheres or other particles of similar dimensions that cannot be distinguished solely by measuring only one property as it is in the case of typical electropherograms displaying Gaussian-like profiles.

Further refinement in the use of two dimensional representations for identification purposes may be possible by improving the detector design used in these studies. The relative standard deviation (RSD) for any microsphere size is around 30% (Table 6). Photobleaching may contribute to high RSD's. However, the reason for high RSD's seems to stem from the inhomogeneous excitation of microspheres as they seem to follow different trajectories through the laser beam used for excitation in the LIF detector. Improvements to the detection configuration that will may reduce intensity RSD include the use of narrower capillary bores to better define microsphere trajectories and better regulation of the sheath flow which affects the residence time in the excitation laser beam (e.g., Cheng et al., Anal. Chem., 63:496-503 (1990)).

TABLE 6
Microsphere fluorescence intensity. Data correspond to those plotted
in Figure 21.

| | Intensity (V) | |
|---|---|---|
| Diameter | | |
| (μm) | Average in each analysis (RSD)^{a} | Pooled Average |
| 1.0 | 6.5 (35), 5.2 (34), 6.8 (25), 5.8 (30) | 6.1 |
| 0.5 | 2.1 (38), 2.2 (21), 1.9 (26) | 2.1 |
| 0.2 | 0.026 (34), 0.027 (34), 0.026 (24) | 0.026 |

^{a}RSD = Relative Standard Deviation

On the other hand, we do not expect that two dimensional representations could be dramatically improved by controlling the electrophoretic mobility dispersion as this spread seems to be a natural attribute of the microsphere population. For example, a comparison of RSD's in electrophoretic mobility determined in the various electropherograms presented here (less than 10%, Table 5) and those derived from Gaussian-like profiles reported in the literature (7.5%) (e.g., Peterson et al., Anal. Chem., 64:1676-1681 (1992)) shows similar mobility dispersion. This topic will be revisited in Section 3.4.

Electrophoretic mobility is a function of microsphere size. In order to facilitate a comparison with the results presented here and with other reports, FIG. 22 shows a plot of electrophoretic mobility versus κR, the product of the Debye factor and the microsphere radius. The average and median mobility values increase with microsphere radius since κ is constant (κ=0.47 nm⁻¹) for the borate-SDS buffer. Mobility differences when κR>100, as observed for the three larger particles sizes used in this study, can be explained if the relaxation effect is taken into account (e.g., Radko et al., J. of Chromatogr., B722: 1-10 (1999); Vanhoenacker et al., Electrophoresis, 22:2490-2494 (2001)). Furthermore, the similarity between the data in FIG. 22 and reports by others strongly suggest the participation of the relaxation effect in this system (e.g., Radko et al., Electrophoresis, 21:3583-3592 (2000)) and that further improvement in the separation could be obtained by modifying the ionic strength of the buffer or by altering the zeta (ζ) potential through alterations of pH or buffer additives.

Origin of electrophoretic mobility dispersion. The electrophoretic mobility dispersion defined by individual electrophoretic mobility measurements may be explained in terms of the various contributions to broadening as described by an equation that assumes that (i) the line of flow of a given microsphere is not perturbed by other microspheres in its vicinity; and that (ii) the electrostatic repulsion or other interactions among microspheres is negligible. By using a low density number of microspheres in the same sample the possible participation of these extra contributions to broadening is reduced.

Furthermore, electrophoretic mobility dispersion does not seem to be affected by other common instrumental sources of broadening which include: injection and detection volume, axial diffusion, thermal gradients in the capillary, conductivity differences between sample and running buffer, and interactions between the capillary walls and the microspheres. These sources of broadening are discussed below.

The injection contribution to broadening is σᵢₙⱼ=1²/12, where 1 is the apparent injected plug length as determined from the electrokinetic injection (e.g., Oda et al., Handbook of Capillary Electrophoresis, 2^{nd} Ed., (CRC Press, Boca Raton, Fla., 1997)). Considering that the largest injection consisted of 3.5% of the total capillary volume (1-μm diameter microspheres), the predicted contribution is less than 1%. Therefore, the length of the apparent injected plug cannot account for the observed broadening. Similarly, the length of the detection window is fixed to 80-milliseconds. Therefore the expected RSD would be only 0.02%.

The Joule heating generated in 50 μm inside diameter capillaries when using borate and borate-SDS buffers has a linear current versus voltage response in the 0 to 400 V/cm suggesting that thermal effects are not likely to be an important source of broadening. Difference in conductivity between the sample and the running buffer can be ruled out because even at the highest density number of microsphere suspensions (5.7×10⁷ microspheres/ml) the highest volume fraction of microspheres to buffer is only 6×10⁻⁶. A sample buffer containing such a low microsphere density number is not expected to affect the conductivity of the sample.

Since poly-AAP coated capillaries have been used successfully in the analysis of proteins, which are smaller than microspheres and may access more readily uncoated regions in a capillary, it is expected that interactions between microspheres and uncoated regions are going to be less probable. Other interactions with the capillary walls such as collisions or roll against the walls may result in flow disturbance and in alterations of observed mobilities (e.g., Hunter, Foundations in Colloid Science, 2^{nd} Ed., (Oxford Univ. Press, 2001)). A Theological model similar to the descriptions provided in other colloidal systems may prove to be advantageous to explain this difference in electrophoretic dispersion.

If all the instrumental sources of broadening do not play a major role in the observed microsphere electrophoretic dispersion, it is likely the variations in electrophoretic mobility result from heterogeneity in size or surface charge composition. Others have reached the same conclusion based on measurements done in Gaussian-like profiles (e.g., Peterson et al., Anal. Chem., 64:1676-1681 (1992); Radko et al., J. of Chromatogr., B761:69-75 (2001)). A comparison of electrophoretic mobility RSD's (Table 6) with size RSD's reported by the manufacturer (i.e., 3% for the 0.2-μm diameter microspheres) suggests that size could be an important contributor to the observed dispersion. Similarly, the reduction in mobility dispersion observed in the SDS-borate buffer system (FIGS. 19 and 20), suggests that there is surface heterogeneity that is partially masked by an excess of negative charges from SDS adsorbed to the microsphere surface.

Concluding Remarks

CE-LIF made possible the determination of the electrophoretic mobility and fluorescence intensity in individual microspheres of different diameters. A two-dimensional representation of these properties could provide identification of a microsphere type in a mixture of them even when one of the measured properties have overlapping ranges. Using this approach, studies on heterogeneity, surface interactions, ionic strength, zeta (ζ) potential, size, and double layer thickness may be easily implemented. These studies could provide additional detail to the phenomenological description based on the determination of Gaussian-like profiles. Finally, the strategy presented here can be easily extended to study the fundamentals of so far descriptive electrophoretic separations of organelles (e.g., Duffy et al., Anal. Chem., 74:171-176 (2002)), liposomes (e.g., Duffy et al., Anal. Chem., 73:1855-1861 (2001)), viruses, and bacteria (e.g., Kenndler et al., Trends in Anal. Chem., 20:543-551 (2001); Armstrong et al., Anal. Chem., 73:4551-4557 (2001)).

### Example 6

### Electrophoretic Behavior of Individual Nuclear Species

Materials and Methods

Chemicals. Tris[hydroxymethyl]aminomethane (Tris), N-[2-hydroxyethyl]piperazine-N-ethanesulphonic acid] (HEPES), phosphate buffered saline (PBS), Dulbecco's Modified Eagle's Medium and calf serum were purchased from Sigma (St. Louis, Mo.). Magnesium chloride and sucrose were purchased from Fisher (Fair Lawn, N.J.). Fluorescein; a stain available under the trade designation SYTO-11; and hexidium iodide were purchased from Molecular Probes (Eugene, Oreg.).

Cell culture. NS-1 mouse hybridoma cells were cultured at 37° C. and 5% CO₂ by splitting cells 1:4 every 2 days in Dulbecco's Modified Eagle's Medium supplemented with 10% calf serum.

Nuclear Isolation. The protocol used to isolate nuclei was similar to that described in Graham, Subcellular Fractionation: A Practical Approach, pp. 1-105 (IRL Press, Oxford, UK, 1996). The cells were washed once with PBS and then washed twice with buffer A (250 mM sucrose, 5 mM magnesium chloride, 10 mM Tris, pH 7.4). The cells were next suspended in buffer A and homogenized using 2 homogenization methods sequentially. The first homogenization was performed using a N₂ cavitator (Model 4639, Parr Instrument Company, Moline, Ill.). The cells were introduced to a stainless steel, high pressure chamber, which was filled with N₂ at 150 pounds per square inch (psi). After 10 minutes, the cells were disrupted by forcing them through a narrow opening. Homogenization was monitored by observation under a microscope. The methylene blue exclusion test was used to confirm that cells were disrupted. The homogenate was then centrifuged (Beckman J2-2D centrifuge, 2500 rpm, 600×g) twice for 10 minutes to isolate the nuclear pellet, which was then resuspended in buffer B (2.2 M sucrose, 1 mM magnesium chloride, 10 mM Tris, pH 7.4). To remove membrane contaminants associated with nuclei, such as remnants of the endoplasmic reticulum, the sample was further homogenized using 8 strokes of a Potter-Elvehjem homogenizer with a clearance of 0.004-0.006 inch and a volume of 5 mL (LG-10650-100, Lab Glass, Vineland, N.J.). The final homogenate was resuspended in buffer B and centrifuged for 80 minutes at 5° C. (Beckman L7 ultracentrifuge, 80,000×g). The final nuclear pellet was resuspended in buffer B, and an aliquot of this suspension was used for immediate CE-LIF analysis.

Capillary Electrophoresis with Laser-Induced Fluorescence of Nuclear Isolates. Uncoated, 50 μm inside diameter fused silica capillaries (Polymicro Technologies, Phoenix, Ariz.) were used for the separation of nuclei. The capillary lengths used are listed in the Brief Description of the Figures. The in-house built instrument used to perform CE-LIF analysis of organelles and liposomes has been described previously (e.g., Duffy et al., Anal. Chem., 73:1855-1861 (2001)). The optical detection system was optimized using a 10⁻⁹ M solution of fluorescein (Molecular Probes, Eugene, Oreg.). Briefly, during a continuous flow of fluorescein through the capillary, the position of the sheath-flow cuvette housing the capillary is adjusted until the signal from fluorescein is maximized.

The final nuclear isolate was mixed with an equal volume of 1.0 μM hexidium iodide and kept at room temperature for at least 15 minutes. Hexidium iodide is a dye that fluoresces maximally at 600 nm when intercalated into DNA. An aliquot of the stained nuclear isolate (about 5 nL) was injected into the capillary at 400 V/cm. Following injection, a vial containing the running buffer C (250 mM Sucrose, 10 mM HEPES, pH 7.4) replaced the sample vial, and electromigration proceeded at 400 V/cm for at least 30 minutes.

Species that were labeled by hexidium iodide (e.g. intact and disrupted nuclei) were detected as they migrated out of the capillary by excitation with a 488 nm Ar-ion laser line (20 mW; model 532-BS-A04, Melles Griot, Carlsbad, Calif.). A long pass filter (505 AELP, Omega Optical Inc., Brattleboro, Vt.) was used to reduce scattering before the fluorescence is detected by the PMT. Fluorescence in the range 608-662 nm was selected with a band-pass filter (635DF55, Omega Optical Inc.) and detected by an R1471 (Hamamatsu, Bridgewater, N.J.) photomultiplier tube. The output of the photomultiplier tube was digitized at 50 cycles per second (Hz) using a NiDaq I/O board (PCI-MIO-16XE-50, National Instruments, Austin, Tex.) and the data were saved as a binary file (e.g., Duffy et al., Anal. Chem., 73:1855-1861 (2001)). At the end of each separation, the capillary was reconditioned by pressure flushing using buffer C contained within a syringe fitted to the capillary through an adapter (Valco Instruments Co., Inc., Houston, Tex.).

The detector contribution to the signal variation of individual events was determined using 6 μm fluorescent beads. They were electrokinetically injected into and separated in the capillary, and the fluorescent signal of each was detected individually. Then the distribution of signal intensities was determined as described in 2.6. The relative standard deviation of the individual signals was determined to be 30% RSD for our detection system.

Hydrodynamic Injections of Nuclei. In these experiments the nuclei were injected by hydrodynamic pressure (11 kPa) using an injector used for single cell analyses (e.g., Krylov et al., Anal. Chem., 72:872-877 (2000)). Nuclei being injected were observed by microscopy. The nuclear isolate was diluted in buffer C such that the number of nuclei injected was observed to be between 1 and 5. Once injected the nuclei were subjected to electrophoresis at 200 V/cm and detected as described herein.

Data Analysis. The procedures for data analysis have been described previously (e.g., Duffy et al., Anal. Chem., 73:1855-1861 (2001)). Briefly, an Igor-Pro (Wavemetrics Lake Oswego, Oreg.) algorithm is used for median filtering of the raw electropherogram to eliminate any events narrower than 9-data points. Subtraction of this filtered electropherogram from the raw data yields the signal trace that contains exclusively the narrow events. The latter electropherogram is then processed by a second routine (PickPeaks) to select and tabulate those events that have a signal-to-noise ratio larger than five times the standard deviation of the background (e.g., Duffy et al., Anal. Chem., 73:1855-1861 (2001)). For each event, PickPeaks determines the migration time and the signal intensity. From the migration time (t_{M}), the capillary length (L), and the separation voltage (V), the total electrophoretic mobility (μ_{T}) is calculated as:

μ_{T}=L²/(V·t_{M})

Determination of Electroosmotic Flow (EOF) and Net Mobility. In bare fused-silica capillaries the total mobility has contributions from the intrinsic electrophoretic mobility of the analyte (μₑ) and the electroosmotic flow (μ_{EOF}) (Landers et al., Handbook of Capillary Electrophoresis, pp. 1-42 (CRC Press, Boca Raton, Fla., 1997):

μ_{T}=μₑ+μ_{EOF} (8)

The contribution to mobility by the electroosmotic flow can be estimated by measuring the time (Δt) it takes to replace the full capillary volume with a new buffer that has 80% of the concentration of the running buffer C (200 mM Sucrose, 8 mM HEPES, pH 7.4) (Huang et al., Anal. Chem., 60:1837-1838 (1988)). This method of determining EOF is useful with laser-induced fluorescence detection and does not require the use fluorescent EOF markers. In this method, first the run buffer C is continuously injected electrokinetically and the resultant current is monitored until it is stable. Then the new buffer (80% concentration of run buffer C) is continuously injected electrokinetically. At the introduction of the new buffer, the current drops due to the decrease in electrolyte content and stabilizes once the whole capillary is filled with the new buffer. The time it takes for the current to drop to the lower plateau is estimated to be Δt. The electroosmotic flow is then calculated using the following equation:

μ_{EOF}=L²/(V·(Δt))

Typical values ranged from 4.0 to 6.0×10⁻⁴ cm²/V·s. The time range corresponding to these values is 155 to 232 seconds.

Using the μ_{EOF} and equation 8, the electrophoretic mobiltiy (μₑ) was calculated for each narrow peak identified by the PickPeaks program. Then an electrophoretic mobility histogram was constructed per run. Three such histograms, corresponding to three separate injections of the same sample, were averaged to get the final electrophoretic mobility distribution.

Determination of Injected Volume. The volume injected (Volᵢₙⱼ) during an electrokinetic injection of nuclei was calculated as follows:

Volᵢₙⱼ=Vol_{cap}*Eᵢₙⱼ/Eₛₑₚ*tᵢₙⱼ/t_{M} (4)

Where Vol_{cap} is the capillary volume, Eᵢₙⱼ and Eₛₑₚ, are the injection and separation electric fields, respectively, tᵢₙⱼ is the injection time, and t_{M} is the average migration time for the narrow events identified from the PickPeaks procedure. The values ranged from 4.6 to 6.0 nL.

Determination of Number of Detected Events per Cell. It is possible to determine the number of detected events per cell using the number of events per run, the initial cell density, dilution factors and the sample volume injected. The average number of events/cell was 115±66 (n=3).

Confocal Microscopy. To monitor the quality of the nuclear preparation at each step of the isolation protocol, we sampled the preparation of (a) whole cells, (b) homogenate, (c) nuclei after the first round of centrifugation, and (d) nuclei after the final centrifugation step. These samples (250 μL) were incubated at room temperature with 250 μL of 1 μM of a stain available under the trade designation SYTO-11 from Molecular Probes (Eugene, Oreg.), for 1-1.5 hours, and analyzed by confocal microscopy (MultiProbe 2000 confocal scanning laser system, Molecular Dynamics, Piscataway, N.J.). The stain available under the trade designation SYTO-11 is a DNA intercalating dye, which fluoresces maximally at 527 nm when intercalated into DNA. A band-pass filter (508-562 nm, 535DF55, Omega Optical Inc.) was used to detect the fluorescence.

Results and Discussion

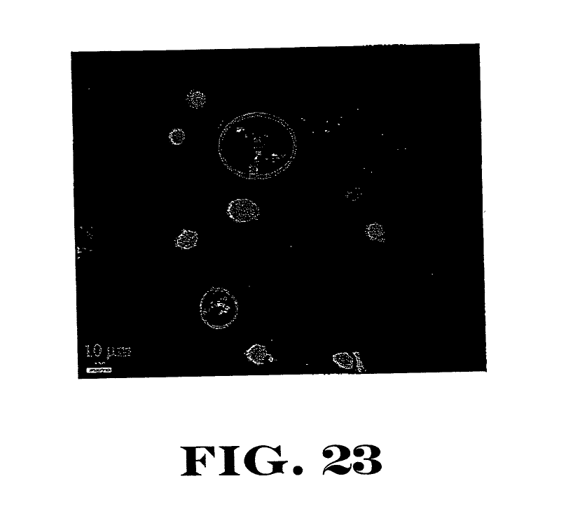

Confocal microscopy was used to visualize nuclei in a purified nuclear preparation, following staining with a stain available under the trade designation SYTO-11 from Molecular Probes (Eugene, Oreg.) (e.g., Wu et al., Gene Dev., 14:536-548 (2000)). A typical confocal image of isolated nuclei is shown in FIG. 23. Nuclei appear as round species, while the nebulous species (circled) are likely to be DNA-containing fragments resulting from disrupted nuclei. The latter likely result from the homogenization process. The various morphological manifestations of nucleic acid-containing particles in this preparation would be expected to contribute to the heterogeneity of nuclear electrophoretic mobility and fluorescence intensity, as discussed in detail later.

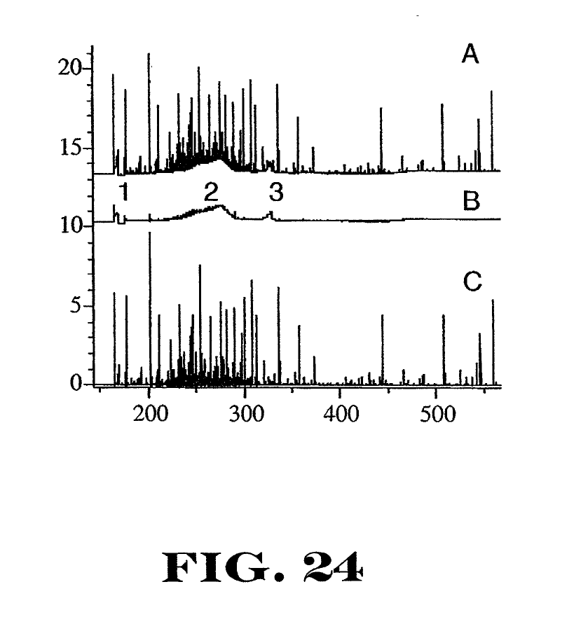

In our CE system, we expect to detect all the fluorescent species observed under fluorescence microscopy (FIG. 23). Furthermore, due to the very high sensitivity of the LIF detection, our CE system is capable of detecting species and contaminants that would normally escape detection by microscopy (Shaole et al., J. Chromatogr., 480:141-155 (1985)). As seen in FIG. 24A, an electropherogram resulting from the injection of a few nanoliters of a nuclear preparation stained with hexidium iodide shows multiple events in a defined migration time window. This electropherogram has two event types: i) broad peaks (labeled 1, 2 and 3) and (ii) narrow peaks having a base width around 180 milliseconds. Whether these events are caused by contaminants, fragmented nuclei, or intact nuclei is discussed below.

To visualize the broad peaks more clearly, a digital filter was used to eliminate the narrow peaks (FIG. 24B). Using control experiments we established that peak 1 (6 seconds wide) and peak 3 (17 seconds wide) were caused by components in the cell culturing media. In one set of experiments, pure cell culture medium was injected and detected under the same conditions used in the analysis of nuclear fractions. As expected for a highly concentrated sample, the medium yielded a broad profile overlapping peaks 1 and 3 in FIG. 24B. These peaks were also detected upon injection of the final supernatant of the nuclear isolation procedure, indicating that some medium components remain even after thorough washing. The observation if these broad peaks is not surprising as cell culture medium is a complex mixture of serum components, vitamins such as riboflavin, and indicators such as phenol-red (e.g., Aubin, J. Histochein. Cytochem., 27:36 (1979); Niswender et al., J. Microsc., 180: 109 (1995)) that may fluoresce, as previously reported in CE-LIF analysis of samples derived from cell cultures (Malek et al., Anal. Biochem., 268:262-269 (1999)).

Another broad event, peak 2 (85 seconds wide), appears to be free DNA intercalated with hexidium iodide. Analysis of hexidium iodide alone did not yield any significant peaks. However, analysis of the supernatant, which was separated by centrifugation from the nuclear fraction that had been stained with this intercalating dye, resulted in an electropherogram with a broad peak that overlapped with peak 2. Since free DNA is unlikely to settle in the centrifugation process, this result suggests that peak 2 is likely to be caused by freely diffusing nucleic acids. For the analysis of narrow events, electropherogram 2B was subtracted from 2A and the resultant electropherogram (FIG. 24C) shows exclusively the narrow peaks. To confirm the nuclear origin of these peaks, preparations not treated with the intercalating dye were used as controls (data not shown). The number of detected events was less than 0.3% of the number of events detected in typical stained preparations (approximately 1000 events). Furthermore, the peaks observed in this control experiment are almost exclusively low intensity events, unlike those shown in FIG. 24A. Thus, based on the selectivity of hexidium iodide for nucleic acids, each peak is likely to indicate an intact nucleus or a large membrane-bound DNA fragment (e.g. circled fragments in FIG. 23).

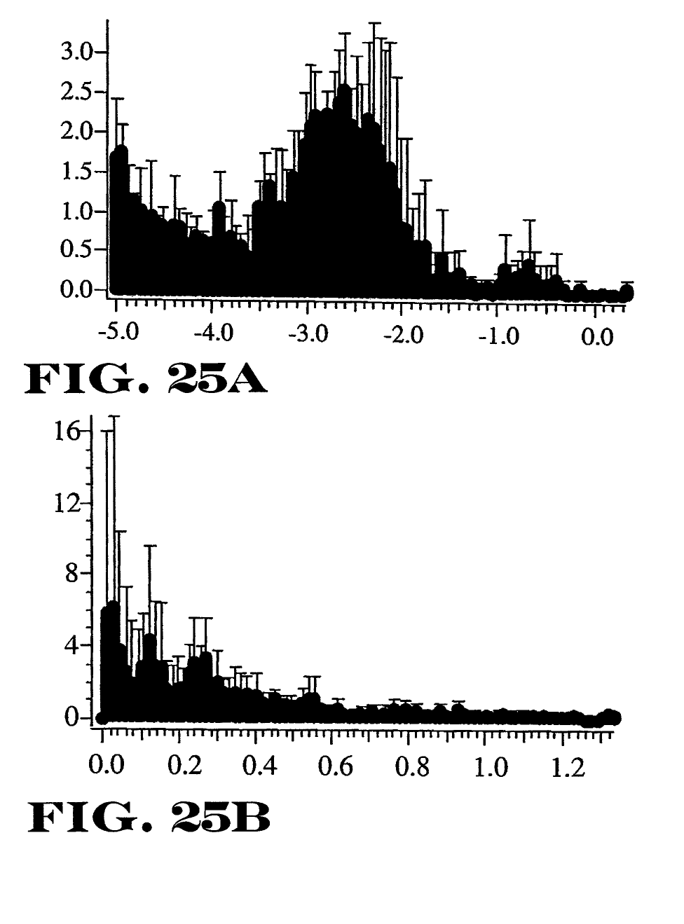

Electrophoretic Mobility. FIG. 25A shows the average electrophoretic mobility distribution of narrow events resulting from the electropherogram of a hexidium-iodide stained nuclear preparation. The overall shape of the distribution was observed to be reproducible in at least 12 independent experiments. The majority of the events (57±6%) are in the −1.5 to −3.5×10⁻⁴ cm²/V·s mobility range.

Since both intact and fragmented nuclei contribute to this distribution, we conducted a separate set of experiments to determine the electrophoretic mobility range of exclusively intact nuclei. In these experiments, a few nuclei (1 to 5, confirmed to be intact by microscopy) were injected into the capillary using hydrodynamic pressure. These nuclei were then separated electrophoretically and the migration time of the detected events was determined as described earlier. The mobility of these hydrodynamically injected intact nuclei fell mainly in the −1.5 to −3.5×10⁻⁴ cm²/V·s range (average: −3.1×10⁻⁴ cm²/V·s, n=6, data not shown). Previously the mobility range observed for rat brain nuclei was 1.00 to −1.13×10⁻⁴ cm²/V·s (Badr et al., Int. J. Neurosci., 6:117-139 (1973)). Differences in the two electrophoretic mobility ranges may be attributed to differences in the charge on the nuclear membrane, nuclear dimensions, buffer pH, and ionic strength. The experimentally determined number of events per cell, 115 events/cell, is significantly higher than the value expected based on one nucleus per cell. Therefore, it must be stressed that the events detected in the −1.5 to −3.5×10⁻⁴ cm²/V·s range do not correspond exclusively to intact nuclei. Furthermore, events that fall outside this range likely correspond to fragments that bear a different electrical charge resulting from morphological changes or drastic changes in the content of nucleo-proteins, phospholipoproteins and DNA (Badr et al., Int. J. Neurosci., 6:131-139 (1973)). Additionally, we cannnot rule out the possibility that the mobility of the detected events is altered by interactions with the walls of the fused-silica capillary used in these experiments (e.g., Verzola et al., J. Chromatogr., A874:293-303 (2000)).

Fluorescence Intensity. FIG. 25B shows the average signal intensity distribution obtained from the narrow events in the same electropherograms referred to in FIG. 25A. Although the detector contributes to the observed variation in signal intensity (approximate RSD 30%), the main cause of appears to be the presence of fragmented nuclei in the preparation, as observed in FIG. 23. We expect intact nuclei to have higher signal intensities than nuclear fragments. Based on the number of detected events/cell (115/cell), intact nuclei may correspond to those events in the highest 1% of the overall signal intensity range. The average electrophoretic mobility for these events was determined to be −3.1×10⁻⁴ cm²/V·s (n=10), which is the same as that observed for the few nuclei injected by siphoning.

Number of Detected Events. The CE-LIF system used here was capable of analyzing a large number of events per run (1003, n=3) in a relatively short time (30 minutes). The error associated with the number of events detected per run in our experiments varied from 27 to 87% RSD in different nuclear preparations. This variation is surprisingly larger than expected from a Poisson distribution (approximately 3%), which predicts that the error in random sampling should be equal to the square root of the number of measured events. One reason for the variation in the number of events detected in replicates of the same preparation may be rapid and unequal settling of the components in the suspension even when vortexed immediately prior to an analysis. Using the number of events per run, the number of events detected per cell was determined to be 115±66 (n=3).

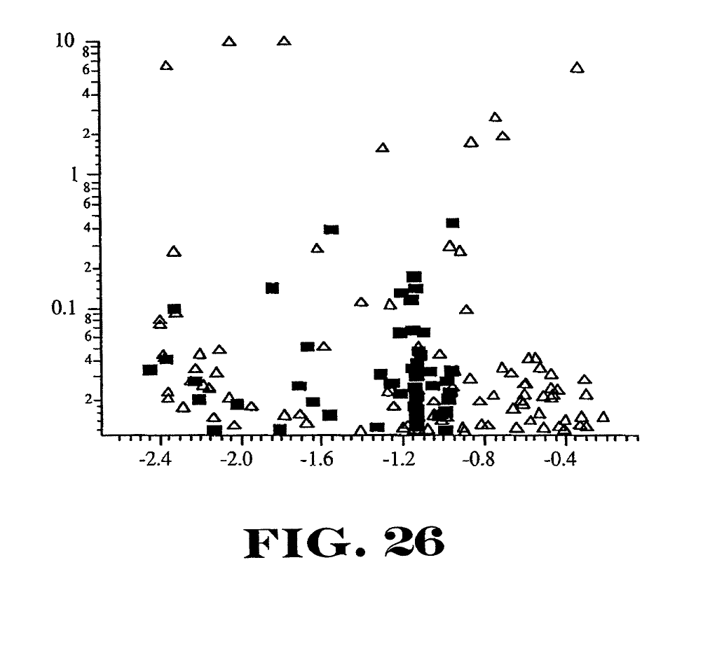

Presence of Mitochondria. Mitochondria are the major organelle contaminant in a nuclear preparation. Since mitochondria contain DNA, sufficiently large mitochondrial aggregates may lead to false positives in nuclear studies. The possibility of mitochondrial contamination in the final nuclear fraction was investigated by staining of the nuclear fraction with MitoTracker Green, which selectively stains proteins in mitochondria (e.g., Keij et al., Cytometry, 39:203-210 (2000)). In FIG. 26 aliquots of the same nuclear preparation were treated with MitoTracker Green (triangles) and the DNA-intercalating dye hexidium iodide (squares). After analyzing these samples separately, the fluorescence intensity of the individual events were plotted against electrophoretic mobility for each sample. Although intensities cannot be compared because the experiments were done under different detection conditions, the presence of mitochondrial contamination is evident (FIG. 26, triangles). On the other hand, mitochondria have a genome that is one million times smaller than the nuclear genome, making it unlikely that mitochondria exposed to hexidium iodide could contribute to false positives in FIG. 24 or 25. Although large aggregates of multiple mitochondria adhered to the nuclear surface may contribute to low intensity events such aggregation was not evident by confocal microscopy of DNA-stained NS-1 cells. CONCLUDING REMARKS

Using CE-LIF we have determined the electrophoretic mobility and the fluorescence intensity of individual species present in nuclear preparations stained with a DNA intercalating dye. The mobility distributions of these nuclear events show a heterogeneous population with mobilities within 0 to −5×10⁻⁴ cm²/V·s range, with intact nuclei producing events falling between −1.5 and −3.5×10⁻⁴ cm²/V·s. Although the presence of mitochondria in the nuclear preparations is evident, based on the relative nuclei acid content of this organelle, this contaminant it does not seem to pose a problem in the identification of nuclear events. However, the excellent detection capabilities of CE-LIF method facilitated detection of fragmented DNA-containing species not evident in confocal microscopy imaging. The CE-LIF method reported here may be used to conduct quality analyses of nuclear preparations when high purity of the nuclear fraction is vital.

### Example 7

### Capillary Electrophotic Separation of Particles Using a Gel

An experiment was run attempting to demonstrate the separation of particles on a gel-containing column (e.g., agarose) by filling a capillary with an agarose-containing fluid, electokinetically injecting stained nuclei, and then running an electophoretic separation. The following conditions were used: uncoated 50 micron inside diameter capillary; fluid was 0.01% by weight agarose, 250 mM sucrose, and 10 mM HEPES, pH 7.4; sheath flow fluid was the same as the above fluid, except that the agarose was 0.005% by weight; injection 400 V/cm for 5 seconds; separation 400 V/cm; sampling rate 50 cycles per second; PMT bias 1000 V. The nuclei were isolated in nuclear paper stained with hexidium iodide, 1 micromolar, 1:1, for 30 minutes at room temperature.

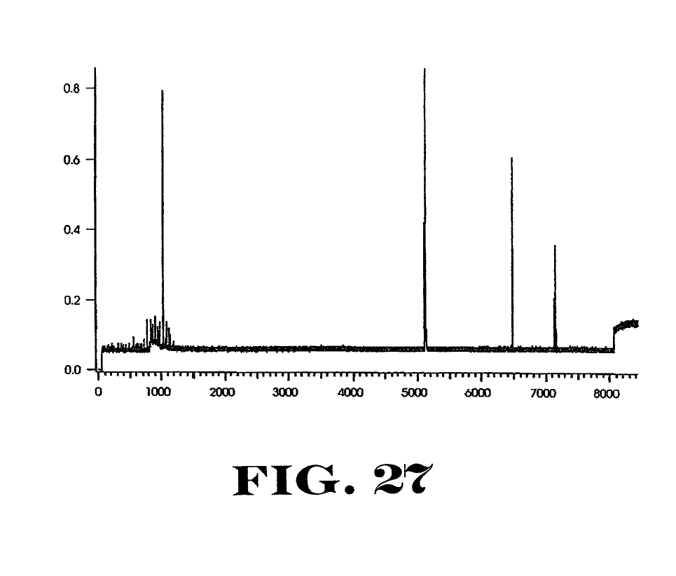

The electroosmotic flow pushed the gel out of the capillary for about 800 seconds, then the spikes of nuclei began to appear after the gel had been removed from the capillary as illustrated in FIG. 27.

It is postulated that a coated capillary may be used to retain the gel in the capillary, and thus used to separate particles using a gel. It Is also postulated that other types of gels or polymers such as poly(ethylene glycol) may also be used.

### Example 8

### Modification of Commercially Available System for Improved Data Acquisition

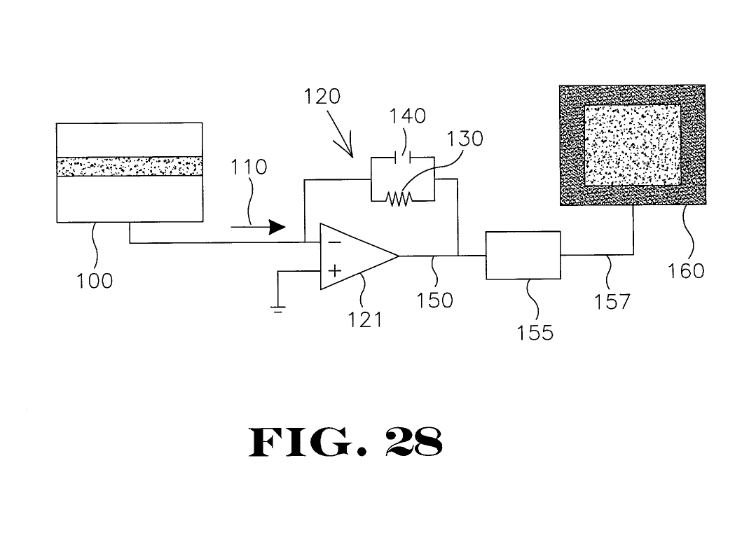

Referring to FIG. 28, a commercially available capillary electrophoresis system 100 available under the trade designation P/ACE MDQ from Beckman Coulter, Fullerton, Calif., is reported to have a data rate collection of 0.5 to 32 Hz (cycles per second) in the Beckman Coulter P/ACE MDQ capillary electrophoresis system product brochure BR-8177B (2000). A P/ACE MDQ glycoprotein system was modified for improved data acquisition.

The system was modified as generally illustrated in FIG. 28. The light detector output current signal 110 from commercially available system 100 was captured and provided to gain circuit 120. The gain circuit 120 includes operational amplifier 121, a current-to-voltage converter that increases signal gain, and RC circuitry to reduce 60 Hz noise. The RC circuitry includes, for example, resistor 130 (e.g., about 51 megaohms) and capacitor 140 (e.g., about 1.25 nanofarads). The output voltage signal 150 of the gain circuit 120 was provided to converter board 155 for analog to digital conversion. The converter board was programmed (e.g., via LabView) to sample at a desired rate. Preferably, the sampling rate was set at 100 cycles per second, and the digital signal 157 provided therefrom was provided to computer 160 for providing output characteristic of a detected particle (e.g., a spike). Computer 160 preferably executes a program written in LabView to analyze digital signal 157, which preferably enables the computer 160 to provide output characteristic of a detected particle.

The modified instrument was used to separate microspheres by capillary electrophoresis. Polystyrene microspheres (1 micron) were electrokinetically injected (e.g., 20 seconds, 200 V/cm), and the separation was carried out at 100 V/cm using a fluid containing 10 mM borate and 10 mM sodium dodecyl sulfate, pH=9.4.

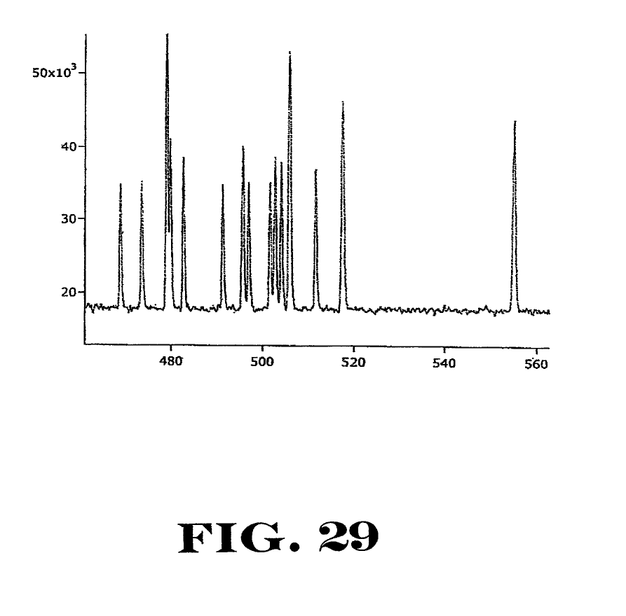

The modified instrument detected individual beads with adequate sensitivity and reproducibility as illustrated in FIG. 29, with a signal to noise of about 170, a relative standard deviation of about 19, and a peak width of about 2000 milliseconds. For comparison, highly sensitive non-commercially available systems may have a signal to noise of about 1500, a relative standard deviation of about 31, and a peak width of about 80 milliseconds.

The complete disclosure of all patents, patent applications, and publications, and electronically available material (e.g., GenBank amino acid and nucleotide sequence submissions) cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

What is claimed is:

1. A method of detecting a particle comprising:
providing a sample comprising a plurality of particles;
applying an electric field to separate a particle;
generating a signal characteristic of the separated particle;
sampling the signal at a sampling rate effective to detect the separated particle; and
providing output based on the sampled signal that is characteristic of the detected separated particle.

2. The method of claim 1 wherein the sample has a defined sample volume.

3. The method of claim 2 wherein the defined sample volume further comprises a fluid.

4. The method of claim 2 wherein the defined sample volume is provided in a separation device, and wherein the method further comprises allowing the plurality of particles to interact with an interior surface of the separation device.

5. The method of claim 2 wherein generating a signal comprises generating a signal based on an electrochemical characteristic of the separated particle.

6. The method of claim 2 wherein generating a signal comprises generating a signal based on at least one received light characteristic of the separated particle.

7. The method of claim 6 wherein generating a signal comprises generating a signal based on received light from fluorescence by the separated particle, received light from light scattering by the separated particle, and/or received light from circular dichroic interactions with the separated particle.

8. The method of claim 6 wherein generating a signal comprises generating a signal based on received light from fluorescence by the separated particle induced by a laser beam.

9. The method of claim 8 wherein the sampling rate is greater than the time for the separated particle to travel through the laser beam.

10. The method of claim 2 wherein the defined sample volume is provided in a separation device, and wherein generating a signal comprises generating a signal after moving the separated particle from the separation device.

11. The method of claim 2 wherein the defined sample volume is provided in a separation device, and wherein generating a signal comprises generating a signal while the separated particle is in the separation device.

12. The method of claim 2 wherein applying an electric field comprises electrophoretically separating a particle.

13. The method of claim 12 wherein the electrophoretic separation comprises a capillary electrophoretic separation.

14. The method of claim 13 wherein the defined sample volume is provided in a separation device, and wherein the method further comprises:
moving the separated particle from the separation device into a cuvette before generating the signal; and
flowing a sheath fluid into the cuvette, wherein the composition of the sheath fluid is the same as the composition of the sample volume fluid.

15. The method of claim 2 wherein the plurality of particles comprise nanometer size particles.

16. The method of claim 2 wherein the plurality of particles comprise organelles, liposomes, or combinations thereof.

17. The method of claim 2 wherein the plurality of particles comprise subcellular entities.

18. The method of claim 2 wherein the plurality of particles comprise mitochondria, nuclei, lysosomes, or combinations thereof.

19. A method of detecting a particle comprising:
providing a sample comprising a plurality of particles;
applying an electric field to separate a particle;
generating a signal characteristic of the separated particle;
sampling the signal at a rate of at least about 40 cycles per second to detect the separated particle; and
providing output based on the sampled signal that is characteristic of the detected separated particle.

20. The method of claim 19 wherein applying an electric field comprises electrophoretically separating a particle.

21. The method of claim 20 wherein the electrophoretic separation comprises a capillary electrophoretic separation.

22. A method of detecting a particle comprising:
providing a defined sample volume comprising a plurality of particles;
directing the particles through a separation device;
allowing the particles to interact with an inner surface of the separation device to separate a particle;
generating a signal characteristic of the separated particle;
sampling the signal at a sampling rate effective to detect the separated particle; and
providing output based on the sampled signal that is characteristic of the detected separated particle.

23. A method of detecting a particle comprising:
providing a defined sample volume comprising a plurality of particles;
separating a particle;
generating a signal characteristic of the separated particle;
sampling the signal at a rate of at least about 40 cycles per second to detect the separated particle; and
providing output based on the sampled signal that is characteristic of the detected separated particle.

24. A method of detecting a particle comprising:
providing a defined sample volume comprising a particle;
applying an electric field to displace the particle based on an electrophoretic property of the particle; and
providing output characteristic of the displaced particle to detect the displaced particle.

25. The method of claim 24 further comprising measuring the time to displace the particle.

26. The method of claim 25 further comprising calculating the electrophoretic mobility of the displaced particle based on the measured time.

27. A method of detecting a plurality of particles comprising:
providing a sample comprising a plurality of particles;
directing the particles through a separation device to provide a plurality of separated particles;
generating a signal characteristic of the separated particles;
sampling the signal at a sampling rate effective to detect at least about 50% of the separated particles; and
providing output based on the sampled signal that is characteristic of the separated detected particles.

28. The method of claim 27 wherein the sample has a defined sample volume.

29. A system for detecting a particle comprising:
a separation device operable to receive a defined sample volume comprising a plurality of particles;
an electric field application device operable to apply an electric field across at least a portion of the sample volume to separate a particle;
a signal generating device operable to generate a signal characteristic of the separated particle; and
an output device operable to sample the signal at a rate effective to detect the separated particle and to provide output based on the sampled signal that is characteristic of the detected separated particle.

30. The system of claim 29 wherein the electric field application device comprises an electrophoretic separation device.

31. The system of claim 30 wherein the electrophoretic separation device comprises a capillary electrophoretic separation device.

32. A system for detecting a particle comprising:
a separation device operable to receive a sample comprising a plurality of particles;
an electric field application device operable to apply an electric field across at least a portion of the sample to separate a particle;
a signal generating device operable to generate a signal characteristic of the separated particle; and
an output device operable to sample the signal at a rate of at least about 40 cycles per second to detect the separated particle and to provide output based on the sampled signal that is characteristic of the detected separated particle.

33. The system of claim 32 wherein the electric field application device comprises an electrophoretic separation device.

34. The method of claim 33 wherein the electrophoretic separation device comprises a capillary electrophoretic separation device.

35. A system for detecting a particle comprising:
a separation device comprising a defined sample volume comprising a plurality of particles, wherein the separation device has an inner surface that interacts with the particles;
a device operable to direct the particles through the separation device to separate a particle;
a signal generating device operable to generate a signal characteristic of the separated particle; and
an output device operable to sample the signal at a rate of at least about 40 cycles per second to detect the separated particle and to provide output based on the sampled signal that is characteristic of the detected separated particle.

36. A system for detecting a separated particle provided in a separation device, wherein the separation device is operable to receive a defined sample volume comprising a plurality of particles, the system comprising:
a signal generating device operable to generate a signal characteristic of the separated particle; and
an output device operable to sample the signal at a rate of at least about 40 cycles per second to detect the separated particle and to provide output based on the sampled signal that is characteristic of the detected separated particle.

37. The system of claim 36 wherein the signal generating device is operable to generate a signal based on at least one received light characteristic of the separated particle.

38. The system of claim 37 wherein the signal generating device is operable to generate a signal based on received light from fluorescence by the separated particle, received light from light scattering by the separated particle, and/or received light from circular dichroic interactions with the separated particle.

39. The system of claim 37 wherein the signal generating device is operable to generate a signal based on received light from fluorescence by the separated particle induced by a laser beam.

40. The system of claim 39 wherein the sampling rate is greater than the time for the separated particle to travel through the laser beam.

41. The system of claim 36 wherein the signal generating device is operable to generate a signal after moving the particle from the separation device.

42. The system of claim 36 wherein the signal generating device is operable to generate a signal while the separated particle is in the separation device.

43. A method of detecting a particle using a system for detecting a separated particle provided in a separation device, wherein the separation device is operable to receive a defined sample volume comprising a plurality of particles, the method comprising:
generating a signal characteristic of the separated particle;
sampling the signal at a rate of at least about 40 cycles per second to detect the separated particle; and
providing output based on the sampled signal that is characteristic of the detected separated particle.
